(19) United States
(12) Patent Application Publication
(10) Pub. No.: US 2010/0049603 A1
(43) Pub. Date: Feb. 25, 2010

(54) LOCALLY DRIVEN ADVERTISING SYSTEM

(75) Inventors: Harold L. Peterson, Scotts Valley, CA (US); James B. Williams, Santa Cruz, CA (US); Joel R. Rigler, Aptos, CA (US); Matthew R. Muyres, San Jose, CA (US)

Correspondence Address: Patent Venture Group, 10788 Civic Center Drive, Suite 215, Rancho Cucamonga, CA, 91730-3805, US

(73) Assignee: DIGITAL DELIVERY NETWORKS, INC., Scotts Valley, CA (US)

(21) Appl. No.: 12/437,126

(22) Filed: May 7, 2009

Related U.S. Application Data
(63) Continuation-in-part of application No. 09/423,025, filed on Oct. 28, 1999.
(60) Provisional application No. 60/058,623, filed on Sep. 11, 1997.

(51) Int. Cl. G06Q 30/00; G06Q 10/00; G06F 15/16

(52) U.S. Cl. 705/14.45; 705/14.4; 705/14.61; 715/760

(57) ABSTRACT

A method for providing offline advertising on a user's personal computerized system that has a display unit and a primary storage unit. A campaign set is provided in the primary storage unit, wherein at least part is stored in the primary storage unit prior to its being received by the user, either as part of or by addition to the personal computerized system. The campaign set includes a plurality of ads each having respective deployment attributes. A viewable window is generated on the display unit, wherein this viewable window includes at least one position. An ad from the campaign set is retrieved based on its respective deployment attributes. And the ad is presented in said position, thereby permitting the user of the personal computerized system to view said ad.

### CROSS-REFERENCE TO RELATED APPLICATIONS

This is a continuation-in-part of co-pending U.S. application Ser. No. 09/423,025, filed Oct. 28, 1999, which is a continuation under 35 U.S.C. 371 of application PCT/US98/18948, filed on Sep. 11, 1998, and which claims the benefit of U.S. provisional application Ser. No. 60/058,623, filed on Sep. 11, 1997, hereby incorporated by reference in their entirety. This application is also closely related to U.S. application Ser. No. 09/797,639, filed Mar. 1, 2001, now abandoned, which is hereby also incorporated by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### COPYRIGHT NOTICE AND PERMISSION

This document contains some material which is subject to copyright protection. The copyright owner has no objection to the reproduction with proper attribution of authorship and ownership and without alteration by anyone of this material as it appears in the files or records of the Patent and Trademark Office, but otherwise reserves all rights whatsoever.

### BACKGROUND OF THE INVENTION

1. Technical Field

The present invention relates generally to the marketing functions of vending and delivery of digital content and services related thereto, and more particularly to advertising in interactive computer networks used for such marketing.

2. Background Art

Today we are seeing a merging of many products and services into digital formats. Some typical examples of such digital products are computer software; audio content, like music or audio-books; and audio-visual content, like videos and movies. For present purposes, the salient feature of such digital products is that they can often be treated as mere bags-of-bits (BOBs), with the underlying nature of the products ignored during most handling after creation and before use.

Somewhat less widely appreciated is that many services are now also digital to a considerable extent. For example, computer users today let applets run tests and communicate the results to providers for obtaining installation, upgrade, and problem diagnosis of operating system and applications software; computer game players send each other hints via e-mail; and Internet “telephone,” “radio,” and “television” are emerging as replacements for specialized telephone and broadcast systems. Thus, often to a considerable extent services today can be reduced to digital communications, and can then also be treated as BOBs, in a somewhat more dynamic sense.

For more stable forms of such digital content it has long been appreciated that the particular storage media used has become largely irrelevant. Tape, disk, and drum media are all common, as are physical, magnetic, and optical means of impressing digital content into them. Similarly, for digital services the channels of communication used have become largely irrelevant. Electrical current through wires, light through fibers, and radiation through space are all common, and substantially interchangeable communications channels.

Of relatively recent advent are communications networks, particularly including public networks like the Internet. Although access to such networks is still not universal, such networks are increasing the trend towards the irrelevance of the underlying media used to store digital products and the medium used to communicate digital services. In the following discussion the collective term “digital content” is used to represent both digital products and digital services.

Because networks are overwhelmingly computerized, and thus those already familiar with computers can be expected to most easily appreciate and readily adopt network storage and delivery of digital content, examples in the context of personal computers will be primarily used herein (personal computer: “PC”; used here in the broad sense, because even most computers in business today are actually termed PCs). It should, however, at all times also be appreciated that the principles being discussed are valid for and extendable to other contexts.

Turning now to an example of how the potential of digital content is not adequately being employed, new PCs are usually purchased with some specific task in mind, such as word-processing. However, the customer often also wants to try out new hardware and software capabilities, much like the child in us all likes to immediately play with a new toy. Further, when a consumer purchases a new PC he or she usually also wants to employ it for such intended and experimental tasks almost immediately. It thus is not surprising that studies show that new PC owners are twice as likely to purchase software, as compared to ones who have owned their computers for longer than three months.

Various vehicles for delivery of software for new PCs exist. For example, it can be obtained at the same time as a new PC, or by returning to the store for later purchase. Further, obtaining the software at the same time as the PC can be achieved as a collateral purchase, or it can be obtained as “bundled” software coming with the PC. Unfortunately, there are a number of problems with these methods of delivery.

The collateral purchase of software usually occurs only when the consumer knows exactly what he or she wants, or when the price is within the consumer's impulse purchase price range (i.e., relatively low in price). There are various reasons for this, but some typical ones include the divide and conquer approach to getting a complex system working (including even so-called turn-key PCs today), and the palatability of separating hardware and software costs (which may be substantial, particularly taken together).

In theory, the bundled approach to software delivery seems quite desirable. The consumer gets pre-installed working software, and economy of scale keeps the price for this low.

Unfortunately, theory and reality do not mesh well here, and the desire of PC manufacturers today is to reduce the amount of bundled software. In surveys the reasons cited for this include cost (approx. $20 per system; which is substantial in the low margin, competitive field of hardware sales), lack of quality in the software offerings (so-called “shovelware” or “crapware”), and general customer dissatisfaction. In fact, one top-ten PC manufacturer has found that over 20% of its customer survey respondents sent their PCs back because the bundled software “didn't work.”

Thus, the later purchase of software (i.e., post initial PC sale) remains the overwhelming means by which consumers today obtain software for their PCs. But even this approach has problems which are legend. Obviously there is the awkwardness of a second purchase, or purchases, with the attendant issues of what is now current, where it is in stock, and whether the stores are open. There are also heightened compatibility problems, since the consumer is now back in the store and the PC is now at home or in the office. And there are customer service issues. Even if the consumer returns to the very same store where he or she bought the PC, and perhaps even the very same clerk, he or she is now treated as if the present software purchase is the total extent of the commercial relationship.

However, as noted above, there are emerging new trends in marketing itself. Computer software is one of the leading commodities which has become digital content. For example, less than 2% of all software sales were recorded in electronic distribution channels in 1996, but that figure has increased rapidly to the point where over 40% of software, services and media are now sold online.

Unfortunately, today electronic distribution of computer software remains merely another form of “later purchase” of software. It does nothing about, and in some cases even exacerbates, the existing technical issues of installation, configuration, and compatibility. And it introduces a plethora of new commercial issues, such as consumer trust in the mechanisms used for transactions, protections for the intellectual property in manufacturer's software products or in artistic media, and legal mechanisms to address breakdowns in these.

The above discussion has primarily used PCs as an example, but the problems extend beyond PCs. Many existing, and particularly emerging, personal computerized devices also suffer from these problems. A few present examples are gaming stations, like Sony's latest Playstation™ and Microsoft's X-box™, Nintendo Wii and others; personal communication service (PCS) devices, generally; television “set-top” boxes that permit access to the Internet, such as WebTV™ and Tivo™; and Internet access enabled cellular telephones and personal digital assistants (PDAs), like Blackberry™ and Iphone™ devices. Furthermore, we are seeing a merging of device functionality. For example, some lap-top PCs today have built-in digital image collection devices that can capture still and moving pictures. PCSs and PDAs now contain such as well, and this is blurring and somewhat eliminating the need for digital cameras and “cams” (digital movie cameras) to be distinct devices. Thus, we are approaching a point where we may not need to own many different devices, but just one or two “personal devices” that we use for text, audio, image, etc. data types and for the capture, storage, playback, communication, etc. of this data.

These examples have one thing in common, a primary storage unit or units where an operating infrastructure, applications, and various forms of data are stored. From a hardware perspective, primary storage typically is non-volatile storage which is usually fixed in place for a relatively long period of time and often, but not necessarily, can be rewritten. This definition includes conventional hard drives, which historically have been fixed in a computerized system but which increasingly may be mounted in cartridges and removed, even being “hot-swappable” in some cases. Hard drives have, in recent history, been provided in 5¼″ and 3½″ sizes, and in the now widely accepted 2″ size. In smaller, and typically thinner format, these are also termed “micro-drives.” And another class of primary storage now is flash memory units, typically called “flash cards.”

Looking at the problems of concern here from a higher-level perspective, an overriding problem is getting what we “want” into primary storage. Such primary storage usually comes with what we “need,” that is, a minimal operating system and maybe some basic utility-like applications, but if one wants anything more it has to be sought out and obtained, then loaded or installed, and possibly configured and tested.

Accordingly, from the above it follows that what is today needed is a new mechanism for the marketing of computer software, media, and services, one that provides us with what we want, when and how we want it. And to facilitate such new marketing mechanisms and general sales as well, what is also needed today is a locally driven advertising system.

### BRIEF SUMMARY OF THE INVENTION

It is an object of the present invention to provide a new mechanism for advertising, a locally driven one which operates continuously, whenever consumers are shopping and without need for the actual physical availability of a current on-line connection.

Briefly, one preferred embodiment of the present invention is a method for providing offline advertising on a user's personal computerized system that has a display unit and a primary storage unit. A campaign set is provided in the primary storage unit, wherein the campaign set includes a plurality of ads each having respective deployment attributes and at least part of the campaign set is stored in said primary storage unit prior to its being received by the user. A viewable window is generated on the display unit, wherein the viewable window includes at least one position. An ad is retrieved from the campaign set based on its respective said deployment attributes. And the ad is presented in the position, thereby permitting the user of the personal computerized system to view the ad.

Briefly, another preferred embodiment of the present invention is a computer program, embodied on a computer readable storage medium, for providing offline advertising on a user's personal computerized system that has a display unit and a primary storage unit. A code segment generates a viewable window on the display unit, wherein the viewable window includes at least one position. A code segment retrieves an ad from a campaign set based on respective deployment attributes for the ad, wherein the campaign set has been pre-stored in the primary storage unit prior to its ever being received by the user. And a code segment presents the ad in the position, thereby permitting the user of the personal computerized system to view the ad.

An advantage of the present invention is that it provides an advertising system at the speed of digital electronics, yet in the conventional context of time proven, widely understood, and trusted transactional interrelation of consumer and vendor.

Another advantage of the invention is that it can provide sizable instances of advertising as digital content to its consumers much more rapidly than existing systems. Since the invention permits storage locally of a substantial inventory of the digital content, including advertising, the communications delay inherent in transmission of large BOBs (bags-of-bits) is eliminated when an item is locally “in stock.”

Another advantage of the invention is that it generally handles digital content, including advertising, generically as simple BOBs, yet it also permits optional inclusion of content specific after-receipt handling instructions. In particular, the advertising is not constrained by communications bandwidth limitations, and the target use-audience is not inconvenienced by having to wait while advertising arrives.

Another advantage of the invention is that it may be entirely automated and may employ communications and outside services which may also be entirely automated. It may use communications services which are always available, or which are merely intermittently available, or in its basic case it may present advertising from a local inventory of digital content when communications service is unavailable.

Another advantage of the invention is that it is economical for all involved. The target end user-customers inc no direct cost, and minimal indirect cost in the form of usage of their computer resources. Yet the advertisers, and any intermediaries which they may employ, can employ the system at minimal additional cost over conventional on-line advertising systems.

And, another advantage of the invention is that it is always potentially on and functioning when the target use-audience is shopping, regardless of whether they are on-line.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures and tables of drawings in which:

FIGS. 1a-b are basic stylized depictions of how an embodiment of the invention may reside in a user's personal computer (PC);

FIGS. 2a-b are basic stylized depictions of a business model which may be used by the invention;

FIG. 3 is a detailed block diagram of one suitable architecture for the invention;

FIG. 4 is a block diagram depicting one functional overview of the invention;

FIG. 5 is a block diagram depicting one navigational overview of portions of the invention which may reside in a client computer system;

FIG. 6 is a depiction of a top view, or “village” view, presented by a graphical user interface (GUI) suitable for use on the client computer system of FIG. 5;

FIG. 7 shows a store GUI view, accessible via the GUI in FIG. 6;

FIG. 8 shows an asset GUI view, accessible via the store view in FIG. 7;

FIG. 9 shows a purchase summary and confirmation GUI view, i.e., a “check-out” view, accessible via either the store view in FIG. 7 or the asset view in FIG. 8;

FIGS. 10a-e show a search GUI views accessible via the GUI views in FIGS. 6-8, where FIG. 10a depicts an asset name based search, FIG. 10b depicts a provider name based search, FIG. 10c depicts the search of FIG. 10b expanded to include particular assets from a specific provider, FIG. 10d depicts a category based search, and FIG. 10e depicts an overview search based on a village map metaphor;

FIG. 11 is a block diagram depicting a hierarchical overview of an implementation of a master server application using access via the Internet;

FIGS. 12a-c depict how the DCVM can implemented as an N-tier configuration grouped by function and location, with FIG. 12a showing a block diagram overview of major tier elements, FIG. 12b showing a block diagram of a more detailed architecture topology overview, and FIG. 12c showing a block diagram of a server oriented overview;

FIG. 13 is a block diagram which particularly depicts the first and second tiers of the client in the embodiment of the DCVM of FIGS. 12a-c;

FIG. 14 is a block diagram illustrating agents and applets in the client and the transaction server, and particularly includes an architecture for the server transaction agent;

FIG. 15 is a block diagram of more detail in the transaction server of FIG. 14;

FIG. 16 is a schematic diagram depicting one screen layout (somewhat different than those depicted in the embodiment of the DCVM represented in FIGS. 6-10e) which the client may represent;

FIG. 17 is a block diagram showing where the DCVM can fit into an advertising management service database and data broker scheme;

FIG. 18 is block diagram showing one possible click stream data flow approach which the DCVM may use.

FIG. 19 is a block diagram showing a user's first initial view of a local portal in accord a newer embodiment of the present invention;

FIG. 20 is a block diagram showing a view associated with the shop tab in detail, after the user affirmatively selects it or operates a next button while in the view in FIG. 19;

FIG. 21 is a block diagram showing a view associated with the video tab in detail, after the user affirmatively selects it or operates the next button while in the view in FIG. 20;

FIG. 22 is a block diagram showing a view associated with the gadget tab, after the user affirmatively selects it or operates the next button while in the view in FIG. 21;

FIGS. 23a-b are block diagrams showing two special dialogs in the local portal, wherein FIG. 23a is of a set-up dialog and FIG. 23b is of an account info dialog;

FIG. 24 is a block diagram showing an initial view of a pillar of the local portal that is arrived at once the user appropriately exits the set-up dialog in FIG. 23a;

FIG. 25 is a block diagram showing an alternate view of the news pillar subsequent to the view in FIG. 24;

FIG. 26 is a block diagram showing the video pillar in a typical manner;

FIGS. 27a-b are block diagram showing a shop pillar in detail, wherein FIG. 27a depicts representative offerings in a work mode and FIG. 27b depicts representative offerings in a play mode;

FIG. 28 is a block diagram showing the shop pillar once a user selects an offering from the offerings ribbon in FIGS. 27a-b;

FIG. 29 is a block diagram showing the shop pillar when a large set of offerings may apply, and particularly how search controls may dynamically increase or decrease in number and functionality to adapt to this; and

FIGS. 30a-b are block diagram showing a purchase scenario using the local portal, wherein in FIG. 30a the user has operated a special offer selection button and in FIG. 30b the user has operated a take me there button; and

FIG. 31 is a flow chart summarizing the inventive DCVM as a locally driven advertising system.

TABLE 1 shows a suitable file format for clickstream data;

TABLE 2 shows a sample click report file generated from test data and then translated using such a ClickReportReader JAVA class; and

TABLE 3 shows representative classes and methods permitting extraction of data directly from serialized clickstream files.

In the various figures of the drawings, like references are used to denote like or similar elements or steps.

### DETAILED DESCRIPTION OF THE INVENTION

A preferred embodiment of the present invention is a locally driven advertising system that may particularly be practiced in a digital content vending “machine” (“DCVM”). As illustrated in the various drawings herein, preferred embodiments of the invention are depicted by the general reference character 10.

The DCVM 10 may be advantageously viewed using two analogies. The first of these, which is alluded to by its label, is the vending machine. This analogy serves well for providing a general overview of this as a system for vending digital content, and thus as the platform of the locally driven advertising system. The second analogy is a content management service, which manifests as the graphical user interface (GUI) of embodiments of the invention. Two metaphors that have been used in the presentation layers of actual embodiments of the DCVM 10 are described below. The first of these is a village square metaphor and the second is a pillar cover metaphor. The general underlying architecture of both is the same. Neither metaphor should be viewed as limiting, however, and other embodiments of the DCVM 10 can be based on yet other presentation layer metaphors while remaining true to the spirit of the present invention. The village square metaphor was used in early embodiments of the DCVM 10 and, although the inventors have adopted the pillar cover metaphor in their newer embodiments of the DCVM 10, the village square metaphor is still useful as an introduction because it serves particularly well to give an easily grasped and usable perception of the invention as a system for purchasing digital content.

A conventional vending machine, such as a coffee machine, for example, will sell its primary commodity (coffee), but then often also sell parallel market items, like tea and soup, and dispenses optional items, like cream and sugar. Similarly, the DCVM 10 sells digital products as its primary commodity, but it also may sell related information and services for such, and also dispense customer support and access to communications with like minded consumers. Thus, the DCVM 10 provides digital products, digital services, and other digital products, i.e., digital content.

Turning now to the village square metaphor, in such a real place there will typically be shops or stores catering to different tastes, income levels, professions, ages, etc. There will be stores that provide primarily goods, and others that provide primarily services. There typically will also be diverting entertainments, and areas set aside simply for communications with those sharing similar interests. And there usually will also be directory plaques or information kiosks to help users find where things are at and to assist in getting to them. As products and services increasingly become digital, this village square analogy is readily extendable into the DCVM 10 as now described.

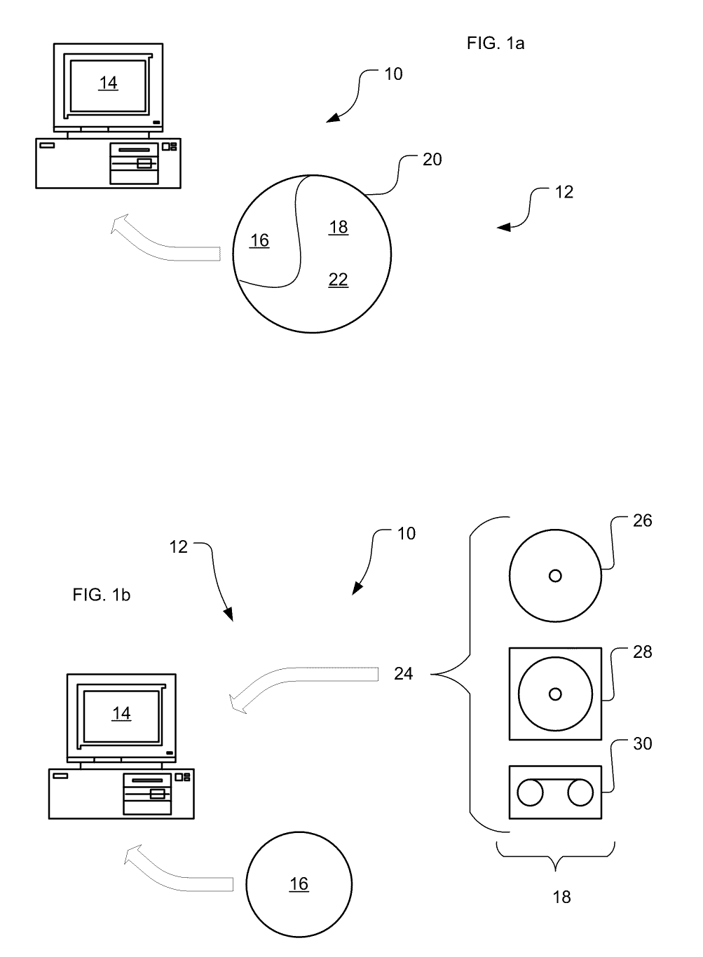

FIGS. 1a-b present how the client 12, i.e. a client application, resides on a user's personal computer (PC 14) and contains both an infrastructure 16 and an inventory 18. The infrastructure 16 is an engine that handles the functionality of the DCVM 10, and the inventory 18 is the local collection of assets 22 of merchandise or units of service.

The infrastructure 16 is relatively static. Like most software applications, it perhaps merits an occasional upgrade as new features become available, but otherwise may generally be installed and left alone. It is anticipated that the infrastructure 16 will usually be stored on a local hard drive 20, although in some cases a hard drive 20 on a local area network (LAN; not shown) may also be acceptable. Keeping the infrastructure 16 local insures good overall DCVM 10 responsiveness.

In contrast, the inventory 18 is relatively dynamic, potentially including assets 22 such as computer software products, music, audio books, video, and anything else which can be reduced to digital format and electronically transmitted and stored. The inventory 18 may be loaded on a local device, or it may also be accessible over a LAN having an appropriate bandwidth, since storage capacity and transfer rate are more important than responsiveness for it. Standalone hard drive units, such as those that can be externally connected to a PC 14 via an eSata, USB, or IEEE 1394 port, as well as network accessible storage (NAS) and direct access storage (DAS) devices are increasingly common and are also good candidates for storing all or substantial portions of the inventory 18.

In FIG. 1a both the infrastructure 16 and the inventory 18 are depicted residing together in fixed storage in the PC 14. Today such fixed storage will typically be hard drives 20 (also sometimes termed a “fixed drive”), but as other large capacity storage means become common they may be used instead.

FIG. 1b depicts how the infrastructure 16 may reside in fixed storage, but the inventory 18 instead resides in a removable media 24 which is accessible by the PC 14. Some common early examples of such removable media 24 are CDs 26, DVDs 28, and tape 30, but still others are easily possible. In fact, since the initial conception of this invention many new examples of removable media 24 have emerged (e.g., HD-DVD™ and BluRay™, and a plethora of flash memory based devices). For the sake of this discussion the above noted standalone hard drive units and NAS and DAS devices can generally also be regarded as examples of removable media 24.

In early, basic embodiments of the DCVM 10 which were delivered by hard drive 20, approximately one to four gigabytes of storage were used. Of this the infrastructure 16 was roughly 50-100 megabytes (Mb) in size and the inventory 18 took up the balance. For embodiments delivered by CD 26, only about 600 Mb were used for the inventory 18.

Even as these early embodiments were first being envisioned, however, it was anticipated that larger capacity hard drives 20 and higher capacity removable media 24, like DVDs 28, would become widely available. Today we see 750 gigabyte (Gb) and even 1 terabyte capacity hard drives 20 in PCs 14 and emerging types of removable media 24, like HD type DVDs 28, now approaching 50 Gb capacities. These are now used in PCs 14 as well as in home entertainment and even automotive types of computerized systems. Furthermore, newer types of removable media 24, such as 4 Gb and 8 Gb flash memory units that have USB or mini/micro SD module interfaces are now particularly used in computerized systems other than traditional PCs 14, such as cellular telephones, personal digital assistants (PDAs), and music/image video players (often collectively labeled “MP3 players”).

The increase in storage media capacities, the broadening range of devices that use such storage media, and the growing multi-mode functionality of devices to be able to use digital content in one or more modes all now even more clearly emphasize realizations by the present inventors' that have helped motivate this invention. Most storage media is empty when it is first delivered to the end consumer, and this is a hugely wasted opportunity for essentially all of the parties involved, starting with the media manufacturer, through essentially all aspects of the chain of supply, and ending with the ultimate end consumer/user.

In one preferred embodiment of the DCVM 10, initial delivery of the infrastructure 16 is on the hard drives 20 of new PCs 14. However, the DCVM 10 may also be “delivered” on a new hard drive 20 used for upgrading an existing PC 14, or on an added standalone hard drive unit, a DAS or a NAS device. Or it may even be delivered via conventional software installation by loading it from removable media 24 into the PC 14, or by downloading it from an online source and then installing it (a newer installation technique becoming common today). Initial delivery of the inventory 18 may similarly be in pre-loaded format on the hard drive 20, or by provision on removable media 24 which is then placed as needed into the PC 14 for access by the infrastructure 16 (typically depending upon the capacity of the hard drive 20).

Of course, like in real world stores, the inventory 18 of the DCVM 10 may need to be replenished as sales occur, updated as new versions become available, and expanded as suppliers change and new offerings become available. Therefore, the DCVM 10 may be maintained and updated using intelligent push technology over modern networks, like the Internet. Such push technology may also be used to provide a one-to-one buying and selling experience for users, and to allow individual preferences to be collected and catered to without need of human intervention.

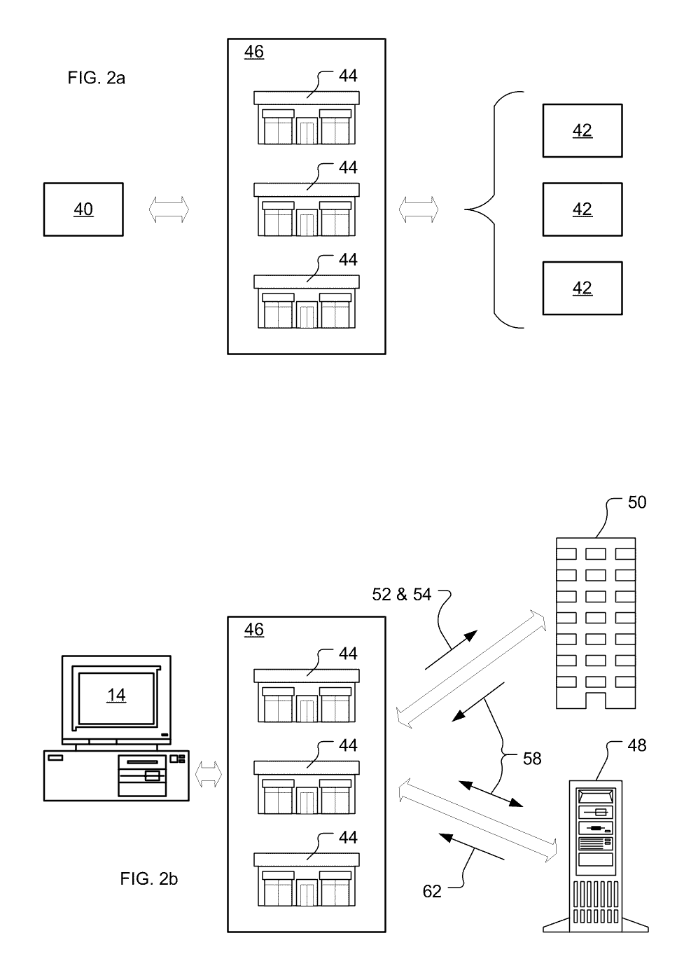

FIG. 2a depicts, in simplified form, a business model which may be used by the inventive DCVM 10. The end users are termed customers 40 and those entities providing the digital content are termed vendors 42. The vendors 42 operate stores 44 (a term used broadly to denote a point of supply for any digital content, regardless of whether overtly commercial in nature). A graphical user interface (GUI), termed the village 46, is used to present a collection of the stores 44 as a virtual setting in which the vendors 42 vend and the customers 40 consume. The stores 44 in the village 46 advertise and carry out commerce at various levels of directness, and particularly through several audio and visual channels in each. It is expected that each store 44 typically will feature three main activities: shopping for digital content, viewing events, and communicating.

FIG. 2b depicts a more complete version of the business model introduced above. In addition to their local presence, the vendors 42 are also collectively represented on a master server 48, and all can invoke the assistance of a financial intermediary termed a clearing house 50. The clearing house 50 facilitates complex purchase scenarios, permits larger numbers of stores 44, and more dynamically provides service to both the customers 40 and the vendors 42.

In a typical exemplary purchase scenario, a customer 40 transmits money 52 and an identifier 54 to the clearing house 50. The clearing house 50 then credits the account of the particular vendor 42, and transmits back to the customer 40 a key 58. Next, usually automatically under control of the infrastructure 16, the customer 40 sends this key 58, or part of it, on to the master server 48, which sends back another key 58 (the keys 58 are typically all unique). Again automatically, if desired, the infrastructure 16 uses this second key 58 to digitally “unwrap” an asset 22 of inventory 18, which has now been “purchased.” Since the money 52, identifier 54, and the keys 58 can all be relatively small, compared to the asset 22 being purchased (typically many megabytes or even gigabytes in size), even transactions in very sizable digital content can be carried out quite quickly.

Of course, simpler purchase scenarios are possible. The customer 40 might deal directly and entirely with the master server 48. However, at least for the near future, there is no reason to expect that customers 40 and vendors 42 will feel secure without some “online” commercial intermediary such as the clearing house 50. Alternately, if the asset 22 is already part of the inventory 18, and if the vendor 42 completely trusts the clearing house 50, and if the clearing house 50 is willing to carry appropriate keys 58, the key 58 sent back from the clearing house 50 may be made suitable for directly unwrapping the asset 22. However, since some communications already must take place anyway, and since that will often already be occurring over a medium such as the Internet, there is relatively little burden added by the customer 40 to master server 48 communication legs of the transaction.

The keys 58 play an important security role. They unlock a digital wrapper 60 (not shown, since it is not directly tangible; but numbered here for reference) that protects the asset 22 until after it has been paid for. In most cases the vendors 42 will strongly want such protection, to suppress unauthorized copying of their intellectual property. The digital wrapper 60 may use simple serial number entry to enable or disable a reminder feature, or it may use soft or hard encryption (both conventional technologies to the extent that the inventive DCVM 10 employs them).

Alternately, other mechanisms to protect the assets 22 of the inventory 18 can be used. An example used with early embodiments of DCVM 10 serves here to illustrate some general concepts, although it should still be kept in mind that these security schemes are merely examples of technologies that can be used and their features are not limitations of the DCVM 10 itself.

The digital wrapper 60 may use what the inventors term a “two sector steal.” In the two sector steal, embodiments of the inventive DCVM 10 that store the inventory 18 on a hard drive 20 have two disk sectors of information (an amount empirically found preferable by the inventors) initially omitted. Upon asset 22 purchase, data in the appropriate “stolen” sectors can be supplied, either as part of a key 58 itself, or via use of a key 58 to unlock sector data which has been present all along in an encrypted format. In this manner the asset 22 remains unusable until the missing parts are supplied, yet can be unwrapped reasonably quickly, particularly if the key is electronically communicated to the PC 14.

The two sector steal provides particular advantages to OEM suppliers of PCs 14 and upgrade hard drives 20 (and standalone hard drive units and DAS and NAS devices). The assets 22 can be supplied entirely pre-installed and default configured, but with the sectors stolen (note that sector stealing eliminates the need for bulk encryption). When such an asset 22 is then purchased the sectors are merely installed (or in place decrypted) and the asset 22 is immediately and assuredly ready for use, which will eliminate many technical support calls to the OEM suppliers. And when the customers 40 do have to seek help, the issue of who is to blame for the problem is substantially reduced, which greatly increases their willingness to pay for support and still hold the supplier in high regard.

For additional security, in addition even to the use of keys 58, at the option of the vendor 42 (perhaps under a contractual obligation with an actual software publisher or entertainment media copyright owner), assets 22 may be “machine bound” to a limited number of physical hard drives 20. For example, as discussed further below, even verbal delivery of keys 58 to customers 40 via the telephone can be used by the DCVM 10. Such keys 58 obviously must be manageable in size and directly enter able by the customers 40, yet it is highly desirable by the vendors 42 that the customers 40 not be able to use one key 58 to unwrap more than one copy of an asset 22. This is easily provided for if the keys 58 are each specifically related to some relatively unique indicia on the hard drives 20. A Help/About menu access in the village 46 can provide a short code based upon such a unique indicia, and a customer 40 can then enter the code with a telephone touch-tone pad to receive a key 58 which only unwraps an instance of the particular asset 22 on their hard drive 20. In this manner, each asset 22 purchased from the DCVM 10 may be restricted from even highly skilled and determined efforts at unauthorized use.

The keys 58 may also play an important commercial role, facilitating payment and accountability of all parties involved. They may act as customer 40 receipts for payment, and vendor 42 vouchers for payment. Assuming that unique keys 58 are used and are retired after one complete transactional cycle, if a key 58 is ever lost it can simply be reissued, since it will only work once and then only for its intended purpose. As noted above, the use of a second key 58 is optional, but much can be gained by doing so. This permits the vendor 42 to closely track its market and, more importantly, keeping the vendor 42 in the “loop” permits better customer 40 support. For example, say that a customer 40 starts a purchase scenario for an asset 22 which is in the local inventory 18 in version 4.10, but the master server 48 now has a newer version 4.15 of that asset 22 in stock. Rather than simply return a key 58 for version 4.10, an offer can be communicated to the customer 40 to (1) go ahead and send the key 58 for version 4.10, or (2) transmit version 4.15 of the asset 22 to update the local inventory 18 and also send the key 58 which will unwrap it, or (3) cancel the transaction (perhaps to be resumed after the customer is mailed a CD 26 containing an updated inventory 18).

The master server 48 can also take an active role in maintaining the infrastructure 16 and the inventory 18, by sending updates 62 to the PC 14 containing fixes and enhancements of the infrastructure 16 and new assets 22 for the local inventory 18. By using the master server 48 as a collector of preferences of the customer 40 to selective apply such updates 62, the inventory 18 can be particularly tailored to the preferences and statistical purchase history of the customer 40.

To assist the master server 48 in this role, click (and key stroke) streams for the customer 40 can be tracked on the client 12 running on the PC 14. This with reference to a substantially unique indicia for the client 12 can then be used with Internet push technology for determining and transmitting appropriately tailored updates 62, or at least prioritizing such updates 62. The indicia used may be a code pre-stored in a hard drive 20 or a removable media 24, or it may be generated on the first execution of the client 12, or it may be provided as a registration process on the master server 48.

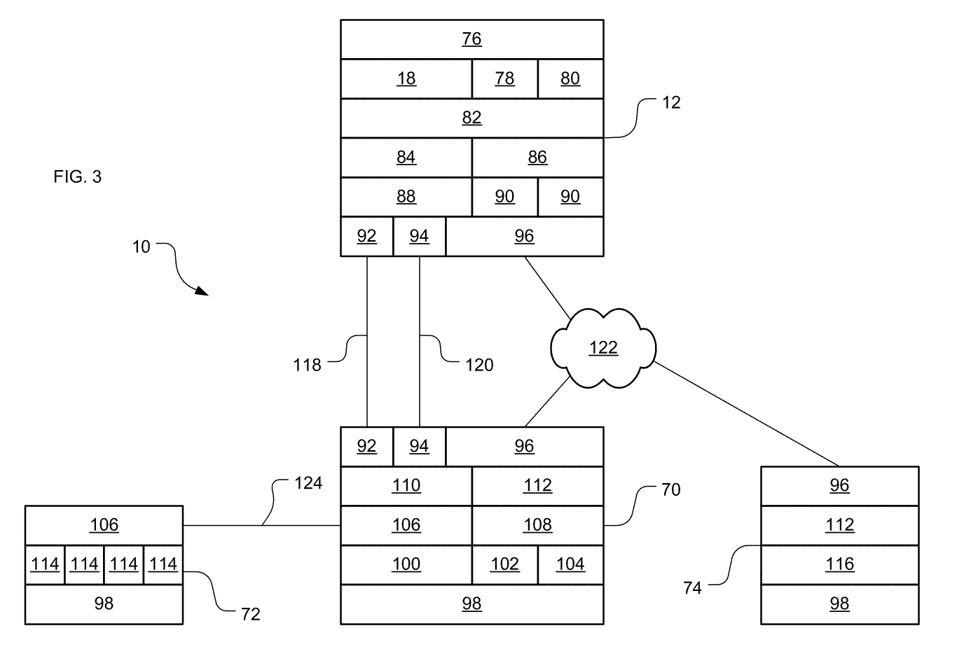

FIG. 3 depicts a suitable architecture for implementing a full featured embodiment of the inventive DCVM 10. The client 12 runs on the PC 14 of the customer 40, a master application 70 runs on the master server 48, a clearing house application 72 runs on the clearing house 50, and a streaming media service 74 is provided.

The client 12 resides on the PC 14 in a layered structure. The lowest layer (hardware and BIOS layers in the PC 14 are not shown, but may be entirely conventional) is a suitable operating system (a client OS 76; e.g., WINDOWS 95/98/ME/NT/2000/VISTA All™ by Microsoft Corporation of Redmond, Wash.). The next layer includes the inventory 18, a village profile 78, and a preference log 80. Atop this is a layer formed by a village manager 82, which using the village profile 78 and preference log 80 permits tailoring for particular customer 40 needs and preferences. At a higher layer are a village interface 84 and an update sub-client 86. Since the village interface 84 itself needs updating from time to time, the update sub-client 86 needs to preferably be in at least as high a layer. Atop this is a layer that includes an order entry interface 88, and client protocols 90 for communications. Finally, within the client 12, is a communications layer which includes a telephone module 92, a private network module 94, and an Internet module 96 for respectively accessing these mediums of communication.

The master application 70 similarly resides in a layered structure on the master server 48. The lowest layer (again hardware and BIOS layers are not shown) is a suitable operating system (a server OS 98; e.g., WINDOWS NT/2000/SERVER 2003/2008 All™ by Microsoft Corporation of Redmond, Wash.). Atop this are a master interface 100; a profile database 102, from which portions transmitted to a client 12 become stores 44; and a master inventory 104, from which portions transmitted to a client 12 become assets 22 in the inventory 18. The next layer includes a financial peer 106 (discussed further presently) and an update sub-server 108. Atop this is a layer including an order interface 110 and server protocols 112. Finally, within the master application 70, is a communications layer which includes a telephone module 92, a private network module 94, and an Internet module 96.

The clearing house application 72 is run by the clearing house 50, and thus effectively is also a server. It also has as a lowest layer a suitable operating system (another server OS 98). Atop this are financial modules 114, which handle services like anti-fraud, pre-authorization, reporting, etc. And atop this is a financial peer 106, for communicating directly with the equivalent in the master application 70.

The streaming media service 74 has a suitable server OS 98 which supports an audio-visual database 116, atop that are server protocols 112 and also an Internet module 96.

The client 12 communicates with the master application 70 via either telephone 118 (touch-tone entry or using voice recognition, and pre-recorded or generated message replies), a private network 120, or the Internet 122. Notably, the first two of these reach customers 40 who are not yet on the Internet 122, per se.

If a telephone 118 is used (say to call an 800 number), the customer 40 may manually enter credit card information on the tone pad, and then hear recited back a simple key 58 which is used to unwrap the asset 22 purchased (of course, this could also be a conventional verbal human transaction, but such are inefficient). The key 58 may be entered by the customer 40 at the PC 14 either as it is received, or it may be written down and used later when the customer 40 is off the telephone 118. If a private network 120 is used, the infrastructure 16 may alternately automatically unlock the purchased asset 22, the customer 40 may still note the key 58 (presumably a simpler one) for later manual entry. If the Internet 122 is used, the infrastructure 16 may automatically use the key 58 to unwrap the asset 22 now purchased, and the key 58 can accordingly be larger and more complex. It should also be appreciated that groups of customers 40 anywhere on a local network can also use the private network 120 and the Internet 122 variations.

In FIG. 3 the master application 70 and the clearing house application 72 are depicted as connected via a dedicated link 124, i.e., all commercial transactions go physically through the master server 48, but with minimal involvement of the master application 70 itself. This provides for universal access by the client 12 via the master application 70, even over the telephone 118 or private network 120. This also provides for very high security, but that may be dispensed with as alternate security means and confidence in them become widespread, perhaps soon with more secured communication over the Internet 122.

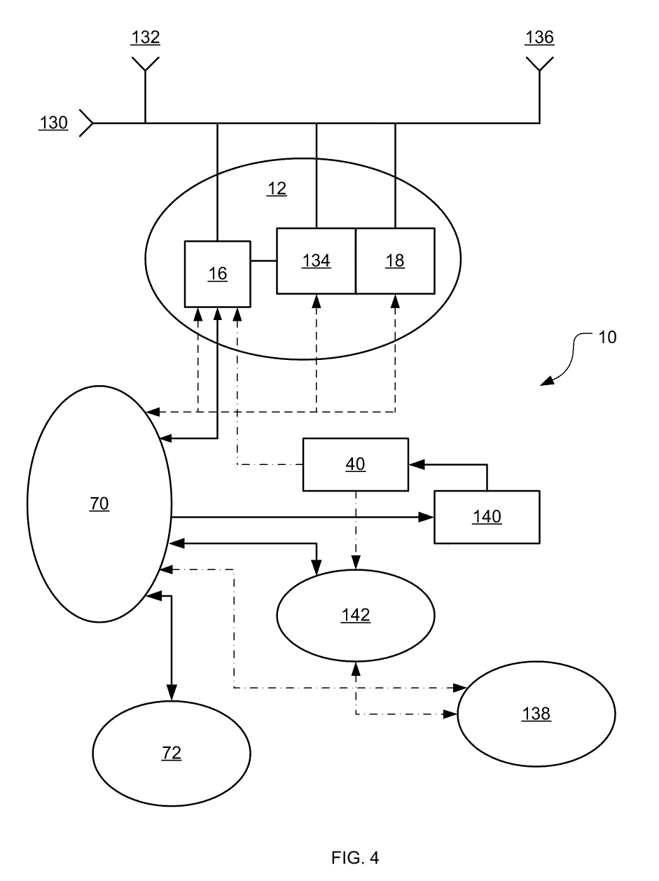

FIG. 4 is a block diagram depicting a functional overview of the DCVM 10. The client 12 is typically installed onto the hard drive 20 of a PC 14 (or other computerized system) by either an original equipment manufacturer (OEM) (step 130) or loaded by a potential customer 40 (step 132) from a removable media 24. The client 12 then contains the infrastructure 16, which provides the GUI of the village 46 to the customer 40, and which is the engine that presents the stores 44 and accesses an inventory database 134 and the inventory 18 itself (say, either on the hard drive 20 or still on the removable media 24).

As an aside, the impression may have been conveyed that the stores 44 always reside on the hard drive 20 as part of the infrastructure 16. However, while often desirable, this need not always be the case. Since the DCVM 10 permits addition and deletion of stores 44, and since large number of stores 44 may be provided, general access to particularized sub-sets of the inventory 18 may be accomplished by putting only popular stores 44 onto the hard drive 20, and leaving the rest on the removable media 24. Further, as the customer 40 deletes some stores 44 and as the village 46 accumulates actual usage information, the stores 44 actually on the hard drive 20 can be changed.

For local updating of the client 12 after installation, particularly for updating the sizable inventory database 134 and the inventory 18 (say, if it is stored on a hard drive 20), additional removable media 24, such as CDs 26 or DVDs 28, may later have their contents copied into the PC 14 (step 136). However, this can be reduced considerably, or even eliminated, if a suitable communications means is available.

Once the client 12 is installed, communications with the master application 70 can ensue, directly from the customer 40 through the infrastructure 16 and indirectly from the inventory database 134 and the inventory 18 (as depicted in FIG. 4 in uniformly dashed lines). The master application 70 and the clearing house application 72 are also depicted as being able to directly communicate. Further, communications from technical support 138 can pass through the master application 70 to and from the client 12. Since a large percentage of PCs 14 on which the DCVM 10 will be loaded will employ step 130 (OEM loading), it is particularly anticipated that this will facilitate access to OEM supplied technical support 138.

The customer 40 can also request fulfillment of orders for hard goods 140 via the client 12. Such hard goods 140 may be ancillary to the inventory 18, e.g., manuals for computer software assets 22 in the inventory 18, or they may be entirely separate, i.e., permitting the DCVM 10 to optionally be used as a catalog server for entirely non-digital content as well.

However, the customer 40 is not restricted to only communicating via the client 12 to the master application 70. The customer 40 may still use a simple telephone, say, using a toll free number, to verbally communicate with phone support 142, and via the phone support 142 to also access the technical support 138 (depicted in FIG. 4 in non-uniformly dashed lines). This particularly facilitates the customer 40 being able to get assistance when the client 12 is “broken” and to advise that something has gone awry in the master application 70.

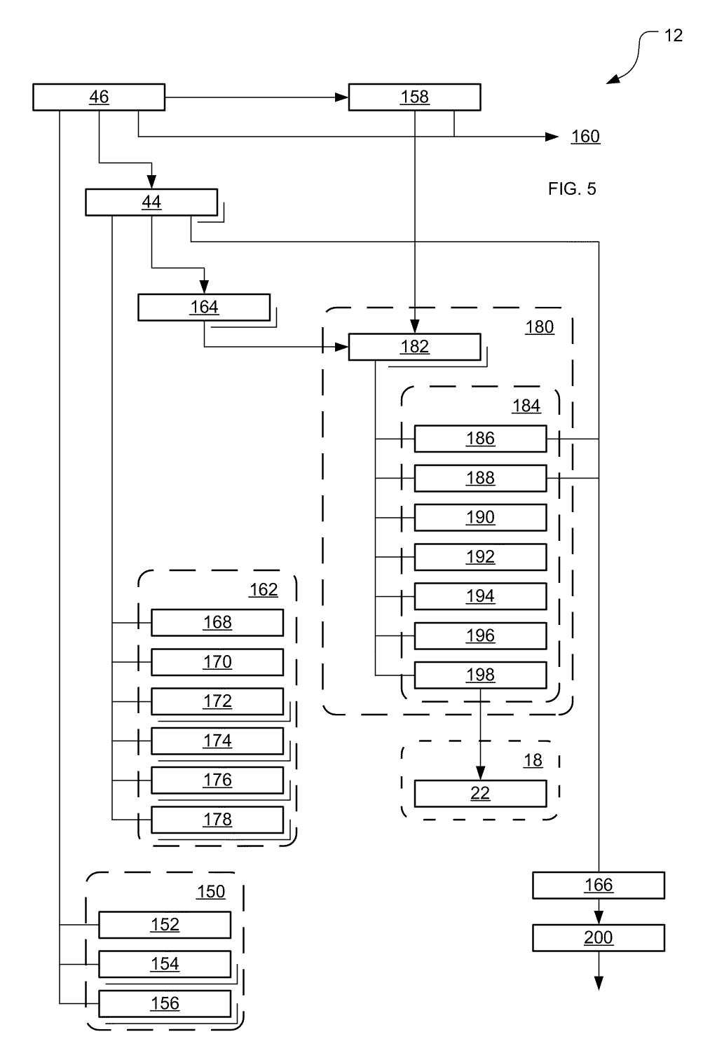

FIG. 5 is a block diagram depicting a navigational overview of one embodiment of the client 12. At the highest level is the village 46, which has a village template 150 including a village video 152, village ads 154, and a number of store controls 156 (combination button-icons). From the village 46 access is also available to a search feature 158, which provides a quick way to find particular assets 22 (described below), and to an extra assets feature 160 which provides access to digital content not presently in the inventory 18 (i.e., in the master inventory 104 on the master server 48). From the search feature 158 there is also access to this extra assets feature 160.

The store controls 156 of the village 46 provide access to the stores 44. Each store 44 has a store template 162, aisles 164, and a shopping cart 166. The store template 162 includes store data 168 (e.g., name, etc.); a store video 170, describing the store 44; and store ads 172, analogous to traditional end-cap advertisements; optional Internet links 174 for the store 44, i.e., for alternately reaching the sponsoring vendor 42; optional promotional ads 176, for particular assets 22, i.e., “hot deals”; and aisle controls 178.

The aisle controls 178 provide access to the aisles 164, usually with a plurality appearing for each store 44. Each aisle 164 has an associated aisle template 180.

The aisle templates 180 each include a number of asset controls 182, each in turn associated with an asset template 184. An asset template 184 includes asset data 186 (e.g., name, provider, category, version, etc.), an asset price 188, an asset description 190, an asset video 192, an asset ad 194, a third-party opinion 196 (i.e., a review of the asset 22), and an asset link 198 pointing to where the particular asset 22 is stored in the inventory 18.

By customer 40 selection when viewing an asset template 184 appropriate information, such as the asset price 188 and the asset link 198, are sent to the shopping cart 166, a place where information identifying prospective asset 22 purchases accumulates prior to formal purchase. Later, back at the store 44 level, the customer 40 can access the shopping cart 166 and invoke an order module 200 to selectively complete formal purchase of the chosen assets 22 in the shopping cart 166.

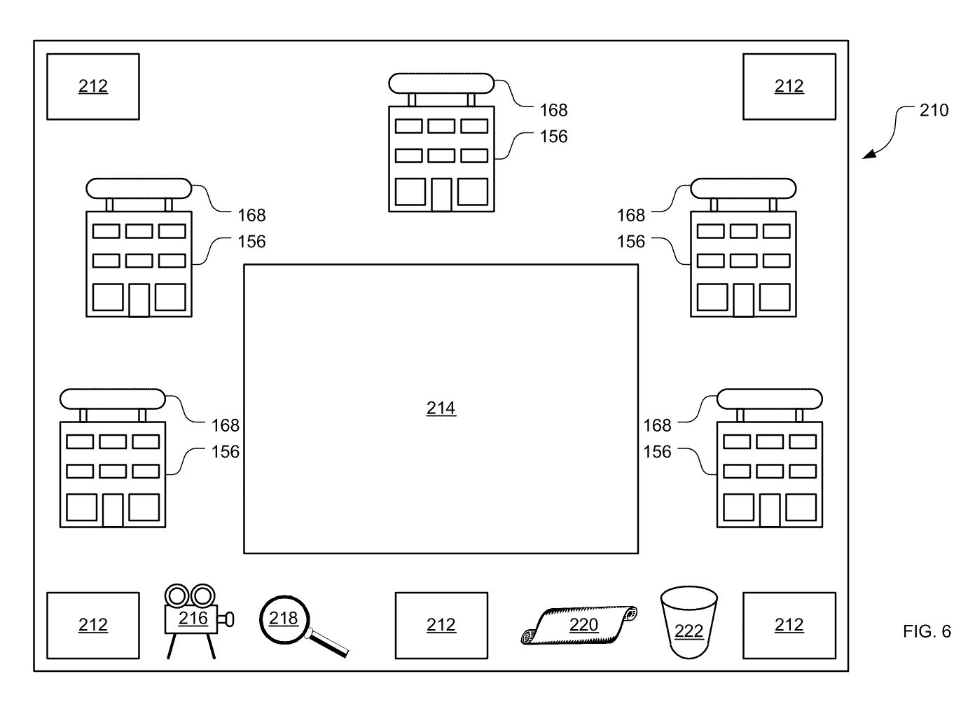

FIG. 6 depicts a suitable village view 210 for presentation to the customer 40. A series of ad cells 212 are placed about the village view 210. These may contain either fixed or banner advertisements from the village ads 154. The major features of the village view 210 are the store controls 156, each with respective store data 168 prominently displayed, and a centrally placed video display 214. Further provided, at the bottom of the village view 210, are a video control 216, to start/restart the village video 152 in the video display 214; a search control 218, which invokes features described below; a guarantee control 220, which invokes display in the video display 214 of business information about the parties operating the master application 70, the clearing house application 72, and the respective vendors 42; and a delete village control 222, to entirely eliminate the DCVM 10 from the PC 14.

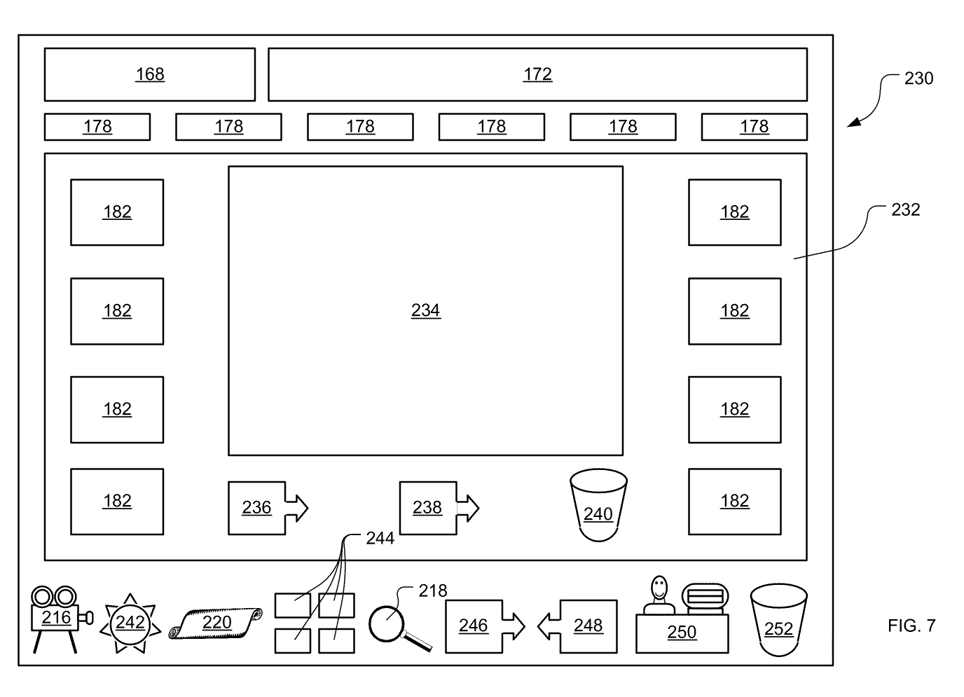

FIG. 7 depicts a suitable store view 230 for presentation to the customer 40. The store data 168 (at least the store name) and the store ad 172 are displayed at the top. Below is a row containing the aisle controls 178. And below that row is an aisle sub-view 232, which changes depending upon which aisle control 178 is currently selected. The aisle sub-view 232 includes a video display 234, asset controls 182, an aisle update control 236, a next page control 238 (to display a subsequent view of assets, since aisles may often contain more than will fit on one view), and a delete aisle control 240. At the bottom of the store view 230 are the video control 216, to here start/restart playback of the store video 170; a promo control 242, to start/restart playback of the promotional ads 176; the guarantee control 220; a links control 244, to display the Internet links 174 for the store 44; the search control 218; an update store control 246; a return to village control 248, to return to the village view 210; a checkout control 250; and a delete store control 252, to remove the present store 44 from the client 12.

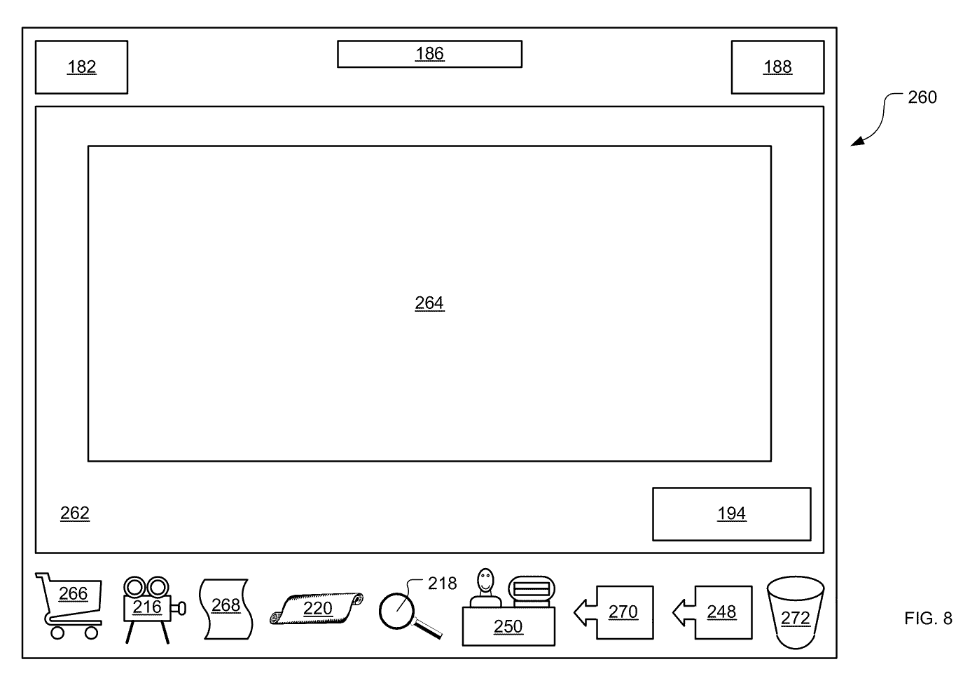

FIG. 8 depicts a suitable asset view 260 for presentation to the customer 40. Displayed at the top are the asset control 182 (here acting only as an icon, since it cannot be selected to go to another view), the asset data 186 (at least the asset name), and the asset price 188. Below is an asset sub-view 262 which includes an asset display 264 and the asset ad 194 (typically a banner type ad, which “rotates” continuously).

At the bottom of the asset view 260 are a shopping cart control 266 (to add the present asset to the shopping cart 166), the video control 216, an opinion control 268, the guarantee control 220, the search control 218, the checkout control 250, a return to store control 270, the return to village control 248, and a delete asset control 272.

Depending upon operation by the customer 40, the asset display 264 presents either the asset description 190 (the default), the asset video 192, the third-party opinion 196, or guarantee information.

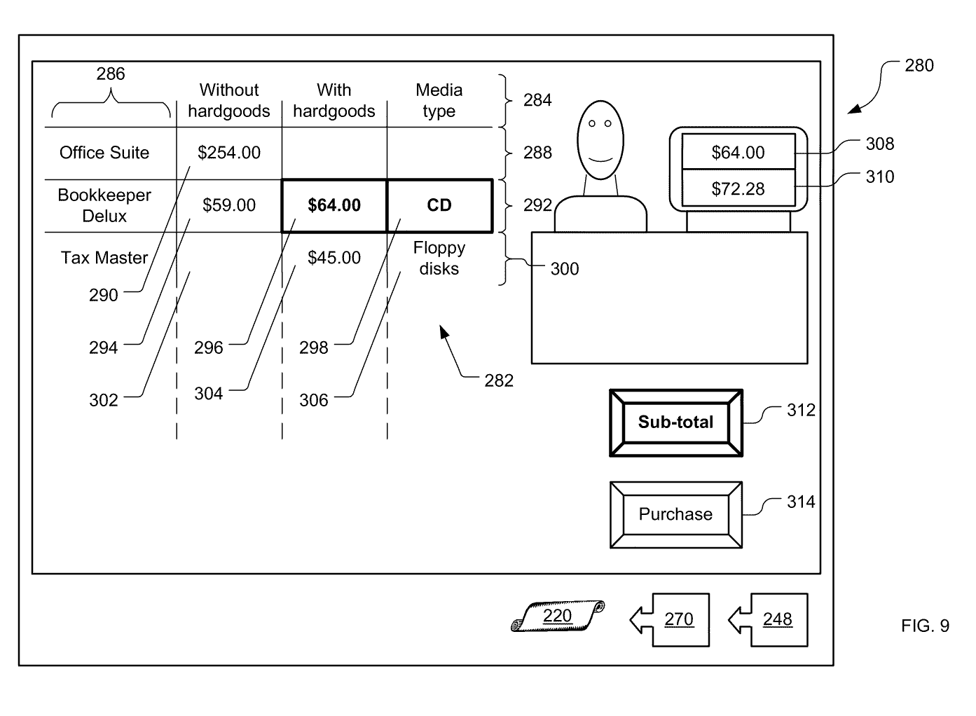

FIG. 9 depicts a suitable checkout view 280 for presentation to the customer 40. Included is an asset table 282 which displays information about all of the assets 22 presently in the shopping cart 166. Across the top of the asset table 282 are column headings 284, indicating availability options, e.g., “without hardgoods,” “with hardgoods,” and “media type.” Along the left side of the asset table 282 are row headings 286 containing respective asset names (from the asset data 186). Depending upon which columns they are in, the cells of the asset table 282 contain asset prices 188 or availability options, and in some cases also function as controls.

For example, assuming the availability options listed above in the asset table 282 presented in FIG. 9, the topmost row 288 contains data only in cell 290 (the leftmost). Further, cell 290 contains an asset price 188 which is not highlighted (in FIG. 9 heavy cell outline designates highlighting). This situation depicts that the asset 22 in row 288 is only available without hardgoods, and that the customer 40 has not yet selected this cell to confirm that they do want to purchase this.

The middle row 292 in this example contains asset prices 188 both in cell 294 and in cell 296, and cell 298 is highlighted and contains text describing a media type. This situation depicts that the asset 22 in row 292 is available both with and without hardgoods, at the respective prices, and that the “with hardgoods” option has already been selected by the customer 40 (as indicated by the highlighting of cell 296 rather than cell 294). The customer 40 here may chose among multiple media types (as indicated by the presence of highlighting in cell 298). Further, since cell 298 is highlighted, the customer 40 may operate it as a control, say with a mouse double-click, to cycle between the available media type choices.

The bottom row 300 in this example contains nothing in cell 302, designating that this asset 22 always comes with hardgoods (say a manual); a price in cell 304 (un-highlighted, and thus as yet un-selected); and un-highlighted text in cell 306. The absence of highlighting for a media type indicates that no choice is available, so the customer 40 should be particularly sure that they can use the media type being noted.

Also appearing in the checkout view 280 are a sub-total box 308, a grand total box 310, a sub-total control 312, and a purchase control 314. The sub-total box 308 displays a running total of the asset prices 188 for selected assets 22 in the asset table 282 (note that only one of the three displayed assets 22 is actually selected in the example, so only its price is used in the sub-total). By activating the sub-total control 312 the customer 40 requests display in the grand total box 310 of the amount in the sub-total box 308 plus applicable shipping costs and taxes (here the sub-total plus 8.25% tax and $3.00 shipping and handling). Activating the purchase control 314 formally requests that purchase take place.

Across the bottom of the checkout view 280 are the guarantee control 220, the return to store control 270, and the return to village control 248.

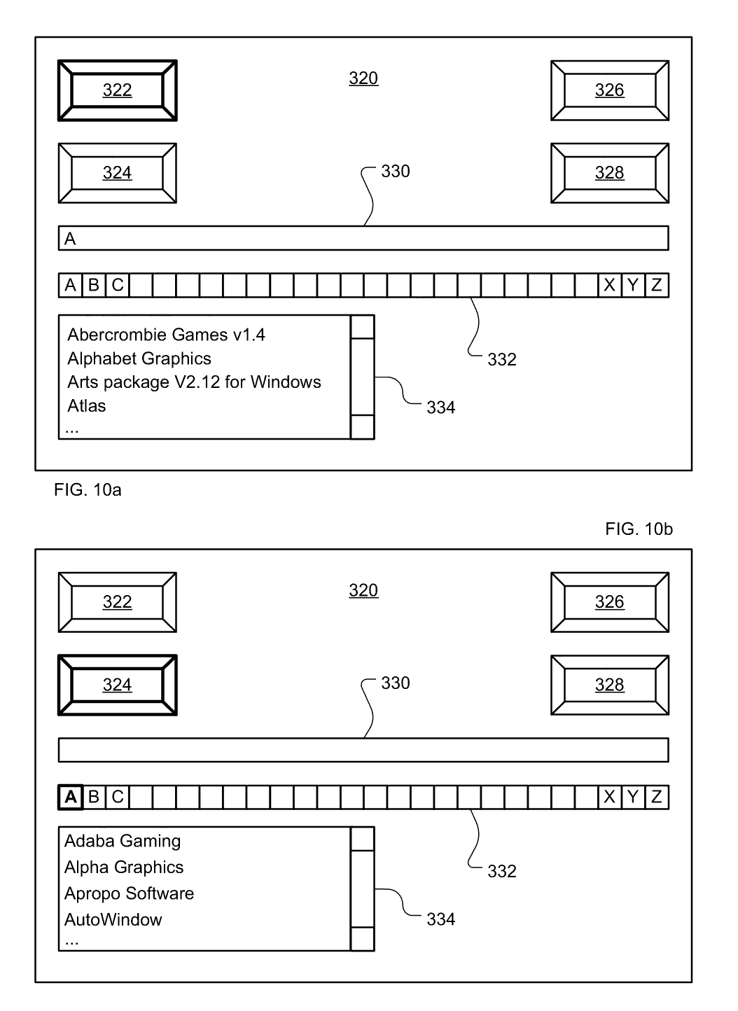

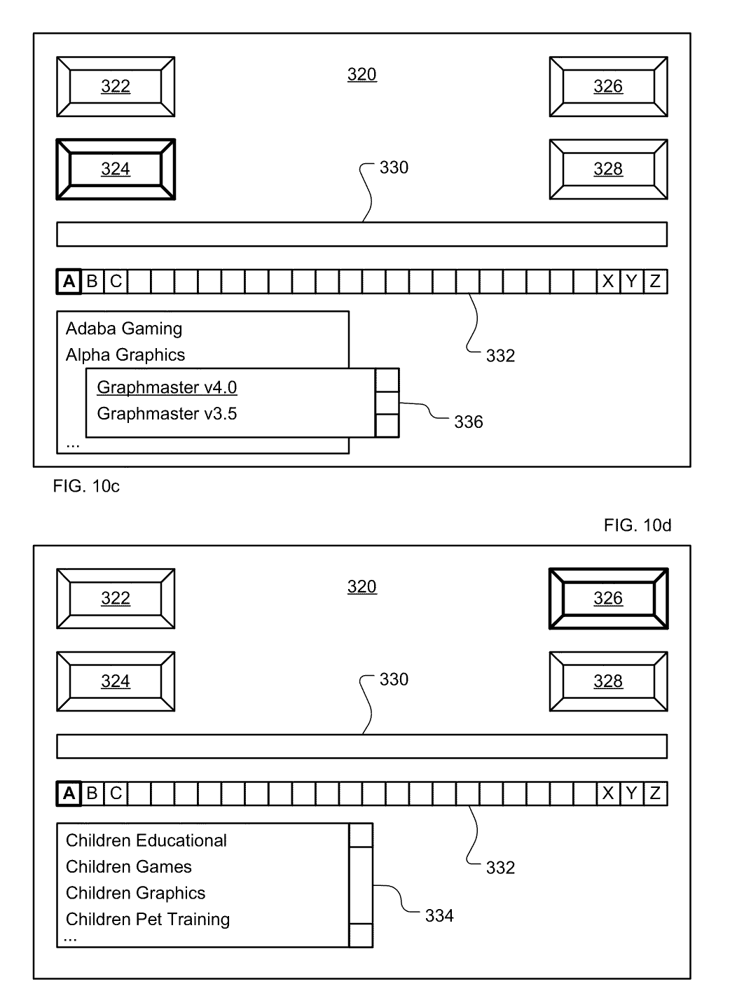

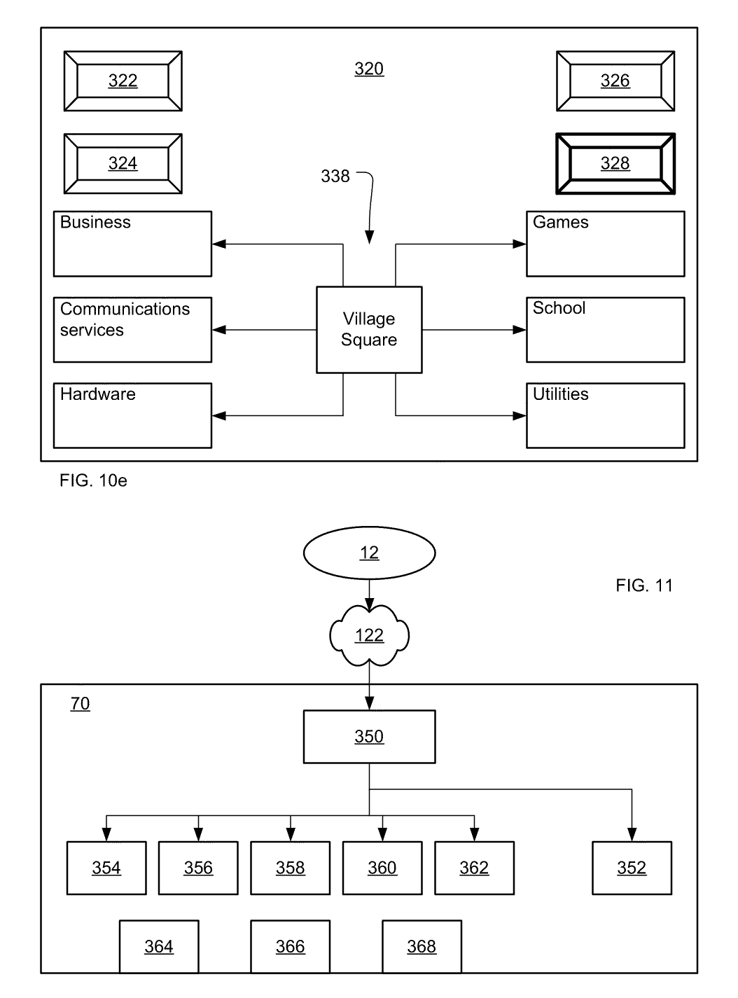

FIGS. 10a-e are stylized depictions of the information presented to the customer 40 when the search control 218 is selected. A search view 320 then appears which includes an asset control 322, a provider control 324, a category control 326, a map control 328, a text entry box 330, a character selection array 332, and a list box 334. In some cases the list box 334 can further include a sub-list 336 (FIG. 10c), and in one case the text entry box 330, the character selection array 332, and the list box 334 may all be replaced with a map sub-view 338 (FIG. 10e).

FIG. 10a shows the default of a search view 320, i.e., a view first seen by the customer 40. The asset control 322 is highlighted (shown with a heavy lining in the figure) to confirm to the customer 40 that the asset based variation of the search view 320 is currently active. The customer 40 may select a provider control 324, a category control 326, or a map control 328 to use other variations of the search view 320. Or, if they have already done so, selecting the asset control 322 will return them to the variation of FIG. 10a.

In the asset based search view 320 of FIG. 10a, the customer 40 may either type initial letters of the asset name (as it appears in the asset data 186) into the text entry box 330 (as depicted in FIG. 10a), or mouse click a first letter in the character selection array 332. These operations scroll the list box 334, which in this variation displays names for assets 22. Alternately, the customer 40 can directly scroll the list box 334. By appropriate choice, perhaps as a setup option, selection of a particular entry in the list box 334 causes an associated asset 22 to be added to the shopping cart 166, or this can take the customer 40 to the asset view 260, with the selected asset 22 there displayed.

If the customer 40 selects the provider control 324 the search view 320 changes to the variation shown in FIG. 10b. Again letters can be entered in the text entry box 330 or mouse clicking may be used to select a first letter in the character selection array 332 to scroll the list box 334 (the case depicted in FIG. 10b), but now provider names are instead displayed for assets 22 in both the inventory 18 (the names as recorded in the asset data 186) and also the master inventory 104.

FIG. 10c shows how selection of a particular provider name in the list box 334 can then cause further display of a sub-list 336 to show assets 22 available from the selected provider. Highlighting, underlining (used in FIG. 10c), or some other convention may be used to distinguish which assets 22 are present locally in the inventory 18, and which are in the master inventory 104. As discussed for FIG. 10a, above, selection of a particular asset entry can be configured to take the user to the asset view 260 or add the selection to the shopping cart 166.

If the customer 40 selects the category control 326 the search view 320 changes to the variation shown in FIG. 10d. Again letters can be entered in the text entry box 330 or mouse clicking may select a letter in the character selection array 332 (the case depicted in FIG. 10d) to scroll the list box 334, but now it instead displays categories of assets 22 in both the inventory 18 and also the master inventory 104. Selection of a particular entry in the list box 334 presents the sub-list 336, only now containing assets by category, and moving to the asset view 260 or addition to the shopping cart 166 can proceed.

In keeping with the village 46 metaphor, a map variation of the search view 320 may also be invoked, by selecting the map control 328. This variation is depicted in FIG. 10e, which has the text entry box 330, the character selection array 332, and the list box 334 all replaced with a map sub-view 338. The map sub-view 338 presents a graphic somewhat resembling a conventional map, but since geographic location need not be represented, what is instead displayed are general categories presented as regions encompassing related sub-categories. Here selecting a category or subcategory takes the customer 40 to an appropriate other view.

In the preferred embodiment, the DCVM 10 is a hybrid application that combines web content HTML, Microsoft Dot Net tools, and traditional C++ programming, as well as SQL based backend services to create a dynamic and engaging shopping environment in the setting of the stores 44 throughout the village 46. [N.b., While the village metaphor is becoming obsolete in some regards, compared to current implementations, the overall architecture even with updated technology is largely the same.] The DCVM 10 may employ features such as digital certificates, streaming video and a content advisor system. The invention is also scalable, making it able to work in most current PC 14 environments. A minimal base hardware platform for the embodiment described so far is a 90 MHz Pentium™ microprocessor with 16 MB of RAM, 50 MB of free hard drive space, video capability of 800×600 SVGA and 1 MB VRAM, a 16 bit sound system, a 4×CD-ROM drive the client OS 76 previously described, an analog, ISDN, DSL telephone connection or a cable-to-internet connection (or Ethernet network connection to a system having one of these), and Internet access software. Access to the Internet 122 is desirable, but optional. In addition to the above mentioned examples, various other modifications and alterations of the inventive DCVM 10 may be made without departing from the invention. [As can readily be appreciated, this means that the DCVM 10 can be embodied using mid-level 1998 technology, which even low-level 2008 technology now exceeds by orders of magnitude.]

Up to this point discussion has primarily been of the client 12. This has been because the master application 70 may be substantially implemented using conventional client-server and hypertext markup-up language (HTML) techniques. For example, FIG. 11 is a hierarchical overview of an implementation of the master application 70 of the inventive DCVM 10, using access via the Internet 122. The client 12 accesses the master application 70 by connection to a hypothetical site at w_w_w.master.com (w_w_w, h_t_t_p, and h_t_t_p_s, should be read without the underscore character which has been added to render links in this document inoperable; the label “master” is used here as a hypothetical site domain name). At an HTML home page 350, registered and non-registered clients 12 can enter here, as well as those accessing entirely other features 352 (although registered clients 12 will more typically go directly to desired lower level services). Alternately, accessing w_w_w.master.com/view invokes a browse module 354, so that the customer 40 using a registered client 12 can view extra assets 22 not in the inventory 18 of the client 12; accessing w_w_w.master.com/buy invokes a purchase module 356, for customers 40 to directly purchase such non-local assets 22 and/or hard goods 140 from out of the master inventory 104; accessing w_w_w.master.com/update invokes an update module 358, to update the inventory 18 in the client 12; w_w_w.master.com/comm invokes an issue service module 360, for support for issue resolution and access to frequently asked question (FAQ) lists; and w_w_w.master.com/fix invokes a technical update module 362, to obtain bug fixes and updates of the infrastructure 16 in the client 12. Finally, also shown in FIG. 11 are a customer database 364, a log file 366, and a report generator 368, all of which may also be largely conventional in nature.

Summarizing, the DCVM 10 may be implemented as a complete N-tier system that provides computer owners (especially new owners) with a convenient means of browsing, evaluating and purchasing digital content, both while online and while “offline.” The computer owners, or “customers” are able to peruse an inventory of digital content and information about it in a rich multimedia format, compare a large catalog of the inventory and prices, and then register, purchase, and even upgrade items of the digital content immediately.

The DCVM 10 is a media rich, and convenient consumer shopping experience. Delays are eliminated by pre-positioning all or at least substantial portions of the “store,” its inventory of assets, and collateral marketing materials at the customer's computer system. In particular, this can even be on the hard drives of new PC systems.

As has been described, the user interface the DCVM 10 may be based on the metaphor of a village, which consists of some number of shops, each of which contains some number of aisles, and each aisle contains some number of digital content items. Recall also that the digital content include either goods and units of service.

The inventory of digital content, advertising, and other information related to the digital content can be updated on a regular basis, both through mailings of removable media 24 and via network based synchronization and “push” techniques (e.g., via the Internet).

Of particular present interest, for the herein claimed locally driven advertising system, a valuable aspect of the DCVM 10 is its ability to track customer browsing behavior, purchases, and information requests along with what parts of the store are deleted or reconfigured by the customer. By compiling a customer profile and knowing the customer's preferences the most useful information, assistance, and advertizing can be provided to the customer. The DCVM 10 then can particularly pre-position advertising and inventory on the consumer's computer system, along with a convenient purchasing capability. This particularly permits the following business model for use with newly acquired computer systems.

The customers of such a model may include: end users, OEM and system integrators, independent software vendors (ISVs), and advertisers. The end users benefit because as consumers they gain high performance, and a convenient and compelling shopping experience for both pre-positioned digital content and remote hard-goods (typically, but not necessarily, related to the pre-positioned digital content). The consumer enjoys a focused inventory selection process and, for pre-positioned digital content, a highly convenient and nearly instantaneous purchase process regardless of the size of an item. The OEMs and system integrators gain an annuity-style revenue stream by hosting the DCVM 10 on newly built computer systems. The ISVs gain access to significantly increased visibility, particularly during the “peak buy period” for the newly acquired system, with virtually no distribution cost. And the advertisers have a new platform for advertising that has two key values: an upscale directed client base, and detailed data on the end users who see the advertising. The advertiser has a number of options, including a full store presence, banner advertisements, etc. The types of advertisers may include intellectual property providers (IPPs), hardware system and accessory providers, and Internet service providers, among others.

The services provided by such a business model may include: hard goods fulfillment, clearing house services, and direct system provider services. For hard goods fulfillment the DCVM 10 is uniquely positioned to provide a convenient shopping access to hardgoods fulfilled through traditional means (e.g. EDI or more common XML forms of communication), contemporaneous with its digital content vending role. The DCVM 10 is also able to provide for necessary commercial clearing house functions, say, by means of a strategic partnership with one or more clearing house providers. As direct system provider services, the DCVM 10 can provide: customer turnkey business solutions for OEMs and system integrators; management of collateral and the digital content inventory (to collect, organize, integrate, package, test, etc.); maintenance of the infrastructure or “stores”; golden master production for loading the media delivery system; collections and billing; as well as be a provider of utilization and advertising demographics data.

The initial versions of the DCVM 10 were targeted at home users and small office/home office (SOHO) users. Then small business, corporate and enterprise markets were additionally targeted with focused features and appropriate methods of communicating in subsequent releases. The initial release was also targeted to client systems running the Windows 95/98/ME/2000/NT operating systems All™ by Microsoft Corporation of Redmond, Wash., but extending other embodiments to other operating systems has proven straightforward and current embodiments of the DCVM 10 run well under the Windows Vista™ operating system.

As described herein, the version of the DCVM 10 principally used for the sake of example herein uses a village or “mall” shopping metaphor and a storyboard to group and differentiate information related to the digital content. FIGS. 2a, and 5-9, previously described, generally cover this.

Within this village metaphor a user interface provides for: browsing and navigation, search, and purchase. A combination of a browser interface and integrated application can be provided for update control, purchase management, and configuration control. The end-user customers can then use a web browser-like application to shop, browse, navigate, and initiate purchase through the DCVM 10 of its contained or associated digital content.

The stores 44 of the DCVM 10 include digital content from two sources: pre-positioned digital content (in the inventory 18 already at the client 12; see e.g., FIG. 1a) and extended or master inventory 104 located in online extensions or a content server (e.g., the master server 48 of FIGS. 2b and 3).

The DCVM 10 may make a compelling presentation, particularly including high performance access to content allowing greater use of high-resolution materials. This particularly facilitates easy navigation to find digital content, easy searching, an application which is browser-based, and seamless continuity with online extensions of the DCVM 10.

“Shopping Cart” and “Checkout” metaphors may be used for both off and on line purchasing. FIGS. 6-9 generally illustrate this. Checkout may be accomplished via an online connection (say, to a Distributed Transaction Server). Alternate purchase options are possible, such as providing human operator supported telephone support, purchase support for standard credit cards, and purchase support for “credits” for “freegoods,” as may be required by partner OEMs.

Softgoods fulfillment may be accomplished by unwrapping (typically including decrypting) pre-positioned intellectual property and by providing means for additional download of intellectual property (and subsequent unwrap/decrypt).

Hardgoods fulfillment may be accomplished via forwarding purchase requests directly to hardgoods fulfillment houses and indirectly through clearing house arrangements for EDI based fulfillment.

As described further herein, the client 12 based store of the DCVM 10 may be updated through online push channels and through distribution of removable media 24 (FIG. 1b). Digital content assets 22, collateral materials, look and feel elements (all treatable generally as digital content) as well as the infrastructure engine, are all candidates for update in this manner. Updates to a client 12 may be prioritized based on design specified requirements and user set policy. Prices and easy, small updates typically will be updated most frequently, but permission to update can be set by client policy. Easy transition between “browsing” and “update” modes can also be provided so that users will control and manage updates by policy and by category. Concurrent with this, the user's behavior (i.e., that of the customers 40) can be tracked and profiled, and this in turn facilitates updating and ensuring that user set policy is met.

Customers may be provided with a content manager as part of the infrastructure 16, to control and manage aspects of the DCVM 10. The entire village 46 may be removed under user control, for instance, and new stores 44, aisles 164, and digital content assets 22 may be added to the existing local stores 44 in order to expand or to get better performance in a particular area, or removed in order to reclaim storage space at the client 12.

The customers may therefore set Policy for actions in various areas. For example, they may update policy, e.g., specify to always warn, ask, or never warn. They may set connection policy, e.g., to anytime/automatic, ask, never. They may define privacy policy, e.g., to tell all, to say nothing, or somewhere in between.

Customer and OEM unit identification can be established and maintained through on-line, voice, and mail registration. The customers can be encouraged to provide additional profiling information through awards and granted digital certificates. Award and “freebie” activities can also be coordinated with the individual OEMs. Customer activity in the stores 44 can be tracked, and uploaded as profile information ultimately to be stored in a customer information server. Of course, a privacy policy can be established and maintained within the conventions of Internet shopping.

Some particularly customizable components can be sponsorship and advertising graphics. In addition, identifying information can be embedded into each OEM associated client 12, such that purchases and activities associated with a particular release of the DCVM 10 can be tracked. (Enabling Oem Associated Tracking of Transactions.)

The DCVM 10 can provide customer service through a variety of outlets, and services. Arrangements can be made with OEMs for direct support of particular OEM's goods. Goods sold through other arrangements, say, with hardgoods manufacturers, can also be supported directly by the manufacturer.

The DCVM 10 can provide direct customer service for order management and fulfillment, payment, first line digital content installation issues and for technical support questions and problems. These services can be provided through a web support site, or by fax or e-mail.

A business model using the DCVM 10 can place significant requirements on central development and MIS core services. But these are manageable, as is now discussed.

Appropriate build management can be used to create multiple master stores 44 for the purposes of OEM duplication and for online use. In early embodiments, each such OEM master was estimated by the inventors to contain between 50 and 200 products, media, and services (i.e., assets 22), a large number of associated advertisements and collateral, plus the components of the store infrastructure itself. Content build management can be used to efficiently and rapidly rebuild OEM specific stores 44 using this. To this end, content build management may typically use a content inventory database, containing all components for all the stores 44 (online, and masters for pre-positioned stores), and a component management system where stores will be treated as top level assemblies comprised of subassemblies. Suitable integrated assembly tracking systems for this can be purchased or developed.

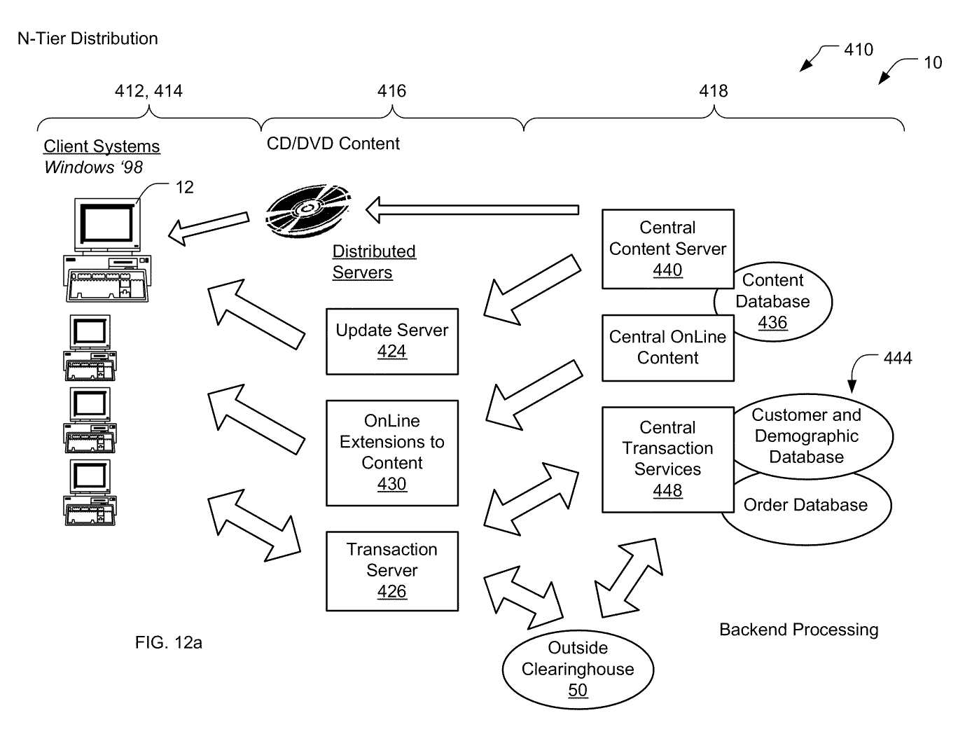

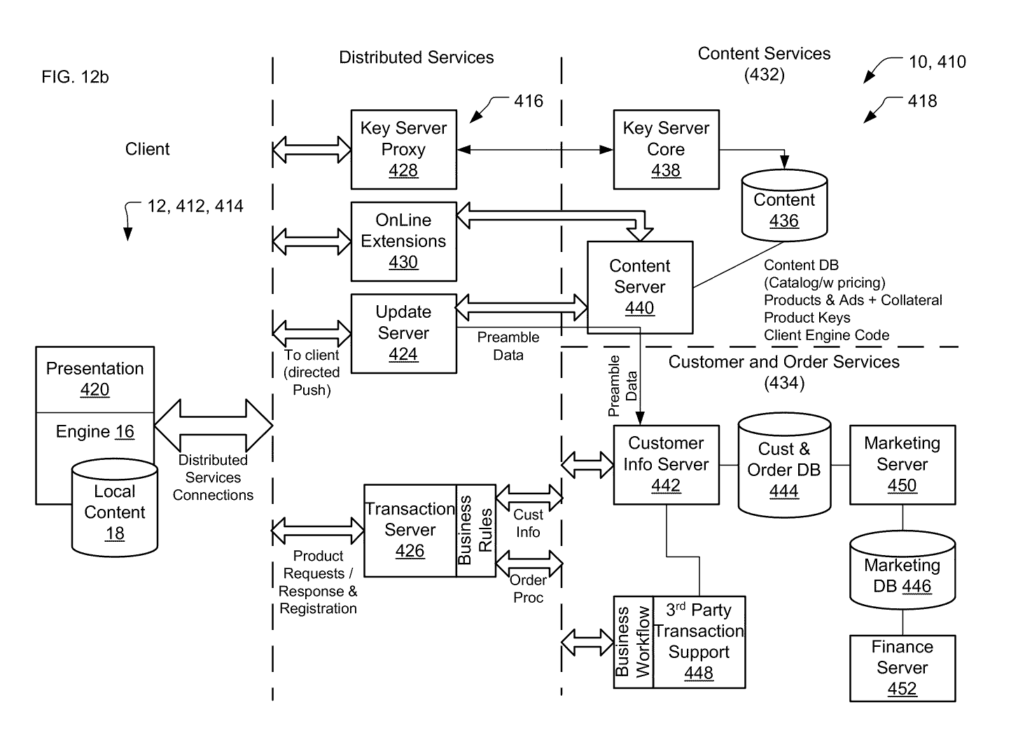

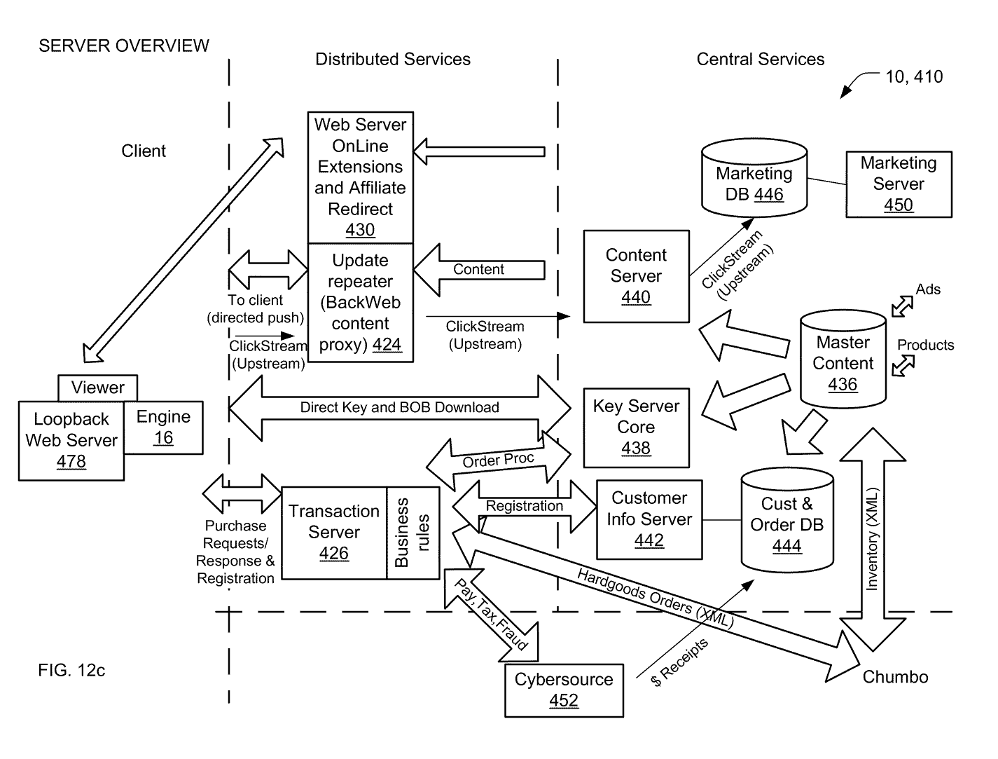

A profile of each customer can be kept in a customer database (see e.g., FIG. 12b). This database can then be used to assist with direct interactions with the customer, to customize online transactions and updates to each customer, to assist with fraud detection, to assist with billing, and to provide marketing and demographic material through data mining techniques.

Intellectual property resident on the clients 12 may particularly be protected, with state of the art encryption techniques. As has been described, the DCVM 10 can include pre-positioned software products and other types of intellectual property assets 22 of considerable value, and such may be provided in a protected or limited use form until purchase. Many arrangements for this can be made. A “Buy Only” (BO) asset 22 can be made unavailable to an end-user until purchase. Upon purchase, a non-sharable key 58 (FIG. 2b) can be applied to a wrapped “Bag'o Bits” (BOB) to unlock it, and to initiate installation. A “Try Before You Buy” (TBYB) asset 22 can be made available in a form, say, limited by maximum number of tries, maximum amount of use, or maximum duration. Such a TBYB type asset 22 may be either “wrapped” in a digital wrapper 60, and limited to running in a protected environment, or “injected” with a runtime module that restricts use. A third form of “Try Only” digital content has advertising value, but no direct revenue value, as it cannot be purchased.

Thus, all of the assets 22 (BO and TBYB), as well as collateral digital content, if desired, may be protected from theft through the use of industry standard and commercially available encryption and wrapping, and obfuscation techniques.

Customer purchase transactions can be conducted via Secure Sockets Layer (SSL). Customer purchase information can be protected via state of the art firewall techniques. Private purchase and transaction information between distributed techniques can be via state-of-the-art VPN or via private leased lines. Online stores and update servers may be made either “read-only,” “proxies” only, or both. Interaction with outside clearing houses can be through a combination of certified (signed) public/private key links, or through other secure means.

Up to here the discussion has been of client side security, but the backend components of the DCVM 10 can also be well protected. Generally conventional techniques can be used for this, and this discussion will not generally cover such. For example, those skilled in the art will recognize that all of the backend servers can be protected with state of the art firewall techniques and private secure networks for administrative purposes.

Embodiments of the DCVM 10 can be designed to potentially support millions of clients, which is particularly important when employing communications mediums like the Internet 122 (FIG. 3). The entire DCVM 10 can be designed for high scalability and high reliability. By making use of an N-Tier approach, frontend services can be duplicated and distributed as load increases. Frontend services can also be topologically distributed, to be “close” on the Internet 122 to a maximum number of clients 12. Of course, backend centralized services can also be scaled and replicated as load increases.

FIGS. 12a-c depict how the DCVM 10 can be implemented as an N-tier configuration 410, grouped by function and location with a first tier 412, a second tier 414, a third tier 416, and a fourth tier 418. FIG. 12a is a block diagram overview of major tier elements; FIG. 12b is a block diagram of a more detailed architecture topology overview; and FIG. 12c is a block diagram of a server oriented overview of the N-tier configuration 410.

The first tier 412 is a presentation service 420, and is resident on the client 12. This first tier 412 includes the viewer application of the DCVM 10, one which is capable of rendering dynamic HTML, along with various graphic, audio and video elements. It also includes a content manager and client management functions, as part of the “engine” or infrastructure 16.

The second tier 414 typically consists of a local “proxy” HTTP service, a client transaction agent, and content cache. The second tier 414 can also be hosted on the clients 12, or on a local proxy server system.

The third tier 416 contains distributable components and frontend servers. The frontend servers include content proxies (e.g., a push or update server 424); a transaction server 426, which handles purchases and initial registration requests; a key server proxy 428; a contents extensions server 430; and various support (and corporate) web servers as needed.

The fourth tier 418 can be grouped into content services 432 and customer and order services 434. The content services 432 typically contain all centrally maintained active content, including “BOBs” of digital content which may be sent to clients 12 as assets 22 and keys 58 to unlock digital wrappers 60 protecting them, advertising collateral, and presentation infrastructure. This is typically stored in content databases 436 and handled by a key server core 438 and a content server 440. Behind the content services 432 and production facilities which create and aggregate content, there are additional services such as the actual distributors and the ISVs.

The customer and order services 434 include a customer information server 442, which works with a customer and order database 444 (or multiple databases) and a marketing database 446. Behind the customer and order services 434 are the actual 3rd party fulfillment and clearing house 50 services. Additional servers can also be provided here to provide additional services. FIGS. 12a-c illustrate this, with the customer and order services 434 here further including a 3rd party transaction server 448, a marketing server 450, and a finance server 452.

Business and transaction logic is evident through all of the tiers, starting with the first tier 412 presentation and execution of client transaction applets, communicating with a client transaction agent (executing in the engine of the second tier 414), communicating with the third tier 416 via the transaction server 426 (which hosts a server transaction agent), applying of specific business rules in the transaction server 426, and applying business rules in the customer information server 442.

The clients 12 remain self contained and may browse and shop off-line. The clients 12 may also go online at any point to also shop online or to obtain updates. Also, once a customer is ready to purchase, they are guided to a “purchase page,” and may be given the option to purchase “online,” via voice operator, or via mail or fax. Customers who do choose to go online can communicate directly with four or more different types of services available. However, to a large extent, the customers are unaware of transitions between the different services and will, in fact, likely be communicating with several services simultaneously.

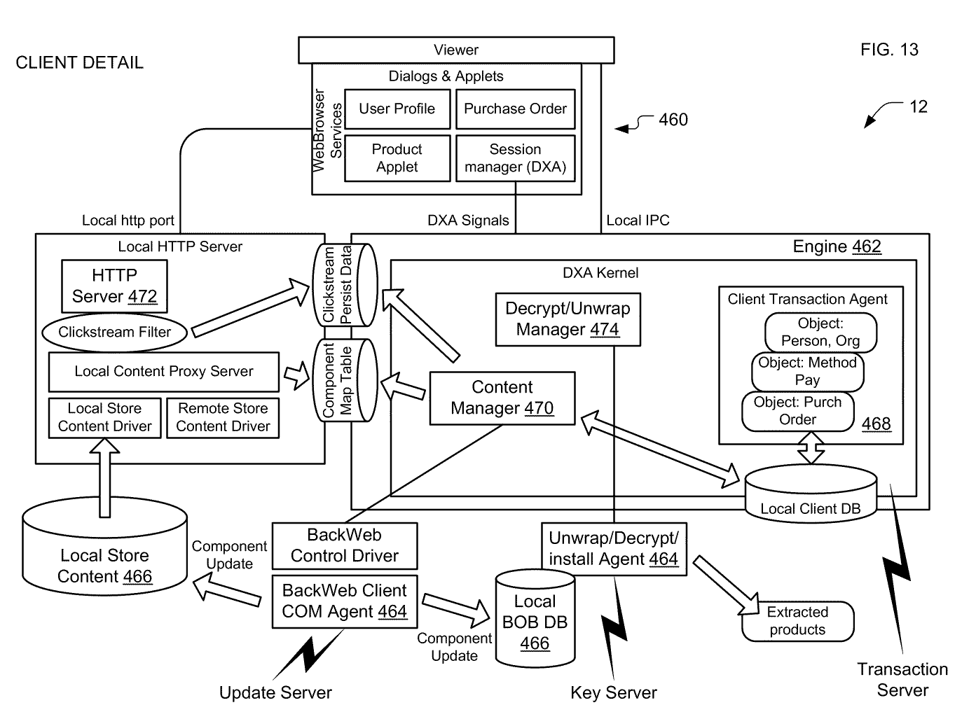

FIG. 13 is a block diagram which particularly depicts the first tier 412 and the second tier 414 of the client 12 in the embodiment of the DCVM 10 of FIGS. 12a-c. The client 12 can conceptually be decomposed into a viewer application 460, an engine 462 (essentially the infrastructure 16 simplistically represented in FIGS. 1a-b), a set of agents 464 providing access to third party technology, and a local cache 466 of the digital content and collateral (including the local inventory 18 of FIGS. 1a-b).

The viewer application 460 may be a thin application that provides viewing, browsing, script interpretation, and rendering to standard “web technology” data and graphics files. In the presently preferred embodiment, the viewer application 460 makes use of built-in Microsoft Web Browser™ and Microsoft's HTML services, that are also used by the Internet Explorer™ browser. Except in a few areas, the viewer application 460 may be identical to this browser with regard to support of HTML, cascading style sheets (CSS), Javascript™ and VBscripts, JAVA applet interpretation, graphics rendering ability, and plug ins. All plug-ins provided to the browser may thus automatically be available to the viewer application 460, and vice versa.

One key exception to this may be in the area of applet security, however. As a standalone application, the viewer application 460 need not be constrained by the security sandbox and rules of the browser. While this makes it easier for one's own applet development, it also creates the potential for a security hole. For this reason, the viewer application 460 may invoke a default browser whenever it follows a non-local link.

The pages for the digital content assets 22 offered. i.e., the stores 44 etc., may be constructed with a set of applets, typically including a ProductApplet, a PriceApplet, and a SessionManager. The viewer application 460 can also communicate directly only with the engine 462, communicating effectively in a loopback to a local HTTP server and a local service socket. HTTP communication occurs through the browser's HTML services. The SessionManager can handle the socket communication for the viewer application 460.

Some typical applets and associated functions might include the following. A ProductApplet can provide the mechanism for adding an asset 22 from the inventory 18 (FIG. 1a) to the shopping cart, buying it immediately, or requesting more information (HTML pages) about it. A PriceApplet can present the most current pricing in an attractive format to the user. This applet queries a client transaction agent 468 (FIG. 13) in real time for up-to-date pricing information. A SessionManager applet can be responsible for populating the customer profile and for handling the method of payment, shopping cart, and purchase order. This can be a multi-threaded, invisible applet. It then can allocate additional threads for the session manager daemon and an observable helper object. A Content_Manager_Interface applet can also be invisible, and present to receive a number of applet tag parameters describing the store, aisle, and product preferences for a given user during the current and subsequent sessions.

Continuing with FIG. 13, the engine 462 is the general host environment for the client transaction agent 468, a content manager 470, a proxy HTTP server 472, and a decryption manager 474 (as well as many others). All internal components of the engine 462 here are developed in the Java™ language. The engine 462 then may be either a set of distinct classes run by the Java runtime engine (JRE) or may be compiled into one or more executables and supporting dynamic link libraries (DLLs). This engine 462 was previously built on a Java defined framework named the Dagny execution architecture (DXA)™, from CIME Software Labs, LLC. Of course, other languages, components, and compilation methods may also be used. Updated versions in 2008 are built with Microsoft's Dot Net framework with C++ and SQL service architecture, using other compatible technology choices as appropriate.

A summary of key elements in the engine 462 follows. The client transaction agent 468 provides the transaction integrity mechanism for the client 12 by managing: user profiles, methods of payment, and purchases. The client transaction agent 468 handles a number of threads and states and synchronizes transactions in a two-phase commit process. The proxy HTTP server 472 delivers locally stored digital content and provides a mechanism for click stream tracking. The decryption manager 474 acts as an interface and manager to a 3rd party (Preview) decryption/unwrap agent. The content manager 470 acts as an interface and manager to a 3rd party push agent.

Returning now to FIGS. 12a-c, we continue with discussion of the third tier 416. A number of concerns have motivated the inventors to use proxies in this version of the DCVM 10, and some initial comments on these are appropriate.

The DCVM 10 must preferably be robust, fault-tolerant, scalable, and avoid any single point of failure. Two ways of partially meeting these requirements are through the use of mirror sites and (caching) proxies. Mirror sites actually contain complete copies of data, and proxies work by providing a transparent front end to a central backend repository of data. The use of proxy servers provides a means of distributing load, by creating an alternate location for service.

The proxy servers can be deployed in two particularly advantageous ways. First, they can be topologically distributed (e.g. US West Coast, US East Coast, Europe, etc). Once the required information is cached, customers can be serviced more quickly from proxy sites that are topologically closer than the central site. Alternatively, multiple proxy servers can be deployed in (or close to) the central server site. As long as that central site is well placed in the Internet it is “topologically” close to all locations. In this case, the proxy servers still provide processing redundancy.

The distributed services of the third tier 416 include all of the front-end service that the client 12 (first tier 412 and second tier 414) needs to communicate with directly over the Internet 122. Included in the embodiment depicted are the update server 424, transaction server 426, the key server proxy 428, and the online extensions server 430. Support servers and additional web servers, such for corporate identity web sites, etc., can also be added as desired.

In this version, by intent and design the frontend servers do not contain, for any significant period of time, any unique or persistent information. (They may cache information for a limited period.) Instead the frontend servers are either proxies or flow-through mechanisms between the clients and the back-end services.

The update server 424 here is a pure proxy for an offline access server (e.g., BackWeb™) implemented backend “Channel” (Content Server). The offline access system used supports a central/distributed architecture where there can be one central server, distributing (read-only) to proxy servers. This supports both proprietary UDP based messages (e.g., with BackWeb Transport Protocol, BWTP) and messages via tunneled HTTP. When the protocol in use is BackWeb's proprietary BWTP, a BackWeb proxy server is used. When the protocol in use is HTTP, any proxy server may be used. BWTP is also the protocol used with regard to BackWeb's “polite” client agent. Current versions are built around Microsoft BITS services with many custom feature sets.

The online extensions server 430 may be a standard web server, providing additional content not already available on the local clients 12. This may particularly be optional, and the offline access server channel may provide sufficient content extension and real time update facilities without requiring this.

The support server (integrated into the extensions server 430 in the figures) may be a standard web server providing “standard” technical support and customer support mechanisms. It can include a means of tracking open orders, requesting refunds, asking for assistance, etc. The support server may have access to the customer and order database 444 via the backend customer information server 442. This site does not require any special services, and can be implemented with a standard web server such as Microsoft IIS™ running on Windows NT Server™.

The key server proxy 428 may be implemented using Preview Systems' ZipLock™ server technology. This provides client support for requests for the keys 58 and digital wrappers 60, once a purchase authorization has occurred. It is preferably in place as a proxy only, and requests are “flowed through” to the backend key server using this server to server protocol.

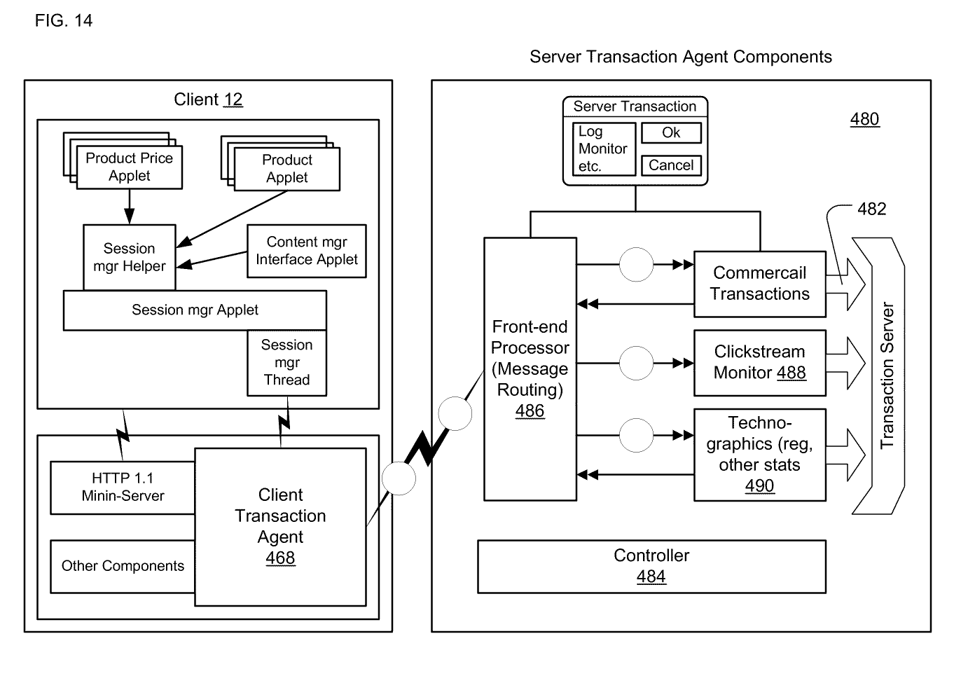

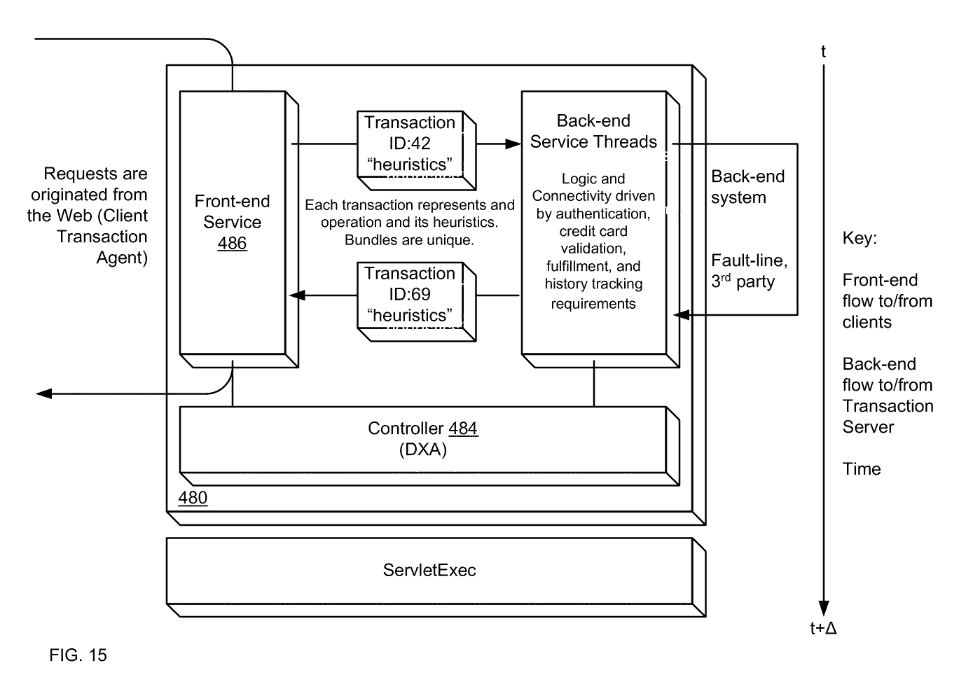

The transaction server 426 provides services for client registration, purchase and fulfillment. The purpose of the transaction server 426 is to act as a broker between the clients 12, and the back-end services of key fulfillment, clearing house activities, order handling, and customer information data services. The transaction server 426 can be decomposed into two primary components: a server transaction agent 480 and an order processing pipeline 482 (FIGS. 14 and 15).

The transaction server 426 communicates with clearing house(s) through protocols typically established by a clearing house server (see e.g., clearing house 50 in FIGS. 2b and 3). In the case of Cybersource™, which the inventors have used in some embodiments, that protocol is SCMP. In the case of OrderTrust™, used in other embodiments, the interface is via a proprietary OrderTrust SDK. Latest versions utilize clearing services from Authorize.net or any commercial transaction clearinghouse.

The transaction server 426 may host the server transaction agent (STA) by running it as an servlett. The STA is the server counterpart to the client transaction agent 468.

FIG. 14 is a block diagram illustrating particular agents and applets in the client 12 and the transaction server 426, and particularly includes an architecture for the server transaction agent 480.

The order processing pipeline 482 is the component responsible for executing the business logic or “rules” associated with each purchase request. The order processing pipeline 482 is concerned with completing full transaction on each order. A transaction can be thought of as a set of events that are committed or rolled back as a unit—either all of the events happen, or none of them do.

For softgoods the transaction sequence may be, approximately: credit authorization, optional fraud evaluation, order record open, key request from the ZipLock server, key response (ZERT) to the client 12, and credit commit or conveyance.

For hardgoods, the order process may be a sequence of: inventory check, credit authorization, optional fraud evaluation, order placement, and order record update to the client 12.

FIG. 15 is a block diagram of more detail in the transaction server 426 of FIG. 14, and is used in the following conceptual overview discussion. In this version of the DCVM 10, a Microsoft Transaction Server™ hosts the server transaction agent 480. This is in turn extended with NewAtlanta's Servletexec™ servlet product.

The server transaction agent 480 is implemented as a servlet that spawns a collection of threads running in a middle-tier server. This middle-tier server ties together all transaction and content flows. The server hosting the server transaction agent 480 is also preferably responsible for fault tolerance and load balancing to the back-end components.

A multi-threaded approach may be employed, wherein a controller thread is responsible for allocating all resources, proxies, interfaces, and screen widgets associated with the server transaction agent 480. A controller 484 can also manage safe execution and start and stop the service threads for the server transaction agent 480, described below. A threaded frontend service 486 can manage all interactions from the clients 12 and the master server 48 (FIG. 2b). The frontend service 486 routes all requests from the client 12 to its respective handler in the backend. The frontend service thread packages each request in a uniquely identified bundle. A commercial transaction backend can format a purchase request and forwards it in a platform-independent format to the Microsoft Transaction Server. A click stream monitor 488 (FIG. 14) can forward a click stream log file from a given client 12 to its corresponding service in the backend. This thread may have “one way” flow because the click stream transmission does not have to be acknowledged by the backend as anything more than a Boolean value (failed/succeeded). A technographics service 490 (FIG. 14) can forward purchase pattern and other customer personalization data gathered by the client 12 (browser, CTA, digital content purchase patterns, etc.) to the backend marketing engine. This thread also handles customer registration (“first time use” or “first time buyer” depending on policies set) for each user within an organization (family, work group, department, company) as defined in a business object specification.

Note, the transaction processing may particularly be asynchronous. Unique transaction IDs can be used for notifying the services and controller 484 of state changes. The services and the controller 484 thus can implement a modified observer design pattern.

The observer is a normalized method used for asynchronously notifying multiple, unrelated or loosely coupled objects, of activities running in separate threads, processes, or even computers (via Corba or RMI) of some event, such as the completion of a transaction. Observer patterns are very good for handling large numbers of asynchronous events because resources (processor, memory, connectivity) are only consumed when there is need for them. Other alternatives, such as polling, eventually exhaust system resources by keeping the system needlessly busy.

Backend services of the fourth tier 418 include all centrally maintained digital content and databases. As briefly noted previously, the fourth tier 418 can be grouped into the content services 432 and the customer and order services 434.

With reference again to FIGS. 12a-c, the content services 432 may contain all active content, including asset 22 “BOBs” and keys 58, advertising collateral, and presentation infrastructure. The content services 432 are split into the content database 436, the key server core 438 (the core or one of a number of related servers) and the content servers 440 (which includes the content server and the offline access channel server).

The content database 436 is the central repository of all active content. It provides active content for the key server core 438, and the content servers 440, and indirectly for all media updates to the clients 12. While this is shown graphically in the figures as a single database it may, in fact, be several databases plus a structured file system.

The content services 432 include the core key services, as implemented in early embodiments using Preview Systems' ZipLock™ server services. Once purchases are authorized, upon brokered request by the key server proxy 428, the key server core 438 obtains a product key, wraps it uniquely for the target client 12, and provides it as the key 58 via the key server proxy 428 back to the client 12. The core key services server system provides for a hierarchical approach to key servers, so that there is the technical option to connect to third party key servers as well, such as those hosted by distributors or hosted directly by particular ISVs.

For transaction security, all messages between components in the system are multiply encrypted with strong encryption. Each message is encrypted with a session key (90+ bit RC5) and then that key is encrypted with a public or private key (1000+ bit PKCS) before sending the message to or from the server. The server maintains all private keys. No private key is ever sent, in any form or by any means, to anyone. Merchants (distributors and resellers) only receive public keys.

Each merchant account (used by a Vbox client), storefront (e.g., ZipLock gateway) or remote server corresponds to a different public and private key pair, so each communication link is encrypted in a different way. Every message also has its own session key, therefore no two messages sent within this system can ever be decrypted the same way.

In this version all transactions are encrypted, MIME encoded, and then sent using normal HTTP (not SSL), specifically to minimize any firewall-related problems.

The core key services server generates the unlock key for an asset 22 automatically when an offer for an asset 22 is created. The unlock key is both stored in the ZipLock server database and written out in the PID file that is used by the ZipLock builder. Subsequent changes to offer data do not affect the generated key. Resale offers do not have their own keys, only offers that correspond directly to the creation of assets 22 in the inventory 18.

The ZipLock builder uses the unlock key when building the BOB files for assets 22, and the Vbox client uses the unlock key when installing or reinstalling the asset 22. For security reasons, the unlock key is not put into the file. The only way to get the unlock key for an install or reinstall is through the Vbox client from the ZipLock server that generated the PID file used by the ZipLock builder, for all practical purposes this is an impossibility for any hacker.

The ZipLock system uses well-known, reliable encryption algorithms from RSA™ (such as RC5) at levels that cannot be cracked without some form of infeasible brute-force approach. In addition, the ZipLock server employs encrypted and transparent means to deliver keys only to Vbox client. The unlock key itself is always encrypted before being sent from ZipLock server to the Vbox client, and is never stored on disk at any time on the customer's machine. The client-server architecture will accommodate other types of commercially available secure delivery mechanisms similar to Ziplock.

A channel server (within the content server 440; FIGS. 12a-c) provides and serves updates for all collateral, infrastructure, and asset 22 BOBs to clients 12. The channel server is based on push technology. Specifically the inventors in early embodiments have used push technology from BackWeb Technologies. In general this technology allows defining a “channel” of information that feeds (pushes) information to the clients 12, optionally via proxies.

The channels can be further divided with additional granularity, into “subchannels,” “infopaks” etc. BackWeb supports scripted “extracts” of information from databases, file systems, and even external websites.

The update mechanism can be based on an offline access server's custom sub channels and “file distribution” sub channels. For instance, BackWeb has some built-in support for interaction with Oracle™ and Informix™ databases. It has less direct support for Microsoft's SQL Server™ or standard SQL scripts, but does apparently have “automation” scripts that work with the standard Microsoft NT™ database interface, ODBC. This allows the use of any database, including Oracle and SQL that can talk to ODBC on the backend. The update server can either directly (via a custom channel) or indirectly (via a file distribution channel) pull content out of the content database 436.

The customer and order services 434 includes remote operating databases which work with the DCVM 10 (as contrasted with the also remote content database 436).

A customer database (made part of the customer and order database 444 in the embodiment represented in FIGS. 12a-c) contains a record for each registered customer of the DCVM 10, reflecting all gathered information about each registered and profiled customer. It is “fed” by the customer information server 442, and in turn “feeds” the marketing server 450 and the finance server 452.

The primary key in the customer database is a user unique ID (UID), assigned to and associated with each registered client 12. Associated with each UID are records for a computer system ID, a processor serial number, disk serial number, and additional fields as desired.

An order database (made part of the customer and order database 444 in the embodiment represented in FIGS. 12a-c) includes information about all orders, open or completed successfully, denied, or refused by the customer, aggregated from the distributed transaction server databases into a single central location. The order database is “fed” by the customer information server 442, and in turn reports to the finance server 452, the marketing server 450, and the marketing database 446.

The marketing server 450 and the marketing database 446 provide profiling and real-time data-mining capability for the DCVM 10.

Each store 44 can be an assembly of several thousand assets 22 and there will be several stores 44. A fairly large inventory 18 is anticipated. In order to manage these assets 22 they may all be stored in a single central Microsoft Access™ or SQL database. In this version an internal page construction tool, based on Cold Fusion™ was developed that creates a set of “pages” and associated content from a named set of templates. Recent technology developments have led to other technology choices to improve speed, and reduce overhead, but the basic architecture remains the same.

The inventors prefer to use outside services for clearing house activities (e.g., the distinct clearing house 50 depicted in FIGS. 2b and 3). At the current time Cybersource™, OrderTrust™, and Insight™ have been identified as suitable partners for such clearing house activities, including credit card validation and fraud filtering, as well as hardgoods order fulfillment. Tech Data™ and Ingram Micro™ have recently been added for hard goods fulfillment.

All store infrastructure and digital content (assets 22, ads, collateral, etc.) are first created or received by a human operator, where they are entered in the component control mechanism (e.g., Agile™ or similar) hosted on a process server. Every component has an associated revision level.

Once received, it becomes part of an acceptance process. It is evaluated and tested in a number of ways, depending on the content, and its purpose. For example, advertisements are evaluated for look, size, content, and color. Store infrastructure components (e.g. HTML and DHTML source) are tested and evaluated for correctness, as well as visual aspects. Intellectual property components are evaluated for compatibility with various targets, size, and so on. Once a component is fit for at least one build, it is “accepted”. (Note that part of the test and evaluation process is to create sample “builds”, and move to a “test” area.)

“Builds” become SKUs (literally, shelf keeping units) which comprise master(s) for various targets. An SKU will typically be required and generated for a group of OEM handled clients 12, for removable media 24 (e.g., CD 26 or DVD 28), and for target servers.

In one preferred distribution model, duplication of master content onto the hard drives 20 of clients 12 can be done by the OEMs.

Registration of clients 12 typically begins the first time the customer boots up a client 12. An OEM can provide an online registration sequence for this. The registration can piggyback off that sequence (obtaining information from the OEM registration), or can follow in a natural, friendly way. An incentive can be provided to the customers to complete the registration and to connect to the registration service (on the transaction server 426). As much information as possible can be obtained without customer intervention, such as OEM, system or processor Id, disk serial numbers, time of day, followed by reasonable customer information such as name, address, phone, etc., followed by an opportunity to set profile information and to set update, privacy, and connection policy. This information is encapsulated and sent to the registration service (on the transaction server 426).

A registration service component of the transaction server 426 can digest this information, and create a unique identifier (UID) for the customer and return that UID; and forward the customer information to the customer information server 442. (Note that this UID is only for easy customer lookup. It is not used in the BOB decryption or unlock process.)

If the customer chooses not to register on-line, a parallel method for hardcopy registration can be offered. This will consist of generation of the same materials in print format, and location to fax or mail the printed registration information.

The customer information server 442 will create a new customer record and the client 12 will receive the UID and store it redundantly.

Two categories of digital content will be offered via the DCVM 10: “Softgoods” and “Hardgoods.” Softgoods encompasses any intellectual property (IP) that can be made available to the end customer either through pre-positioned content (IP that is already at the client 12, including the assets 22 of the local inventory 18), or through electronic download (e.g., from the master inventory 104 or collateral). All softgoods will have been wrapped (e.g., encrypted) or trial injected and will need to be unwrapped (decrypted) as part of the fulfillment process. Unwrapping softgoods can be made to always require an electronic or digital key 58. That key is delivered to the customer transparently, via download to the client 12, or non-transparently via email, fax, or postal mail, or by voice. FIG. 2b provides a general overview of this.

Hardgoods encompasses all goods that require the IP, or the hardware itself to be physically provided to the customer. This definition includes software, when it is requested as an SKU from the original manufacturer. No provision (such as a custom CD) need typically be made for hardgoods delivery of digital content that exists only in softgoods electronic form.

The typical purchase and fulfillment sequence are as follows. The customer browses using the viewer application 460. The user selects assets 22 from the inventory 18 by adding them to a shopping cart, and proceeds to a checkout, or selects a “Buy Now” choice affiliated with an asset 22.

If the user is not already online the DCVM 10 initiates a connection, if possible. If the user elects to not go online, then the fulfillment initiation is via voice (human operator). The user is presented with a form asking for additional payment information, regarding how they want to pay: with a credit card number or with digital coupons.

Once the client system is online, a connection is made to the transaction server 426 and payment information is uploaded. The payment information consists of a selection of credit card and associated information, or digital credits and associated information. The asset information includes a unique asset code identifier, and the customer's understanding of the purchase price.

Upon receipt of asset information forms, the transaction server 426 imitates the order process. For softgoods, the order process is a sequence of credit authorization, optional fraud evaluation, an order record open, a key request from the core key services server, key response to the client 12, and credit commit or conveyance. For hardgoods, the order process is a sequence of an inventory check, credit authorization, optional fraud evaluation, an order placement, and an order record update to the client 12.

Following order creation, a price comparison and version comparison will be done. (The mechanics and sequence can vary, but note that while prices and version information is “pushed” to the local client 12 at every opportunity, at the time of purchase the client 12 could have stale data.) The customer is given the option to select version alternatives, and to approve or disapprove the order at this point based on the new price and availability information.

If the customer is attempting to purchase by digital credits, the transaction server 426 can also use the central customer and order database 444 to confirm or verify the digital credit balance. If the customer re-approves the transaction or is using a credit card, the central customer and order database 444 is queried by the transaction server 426 for approval. The transaction server 426, interacting with the customer and order database 444, can arrive at a decision to either (a) reject this purchase; (b) use additional credit screening to determine if this is acceptable, or (c) accept this purchase and forward handling onto the clearing house 50 for determination of taxes, etc. The transaction server 426 may use a number of factors, including time-of-day, or its own fraud check guidelines, or other factors such as response times from the clearing house 50.

Note that rejections of credit, can result in a polite response to the user along the lines of “We are Unable to Process your Credit Transaction at this time. Please call our Customer Support number at #800-xxx.xxxx.”. Legitimate purchases can be continued with the help of a customer support operator, either by overriding the fraud check, or by letting the human operator enter approval directly.

Requests to the clearing house 50 may include any of the following: (a) fraud check or screening results, (b) whether to ship or deactivate to a specified address, (c) a balance check, (d) tax collection information; and (e) preliminary approval and value amount reservation.

Finally, if all checks out, a response page is sent to the client 12 with the fully updated information. The customer is offered final approval. If the customer now disapproves, the order is closed.

If the customer approves, and the purchase was for hardgoods, the clearing house 50 is sent a request to complete the preliminary transaction, and to send an EDI message to the hardgoods fulfiller.

A brief discussion of technology incorporated into this version is now provided. However, it should be appreciated that this is essentially conventional technology which the inventors have used as component parts in just some potential embodiments of the DCVM 10, and its inclusion here should not be interpreted in any manner to limit the true scope of the present invention.

BackWeb™ is a client/server system with associated tools and add-ons designed to create a framework for managing client updates, from a set of backend websites and databases. It is designed well for scalability, and extensibility, and it supports extensibility at both the client and server ends. It supports custom application development with an ActiveX™ SDK. In addition, its client InfoCenter can be customized and extended.

BackWeb supports four kinds of channels: File Distribution Channels, for distribution of files and sets of files; BackWeb Channels, for customized server hooks into other publishing or storage mechanisms such as databases; Web Channels, based on channel agents that profile and obtain specific internet/web sources; and CDF Channels, channels defined using Microsoft's Channel Definition Format language.

The ZipLock ESD™ system is composed of several main components, one for each location involved in ESD:

| User | Location | Component |
|---|---|---|
| Customer | Customer | Vbox Client |
| Merchant (or | Merchant's | ZIPLOCK Builder |
| Publisher) | Office | |
| Distributor or | Web Storefront | ZIPLOCK ESD Gateway |
| merchant | or ESD | (formerly ZIPLOCK |
| | electronic | Merchant), ZIPLOCK |
| | warehouse | Merchandiser |
| Clearing house or | Secure Server | ZIPLOCK Server |
| Distributor | | |

ZipLock components may be distributed remotely and owned or controlled by different parties, while still easily sharing transaction communications. Examples are server-to-server, ZipLock ESD gateway-to-server and Vbox client-to-server.

The nature of the support can be described according to the following categories: channel authorization/configuration; how a channel sale works; and record keeping, reporting, billing and auditing.

A publisher uses the ZipLock server's administration interface to grant resale authorization for its offers to the distributor. The publisher also uses the administration interface to grant a server authorization to the distributor's ZipLock server.

A distributor creates resale offers on its ZipLock server for the offers it wants to resell from the publisher's ZipLock server. Resale offers on the distributor's server are created on ESD inventory that was registered when built on the publisher's server.

The distributor uses the ZipLock server's administration interface to grant a storefront authorization to the reseller, also in the form of a digitally-signed electronic certificate. The server generates an account file containing a public key, which the distributor gives to the reseller.

The distributor grants permission to the reseller to sell offers derived from the publisher's offers. Now the reseller has permission to sell the products generally (e.g., digital content), and specific permission to do so through each appropriate storefront. The reseller also has the initial public encryption key that is used to secure the communication between ZipLock gateway at the reseller and ZipLock server at the distributor. A reseller using the DCVM 10 thus sets up a storefront to sell the resell offers.

The ZipLock server works with other applications in the ZIPLOCK system, including the Vbox client, the ZipLock builder, the ZipLock merchandiser and the ZipLock gateway. The ZipLock server database works with MS SQL Server™ and other enterprise-class databases supported by Roguewave's dbtools.h++ interface package. The ZipLock server is distributed with pre-configured dynamic HTML reports for use by licensees of Crystal Reports.

The ZipLock server is set up to do payment processing, if desired. Merchants in the ZipLock ESD system can accept all major credit cards with payment through a Cybercash™ payment processor. Each payment processor may provide services aside from payment processing, such as fraud control, tax calculation, and export control. Payment may be made thru Paypal™ and other current payment methods.

ZipLock databases can be loaded with data from other existing databases. The server provides an API (MAC/PID) for use after the ZipLock database is loaded. This API generates MAC files, PID files, and keys used for communication and unlocking products.

The ZipLock server log files keep track of system activity for use as a trouble-shooting aid. These log files can be found in the logs directory under the ZipLock installation directory.

The ZipLock server uses a consistent format of digital certificate across all digitally signed files. This format is called the ZERT (ZipLock certificate) format. Digitally signed license files in the ZERT format are informally called, synonymously, ZERTs, ZERT license certificates, ZERT licenses, or ZERT files.

A ZERT serves as a digitally-signed proof-of-purchase. A ZipLock server operator controls the information that a ZERT contains by creating a ZERT template associated with one or more offers. The ZERT template can be changed at any time, and the changes take effect immediately.

A ZERT is created for each purchase, and is delivered to the customer either along with the asset file delivery. The ZERT is created by the ZipLock server but is delivered to the customer's desktop by the ZipLock ESD gateway.

The license certificate for an asset 22 distributed electronically via ZipLock (the ZERT) is generated by the ZipLock server closest to Vbox client during a transaction, on behalf of the publisher, and is digitally signed with the reseller's private key stored on that server.

The server operator uses the ZipLock server administration interface to add the “serial number” tag to a ZERT Template. The ZL_SERIAL_NUMBER database table is pre-loaded for each offer or resale that requires it.

Any database reporting package can be used with ZipLock server to provide custom reports of status and activity. ZipLock Server comes pre-configured to use Crystal Reports. All reports are dynamic, based on current data at the time the report is generated. Crystal Reports permits easy generation of dynamic HTML, making it a good choice for integration into the ZipLock Server administration interface.

The DCVM 10 may incorporate particular behavior tracking and customer profiling capabilities. In a preferred embodiment, “clickstream” data is collected at each client 12 and uploaded on a timely basis to the core services. With reference particularly to FIGS. 12a-c and 13, a loopback server 478 and the infrastructure 16, preferably using the content manager 470, gather the data on the client 12. The content manager 470 is responsible for aggregating and collecting the data into a file, and enqueuing that file for uploading using an offline access system's upstream facility, shown as taking place via the update server 424 and content server 440 to the marketing database 446.

The update server 424 may receive clickstream data from multiple clients 12, which it saves in a suitable file format with unique names which it creates. It should be appreciated that the choice of file format, naming convention, and other details of implementation are largely matters of design choice, but the inventors have employed the following approach.

Raw binary clickstream report files are generated at the clients 12 as serialized Java objects. A separate file is generated for each registered user on a client 12, and also for a default person to include click data for unregistered or unknown users. To insure unique file names, the files are named based on a customer identification, a unique random alias, and the date and time. The files preferably include two serialized Java objects: a ClickHeader object and a ClickDataWithLocation object. The ClickHeader object includes the customer identifier, alias, date and time, SKU ID (SKU, shelf keeping unit), system ID, a start date and end date, and the number of records. The ClickDataWithLocation object includes three arrays: an array of integer location Ids, an array of short component Ids, and an array of short click counts. For each countable soft URL (described presently) that has been located by the viewer application 460 for a user, there is an entry in each array (preferably at matching n-th locations in each array). The number of records reported in the ClickHeader object thus defines the number of entries in each array. TABLE 1 shows a suitable file format according to this scheme.

The serialized Java clickstream report files are uploaded using a BackWeb upstream facility to the servers (the update server 424 and content server 440, ultimately to the marketing database 446). However, first it is desirable to translate the raw data into a more usable format. For this a ClickReportReader Java class is employed to translate the serialized data files into text files. This class is part of the content manager 470. Invoking this class with Java causes translation of all serialized files (e.g., those ending with “.dat”) in the current working directory into translated text files (e.g., ending in “.txt”).

TABLE 2 shows a sample click report file generated from test data and then translated using such a ClickReportReader Java class. The first line of the report is the header information. The system ID is not being used in this embodiment. The “DataTypesAndSizes” part of the header is followed by brackets around the entry to indicate that it may be a list of multiple entries (such information may not be needed, since each type of report may be identified by the “Begin” line next described). Following the header, each type of record in the file is preceded with a line that has the word “Begin” followed by the class name of the record type.

And following the “Begin” line are the actual click report records, one per line.

The ClickDataWithLocation is the only type of report represented in TABLE 2 (but others can be easily provided). In the report there is one line for each unique (soft) URL that has been loaded and presumably viewed. Multiple unique URLs may be associated with a single location code, and thus there can be multiple entries with the same “location.”

Using Java classes for the serialized data objects permits the use of access methods to extract data directly from the serialized clickstream files using a Java program or store procedure within a Java enabled database environment. For this the classes and methods in TABLE 3 may be used.

In this version of the inventive DCVM 10 different types of click thru are provided for. A type one click thru is used to cause a navigation bar (NAVBAR) promotional to display a default browser window containing an affiliate website. The extensions server 430 then determines which particular affiliate website will be displayed by using a redirections page. The currently preferred soft URL format for this type of click thru is “NVBR_Menu_S#_A#_P# URL#” (e.g., NVBR_Menu_S1_A2_P3_URL.sub.--4). A corresponding hard URL in the user file may then have the format “redirect://<hardURL>?<SKU>&<-;AD>.” The SKU entry contains the string “SKU ID=” followed by one or more digits. Similarly, the AD entry contains the string “AD ID=” followed by one or more digits. For example:

redirect://redirect.digitalsquare.com/adredirect.cfm?SKU_ID=1 &AD_ID-=2.

The action taken at the client 12 here is that the alias and customer ID are appended to the hard URL and transmitted to the HTTP request with DISPLAYBOX as the target. The URL request received by the extensions server 430 may have the format:

<hardURL>?<SKU>&<AD>&<Alias>&<CustID>-.

The HTML page received from the extensions server 430 will then cause a new default browser to be created with whatever URL it specifies. The SKU and AD entries contain the strings described above. The Alias entry contains the string “Alias=” followed by one or more digits or the string “unassigned” if there is no valid value. The CustID entry contains the string “CustID=” followed by one or more digits or the string “unregistered” if there is no valid value. For example:

redirect://redirect.digitalsquare.com/adredirect.cfm? . . . SKU_ID=1&AD_ID=2&Alias=3&CustID=4.

A type two click thru is used to cause a NAVBAR promotional to display a product (asset) page. The currently preferred soft URL format for this is:

“NVBR_Ad_S#_A#_P#_URL_#” (e.g., NVBR_Ad_S4_A3_P2_URL.sub.--1)-.

And a corresponding hard URL in the user file may then have the format:

“viewer:///s#/a#pframe.html?p#/” For example: viewer:///s4/a3/pframe.html?p2/.

The action taken by the client 12 here does not result in a HTTP request to an external web server. Rather, a specific product page stored on the hard drive is loaded into the DISPLAYBOX.

A type three click thru is used to cause a NAVBAR promotional, SPONSORBAR or ADBAR, to display a default browser window containing a non-affiliated website. The currently preferred soft URL formats for this may include:

NVBR_Ad_S#_A#_P#_URL_#,

SPBR_Ad_S#_A#_P#_URL_#, or

ADBR_Ad_S#_A#_P#_URL_#.

A corresponding hard URL in the user file here may then have the format “launch://<hardURL>.” For example:

“launch://h_t_t_p://w_w_w.company.com/product.htnl.”

The action taken at the client 12 here is that an instance of the default browser is started and passed the hard URL.

A type four click thru is used to cause an ADBAR or NAVBAR promotional to do nothing when clicked. The currently preferred soft URL formats for this may include:

NVBR_Ad_S#_A#_P#_URL_#,

SPBR_Ad_S#_A#_P#_URL_#

ADBR_Ad_S#_A#_P#_URL_#, and

NVBR_Menu_S#_A#_P#_URL#.

A corresponding hard URL in the user file here may then have the format “viewer://no_action.” The action taken at the client 12 here is that the click thru does not result in a HTTP request to an external web server.

A type five click thru is used to cause an ADBAR or NAVBAR promotional to launch a web site based on an advertisement associated with a product (asset) page. This is a POS: point of sale advertisement. The currently preferred soft URL formats for this may include:

NVBR.sub.--_Ad.sub.--_S#.sub.--_A#.sub.--_P#.sub.--_URL.sub.--_#, and

ADBR.sub.--_Ad.sub.--_S#.sub.--_A#.sub.--_P#.sub.--_URL.sub.--_#.

A corresponding hard URL in the user file here may have the format “launch://<hardURL>.” The action taken at the client 12 here is starting up an instance of the default browser and passing it the hard URL.

A type six click thru is used to cause an ADBAR or NAVBAR promotional to launch a web site based on an advertisement associated with a miscellaneous page (e.g., sitemap.html or transact.html). The currently preferred soft URL formats for this may include:

NVBR_Ad-<Page Name No Extension>, and

ADBR_Ad-<Page Name No Extension>.

For instance, NVBR_Ad_TRANSACT. Note, unlike village, store, and aisle page ads, miscellaneous page ads preferably have only one click thru location. The corresponding hard URL in the user file has the format “launch://<hardURL>,” and the action taken at the client 12 is to start up an instance of the default browser and passing it the hard URL, so the URL request received by the non-affiliated web server looks like “<hardURI>.”

We turn now to a functional description and general design description of content management for the client 12 in the DCVM 10. As has been described, a pre-installed “store” may be provided on the clients 12. One approach, actually, is to provide a virtual mall or village 46 which contains multiple stores 44 (FIGS. 2a-b). The stores 44 can vend soft goods (e.g., computer software, image and text based products, music and other audio based products, and movies and other video based products). The stores 44 can also vend units of service, such as units of customer support, remote database access, e-mail service, remote web page “farming,” etc. The village 46 (at a high level) and stores 44 (at more specific, directed and tailored levels) can also provide non-overtly commercial BOBs (bags of bits). A few examples of these include advertising, coupon services, public service and other bulletin posting boards, and news group type discussion forums. Collectively, all of this and much more may be regarded and treated as digital content. To varying degrees of desirability or necessity in various embodiments of the inventive DCVM 10, such “content” has to be maintained, modified, updated, replenished, supplemented, etc. Thus, content management is an important aspect of the DCVM 10.

As a general functional base, the “store” (stores 44 and village 46 in many contemplated embodiments) resides on the customer's client 12 computer system or digital appliance. The digital content is initially present to, some degree, on the client 12. This is done either by prior installation on the system (e.g., on a hard drive when the system comes from an OEM)) or on a component added to it (e.g., on a hard drive added as an upgrade), or by installation from a removable media 24 (FIGS. 1a-b), or even by an online based installation. The digital content is stored on the client 12 in the inventory 18. This, preferably, is done using sets of files placed in a specific directory structure on the client 12. Typically, different clients 12 will be configured to subscribe to different subsets of available content, and this configuration needs to be controlled.

As a prelude to further discussion of content management, the following explanation of terminology is provided. The phrase “content manager” is a general reference to all of the client side applications and software objects which are dedicated to content management functions. In the figures (e.g., FIG. 13) a content manager 470 is depicted. BackWeb is a third party software product which includes both server and client functionality for updating files on a client, via the Internet as an unobtrusive background task. A BackWeb agent is the client resident part of the BackWeb software. It monitors a client network connection and manages collection of files from a BackWeb server. The BackWeb agent also provides an ActiveX interface to communicate with other content management elements on the client. An “infopack” is a BackWeb unit of updateable information. It can include multiple components, e.g., files. A “package” is a generic term for a unit of updateable information for which an atomic transfer can be guaranteed, i.e., an all or nothing download. A package may include both a digital content file and configuration information directing where that file is referenced. A “slot” is a uniquely named digital content file placed in persistent storage on the client 12, e.g., a JPEG image file. A “stream” is a selectable flow of update content, i.e., a separately subscribable flow of upgrade packages. For example, a client 12 may be configured to subscribe to an update stream of ads for a particular game type store 44. An “engine” is the general host environment on the client 12. In the figures (e.g., FIG. 13) an engine 462 is depicted. It includes a client transaction agent 468, the content manager 470, a proxy HTTP server 472, and a decryption manager 474. The inventors have implemented the internal components of the engine 462 in Java. These may be as a set of distinct set of classes run by a Java runtime engine (JRE) or they may be compiled into one or more executables and supporting DLLs. Finally, a “viewer” is an HTML based application which provides browser like functionality for viewing the village 46 and stores 44. In the figures (e.g., FIG. 13) a viewer application 460 is depicted.

In this version, the following architectural assumptions have been used. A file directory structure is used on the client 12 to locally store and retrieve the local digital content. Push technology by BackWeb is used to provide updated digital content. Targeting of specific digital content for specific clients 12 is done using sub-channel subscription selection. The content manager 470 resides on the client 12 as part of the engine 462, where it is implemented as multiple objects accessed as needed by the engine 462. A file manager on the client 12 tracks content references and handles “garbage collection” of old files. And a file server layer in the content manager 470 translates HTML URLs into the actual digital content files.

The content manager 470 maintains user profile information as persistent data. In simpler embodiments there may be only one configuration per client 12, and in more full featured embodiments there may be multiple user configurations. The user configuration data can be combined with configuration data for the village 46 and stores 44, to control the presentation and updating of these as well. One feature typically included in the configuration data is login security for the modifying the configurations of the stores and other functions. The content manager 470 can provide a user profile dialog GUI which permits users to set their personal profiles. Such a personal profile typically will include: user name and login, interest areas, and a privacy policy (e.g., tell all, say nothing, or degrees in between).

The content manager 470 also maintains the store 44 and village 46 configuration as persistent. The content manager 470 can interact with a file manager to decrement references and delete files when a store or part of a store is removed. If an item of digital content is removed the content manager 470 can provide a link to a file identifying non-local availability for display in the store (e.g., in the views of FIGS. 7-10e). To configure this the content manager 470 can provide a store configuration dialog GUI for users to set profiles. Some typical store categories that can be included or removed are: business, games, home, hobbies, gerbils, etc. Content categories can also be included or deleted for each store, with only BOBs deleted or entire stores deleted. The frequency of store and content updates can also be specified, say, as never, as needed, or at a specified frequency.

The configuration for updates themselves is another feature the content manager 470 can permit and control. An update configuration dialog GUI can be provided to let the user set their system update parameters. One typical parameter here is the update style, including the choice of automatic background updates, automatic updates with user approval (message box OK), scheduled updates (automatic but at specific times), and manual updates initiated by the user. Another parameter is the dynamic nature of updates, including whether to enable or disable such and whether user approval is required or not. The connection style may also be configurable here, allowing auto dial connection or updating only if already online.

The content manager 470 particularly controls the updating of the digital content itself. This includes the assets 22 which are sold and the collateral which may, or may not, be associated with the assets 22. This permits updating the essence of what is displayed as the HTML based “village” and “stores.” The content manager 470 uses the user, store, and update configuration data to request specific streams of update data from a remote server (e.g., the update server 424 and the content server 440). Separate streams may exist for each combination of store, content category, and OEM installation configuration. Separately streamed content categories may include ads, product BOBs, store infrastructure (e.g., updates to the infrastructure 16 on the client 12), and pricing. Thus, for example, with five stores 44 and four content categories there will be twenty streams for each OEM configuration. If Alpa Computers and Beta Computers are two OEMs each providing systems with the DCVM 10 installed, there may be up to twenty streams each, or potentially forty in total. Of course, however, the same streams can be used for multiple OEM configurations.

Each update stream can be made up of multiple update packages. The update packages are uniquely identifiable. The client 12 keeps a record of update packages received, and the server (e.g., the update server 424) does not generally send packages which the client 12 has already received. Each update package can include any number of files of digital content and configuration information related to it.

The package configuration information includes a list of URL, filename, and type triplets. The URL is a file reference as used in the infrastructure HTML files for the store 44. The filename is a globally unique name used for an asset 22 or other digital content file. And the type parameter specifies information such as the click stream tracking required.

The content files in an update package include the files named in a filename in the configuration list, but when update packages are sent only files that do not exist on the client 12 are actually sent. The configuration information in an update package is used to update a data structure used for HTML file retrieval. The configuration data structure links URLs used by the viewer application 460 to actual file names. A separate file manager tracks file references and provides garbage collection of old files. And a separate server layer uses this data structure to retrieve files for the viewer application 460.

The content manager 470 thus provides a highly dynamic data update capability. It interfaces to a local HTTP server interface to receive requests for non-local digital content, when that content is requested for display by the stores 44 but available on the client 12. The retrieval of requested files that are not local to the client 12 is handled through BackWeb services or through a connection to a separate non-local HTTP server.

This discussion now turns to content management implementation. In this version the following general assumptions are employed. A file directory structure is used on the client 12 to store and retrieve the digital content. A flat “mangled” structure is used to store files with unique names. A configuration table links URLs used by the viewer application 460 to the actual files names in the file directory structure. The file structure mimics the structure on the server. The content manager 470 accesses a BackWeb agent through a COM API. The GUI of the content manager 470 is accessed through an applet in an HTML feature in the stores 44. The content manager 470 exists as multiple objects accessed as needed by the engine 462. The user profile resides in a persistent file in a file directory on the client 12. A BackWeb agent 464 maintains the Internet connection (in embodiments permitting this, i.e., most, and where possible). The engine 462 and the BackWeb agent 464 are both started at system startup, i.e., when the DCVM 10 starts and the infrastructure 16 starts.

The architecture used for content management in the DCVM 10 may be the following. Content update in the client 12 is controlled by multiple interacting software objects which are components of the engine 462. Configuration dialogs are launched as applets from the viewer application 460. Separate dialogs exist for store configuration and for user profile and update configuration. These dialogs maintain the configuration data in files or in an operating system registry, for access by other software objects. An initializer creates static objects, starts threads, registers dependencies, etc., when the engine 462 is started. A BackWeb content bridge provides a COM ActiveX interface layer to the BackWeb agent 464. A channel manager provides an interface between the BackWeb and profile data. The channel manager is responsible for providing the correct sub-channel or stream subscription information to the BackWeb agent 464. A dynamic content driver handles requests from the HTTP server layer for digital content files which are not present locally. The dynamic content driver initiates requests for the needed information to the agent 464 or to a remote HTTP server. A local HTTP server layer takes URL requests from the viewer application 460 and returns digital content files used in the stores 44. A local file manager manages additions and deletions of the digital content files. It tracks file references and deletes files only if they are no longer referenced by any URL in any store 44 (or by the village 46 itself). The BackWeb agent 464 is a third party software product used in the DCVM 10 which provides functionality for the background updating of material on a client 12 over the Internet. An update manager insures that information in update packages received by the agent 464 is correctly placed in the proper locations and that any file location links or other configuration information is updated as needed.

A channel is a connection to a specific BackWeb server. The DCVM 10 may employ a single or multiple channels, with each channel potentially divided into many streams. Streams are specific categories of information which can be separately subscribed to by individual clients 12. The streams may also be termed “sub-channels.” Each client 12 can subscribe to many streams. The details of the potential separate streams have already been described above. Stream selection is managed by the channel manager.

The user, store, and update profile and configuration data is stored in files or in the operating system registry on the client 12. This information can be edited with dialogs that are accessible from the viewer application 460, via applets installed in its top page.

The digital content is placed in a flat directory. Each file has a globally unique name that can be used to identify its content. The viewer application 460 accesses these files with URLs sent to an HTTP server layer. The server layer uses a configuration table to translate these URLs into the actual file names, and to return the correct file to the user. This abstraction mechanism allows new files to be easily referenced as store content is updated, without changing the various embedded URL links. This also allows a single file to be referenced by multiple URLs, and it facilitates easy file name information retrieval from the configuration table to report when users have viewed particular digital content (i.e., for the click steam reporting).

As noted previously, the information packages received include a list of URL, filename, and type triplets. An update manager can use this to insure that once any complete information package is received the configuration data is provided to the file manager and placed in the configuration table.

The information packages received from the BackWeb server also include content files which the BackWeb agent 464 places in the content directory on the client 12. The BackWeb components can also insure that only new files are sent, and it can provide incremental updates of existing files. The file manager tracks file references and provides garbage collection of old files.

Large portions of the design for the sub-systems used by the content manager 470 have been implicitly covered already, but the following comments elaborate. Dialogs for the village and store configuration (i.e., system profiles), user profiles, and update configuration can be implemented as applets accessed from the viewer application 460. An initializer creates static objects, starts threads, registers dependencies, etc. A BackWeb content bridge provides a COM wrapper and interface layer to the BackWeb agent 464.

The channel manager provides an interface between the BackWeb content bridge and the profile data. A channel subscription configuration runs on initialization and when the profile or configuration settings change.

The dynamic content driver provides for retrieval of needed content which is not present locally. It initiates requests for needed items to the agent 464 (alternately, conventional components and HTTP can be used for this, but using the BackWeb approach works). The dynamic content driver also permits a user option to cancel updates if they are greater than a certain size.

The major objects within the content manager components interface may include a local HTTP server layer, a local file manager, a BackWeb agent, an update manager, and a remote content server. The local HTTP server layer takes URL requests from the viewer application 460 and returns store content files. The local file manager manages additions and deletions to the store content files. It tracks file references and generally deletes files only if they are no longer referenced by any URL in the village 46 or a store 44. The update manager insures that all information in the update packages is handled correctly.

The BackWeb agent 464 is a third party provided object which always runs on the client 12 in the embodiment being described here. The channel manager configures the BackWeb agent 464 using the user profiles, store configuration, and update configuration information. The profile details are used to generate a sub-channel subscription list for the BackWeb server. A one-to-one correspondence between streams and pre-defined sub-channels can thus be provided. Based on subscription received from the BackWeb agent 464 on a client 12 the BackWeb server provides “infopacks” to the client 12 with files and information which allows the BackWeb agent 464 to place these files in the desired directory locations. The BackWeb agent 464 thus manages the requesting and receiving of updates, places updates into the proper directories, guarantees the atomicity of the infopacks received, provides incremental updates of files that are already present (but not sending files that exist unchanged), sends requests for specific information to the BackWeb server, and handles dial up connection if not online and requested by a user.

The remote content server is (in this embodiment) a BackWeb proxy server, in turn connected to a BackWeb channel server, which is accessed by the BackWeb agent 464 of the client 12 for the updates.

As has been described, the inventive DCVM 10 provides both an online and an offline viewing, browsing, and purchasing environment. The client 12 of the DCVM 10 also provides a unique and particularly powerful mechanism for advertisement distribution and display. In some regards this mechanism can conform with industry standards, such as they presently exist or are evolving, and in other regards this mechanism provides new opportunities.

The following terms and concepts are used in the following discussion. Ad objects can be grouped into those relating to placement in a GUI. Thus, with regard to placement, a content unit is a collection of one or more positions (a display region), usually associated by some logical category. Consistent with emerging industry practice, there are three types of content units: a statistically defined form called “standard” and two dynamically defined forms called “site data” and “keyword.” A location is each “rotation time slot” in a position, that is a temporal subset of a position. Each location can be filled with a single creative (the graphical element of an ad, and optionally a click thru link). A niche is a collection of one or more content units, usually associated by some logical category. A position is a display region within a viewable window. An ad position may have one or more locations. Internally, in the client 12 a position is identified with a soft URL, e.g., in the form ADBR_S#_A#_P# (other examples of such forms are covered elsewhere herein). Positions have display attributes associated with the locations, such as random or sequential. A time is associated with either a location or a position.

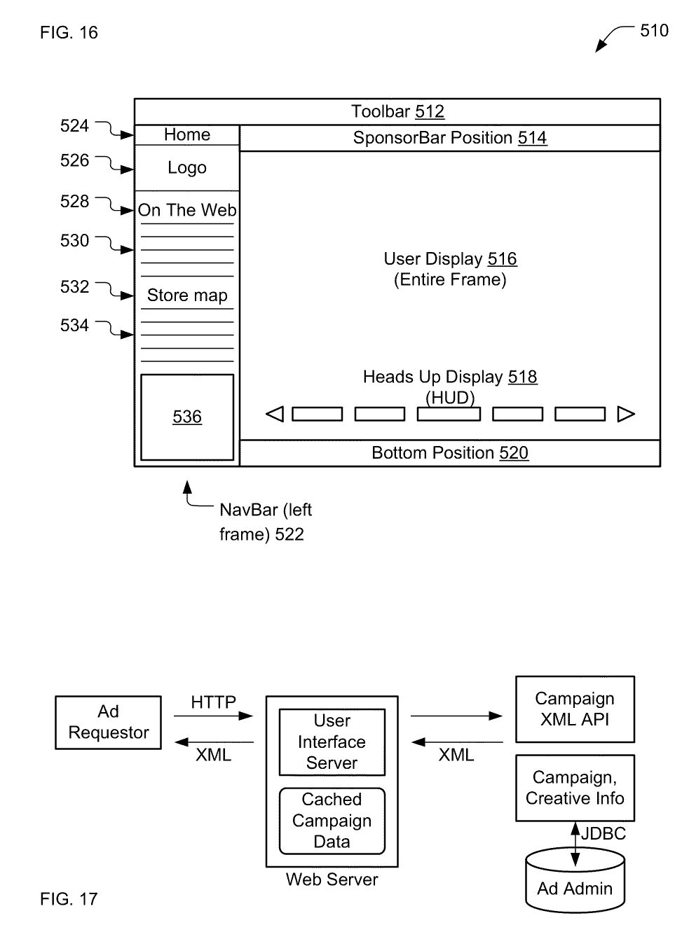

FIG. 16 is a schematic diagram depicting one screen layout (somewhat different than those depicted in the embodiment of the DCVM 10 represented in FIGS. 6-10e) which the client 12 may provide. Proceeding roughly from the top down, the screen 510 includes a toolbar 512, a sponsor bar position 514, a user display area 516, a heads up display 518 (integrated into the lower part of the user display area 516), a bottom position 520, and to the left a navigation bar 522.

The navigation bar 522 is a feature particularly germane to the present discussion. It includes a home button 524, a branding area 526, an on the web button 528, affiliates buttons 530, a store map button 532, in-store buttons 534, and a promo position 536.

Continuing with terms and concepts, and particularly now with regard to content, ads include a creative and, optionally, a click thru link. An ad package is a set of ads belonging to the same content unit, along with a store component file directing remapping and file instances. A creative is a graphical element of an ad (optionally with a click thru link). Under the prevailing usage in the industry, creatives can be “simple” or “rich media.” Simple creatives are single graphic files (e.g., type GIF). Rich media creatives can be complex scripts, written in Java, Java script, HTML, DHTML, in addition to graphic files and redirects. A click thru link is a hypertext reference link (HREF) that names a target page to be navigated to on an ad click. A campaign set is an ad package annotated with deployment attributes.

Now with regard to actions, campaigns are actions that associate advertisers, billing attributes (e.g., rates, contacts, etc.), ads, content units, and deployment attributes. Typically campaigns are booked by a single advertiser group. With digital content distribution, the primary concern is with the association of ads, content units, and deployment attributes. A deployment attribute is a set of rules for ad display and tracking. These may be one or more of: display start date, display end date, subscription period, maximum impression count, circulation delay, duration, etc.

And now with regard to tracking and reporting, impressions occur each time the loopback server 478 (FIG. 12c) of the client 12 delivers a web page element; these are counted. Click stream reports are a message container used between the client 12 and the servers for demographic and impression or viewing count information. Aggregated click stream reports contain summations of click stream report impression count values. A large and configurable set of reports is possible, so that advertisers and publishers can track and account for ad placement in a variety of ways. Aggregated reports are primarily a concern of the backend servers and process in the DCVM 10.

A package thus is a unit of content distribution update. One term particularly avoided here is “banner.” Used in the context of placement, this is synonymous with position. Used in the context of content, this is synonymous with a creative.

The client 12 supports an association of one creative per location, but this association may be re-associated with updates as part of ongoing content management. In simpler embodiments, the client 12 can dispense with support for higher level objects, such as content units and niches. Simple creatives and standard content units can be all that are provided. The store 44, aisle 164, and shelf and product level positions may also support only a few, minimal, locations per position. The click stream reports can contain OEM/SKU, revision build number, customer identifier, and impression counts associated with each store component flagged for active impression counting. All of this permits the use of simple embodiments, and particularly facilitates development of more complex embodiments.

More typical embodiments can contain campaign assignments and deployment attributes which are statically assigned and mapped via static assignments in the master content database (e.g., the master inventory 104 of FIG. 3, if this is used to save ads as general digital content). This is done before creation of a gold master copy of the client side portions (e.g., the infrastructure 16 and inventory 18 in FIGS. 1a-b) of the DCVM 10 is made, or before update package creation. Support for a circulation model can also be incorporated. For instance, the gold master copy may specify a fixed period of availability. A subscription model and an impression model may support only updates. A global circulation time period may be set for all SKUs in the gold master, say, 30 days, but this may be configurable at the time of gold master creation.

The following is a high level review of end-to-end activities involved in booking, retrieving, placing, grouping, gold master deployment, updating, displaying, data aggregation, reporting, and auditing of advertisements in the DCVM 10.

Several types and variations on campaigns may be supported, including common and standard types intended to map directly into standard Internet campaign types as well as a set of new methods that particularly take advantage of the capabilities of the client 12. Click per mil (1,000) campaigns provide a means to count impressions (views) per ad or banner. This type of campaign is typically booked for a maximum global number of impressions. Counts per click campaigns may employ click thru references within HTML displays. Click thru references provided by the client 12 are counted, since these campaigns are typically booked for a maximum number of impressions or clicks. Subscription campaigns may be booked for a period of time, set to start at a particular date, run for a fixed set of days, or run until a stop date. Circulation campaigns are booked for a set number of skipping systems, i.e., for those systems in “circulation.” These typically run for a fixed number of days after the client 12 is first started, regardless of the start date. Circulation, click per mil, and counts per click campaigns can be part of an OEM gold master. Subscription, click per mil, and counts per click campaigns can be targeted to existing clients 12 in the field.

Campaigns can be booked ether directly or via an advertising management service, such as Adforce™ which is a service available for centralizing, serving, targeting, and reporting electronic ad inventory via the world wide web. Typically advertisers, or their associated agencies, create and target campaigns to one or more websites. In the parlance of Adforce, a provider of website space for ads is known as a publisher, and each advertiser controls a network of websites.

The DCVM 10 is usable as a publisher, wherein space is contained in one or more websites on such a network. Logical groups of ad space are called content units, and can have attributes of display, or associated keywords with assumed semantic value. Service booking and direct booking can be mixed, and the inventors have used the DCVM 10 where roughly 80% of such content units are service booked and the remainder used for direct bookings.

Direct campaigns can be placed directly in the network of the DCVM 10. One particular use here is for promotionals closely related to the DCVM 10, e.g., sweepstakes campaigns in the stores 44.

A range of types, styles, and information can be contained within a traditional campaign. Not all of these, however, work well in the DCVM 10, and not all that the DCVM 10 can facilitate fit into the traditional mold. When advertisers book campaigns through services, some sets of types may need to be excluded. Conversely, the DCVM 10 introduces capabilities which are outside the range of “normal” which most advertising account representatives are familiar with. In the following the DCVM 10 is described as it particularly may integrate with campaign models of an advertising management service, but this should not be regarded as implying that the DCVM 10 is limited to just such campaigns and their features.

The advertising management service has been extended to provide a data broker mode of ad service, as the first step in extending to encompass distributed and third party servers. (This service is informally termed the “ad push process,” as it pushes ads to an intermediate third party.) The data broker ad service is implemented as an XML service. under this schema or protocol, third party intermediate ad servers (using the DCVM 10 can request and obtain campaign data that has been targeted to any particular service network or network and website. (In order to ensure security, name and password authentication is still performed, but it is done programmatically as part of the XML exchange.) FIG. 17 is a block diagram showing where the DCVM 10 can fit into an advertising management service's database and data broker scheme.

Campaign data is typically received multiple times a day, using an automatic get process run on the servers in the DCVM 10. The retrieved campaign data (including image based creatives) are resolved at this point, and the images, along with their associated flight data, are stored in an intermediate cache before being moved to the master content database using an ad manager. This opportunity may also be used to review, accept, and, if necessary, deny any campaigns that for any reason are not found desirable in the DCVM 10.

As has been discussed extensively elsewhere herein, the client 12 can be modeled as a website complete with a sitemap. The clients 12 may be modeled as a town or village square, with a set of one or more stores 44 for shopping. Custom clients 12 may be created for various users of the DCVM 10 (here distinct from the end-customers of digital content). In particular, such customers may be original equipment manufacturers (OEMs), ranging from major personal computer manufacturers to small custom system assemblers or upgrade shops. The inventors term each custom configuration a “SKU” (somewhat extending the existing industry term “shelf keeping unit”). The distributed clients 12 of the DCVM 10 may include a village 46 which contains the same set of content units, or they may define different content units for different SKUs or release levels. The content units (again) are logical associations of ad creative graphic display layout locations, and flight data is collectively the functional aspects of campaigns associated with content units.

In the DCVM 10 ad placement can be done automatically, by mapping service broker or other website content units to the content units of the DCVM 10. Once such a mapping is established, for example, campaigns booked to the websites can be “pulled” (via the data broker process) into the DCVM 10, cached to the master content database, and automatically assigned to specific SKU content units. To provide additional control, the ad manager (an interactive Internet service within the DCVM 10) provides a means for internal content managers to place ads directly (for direct campaigns) or to adjust, modify, or monitor the “automatic” campaigns.

For each OEM employing it the DCVM 10 can provide a gold master (i.e., an initialization suite) that includes the client 12, an inventory 18 (a set of wrapped and encrypted assets 22), a set of collateral for the assets 22, and an initial set of ads. This initial ad set is available for display when the end-users first run their systems with the client 12 of the DCVM 10. Stated another way, the gold masters are deployed with all the content units assigned and filled with one or more ads. Any content unit that has duration minimums should have an associated ad content unit descriptor.

The DCVM 10 integrates a content distribution technology to update clients 12 in the field. This technology and how it is built in embodiments described herein using BackWeb technology, implements additional concepts of content distribution management to control packaging and replacement of existing components. While by design nearly all of the components in the client 12 are updateable, the content distribution system is used primarily for the update of the inventory 18 of digital content assets 22, ads, and collateral for both.

The ads and associated logical collateral (such as click thru URLs, etc.), are typically grouped by campaign and content unit into a single update package. These packages are updated to the clients 12 on end-user systems using the offline access technology. Part of the offline access technology includes a “polite” protocol (using UDP rather than TCP/IP), which can actively update end users' systems anytime they are online, rather than only when they are in the village 46 or stores 44.

Distribution to the OEMs may be relatively straight forward, with grouping and updating via update CDs or batch download sets.

The ads, whether from the gold master base set or from updates, are effectively cached on the client 12 and displayed from the cache rather than any direct lookup or access to an ad server. The click thru ads, however, are associated with a URL. These may be of several types, including links to a location or page within the village 46 or a store 44, or links to an external website page, or those that link indirectly through a booking service or other third party redirect server.

Clicking on an external click thru ad causes the viewer application 460 to launch the user's native browser, with the named target URL. The user's default connection configuration (dialup, autodial, target ISP, etc.) takes over.

Note that click thru actions handled as redirects to booking service servers are typically counted by those servers, and the count information supplied by the DCVM 10 may be merely supplemental or used for audit purposes.

As a synopsis of ad integration, the client 12 of the DCVM 10 is capable of keeping request counts for any infrastructure 16, inventory 18, or collateral component, such as a page or graphic or redirect or URL request. Typically the request counts are kept for ad creatives and links, as well as digital content assets 22 and collateral. The request counts are ultimately aggregated into click stream reports.

The click stream reports are gathered on a per user (“person” object) basis, and are then provided periodically to the central services of the DCVM 10 via the offline access upstream messaging technology. At the backend, individual click stream reports are digitally signed, parsed, and archived for use by an audit control. Parsed click stream reports are aggregated by component counts. There is a reconciliation between the component identifier and the original ad or campaign. Totals are comparable to reject and accepted values, so that cross-correlation may be done for auditing purposes.

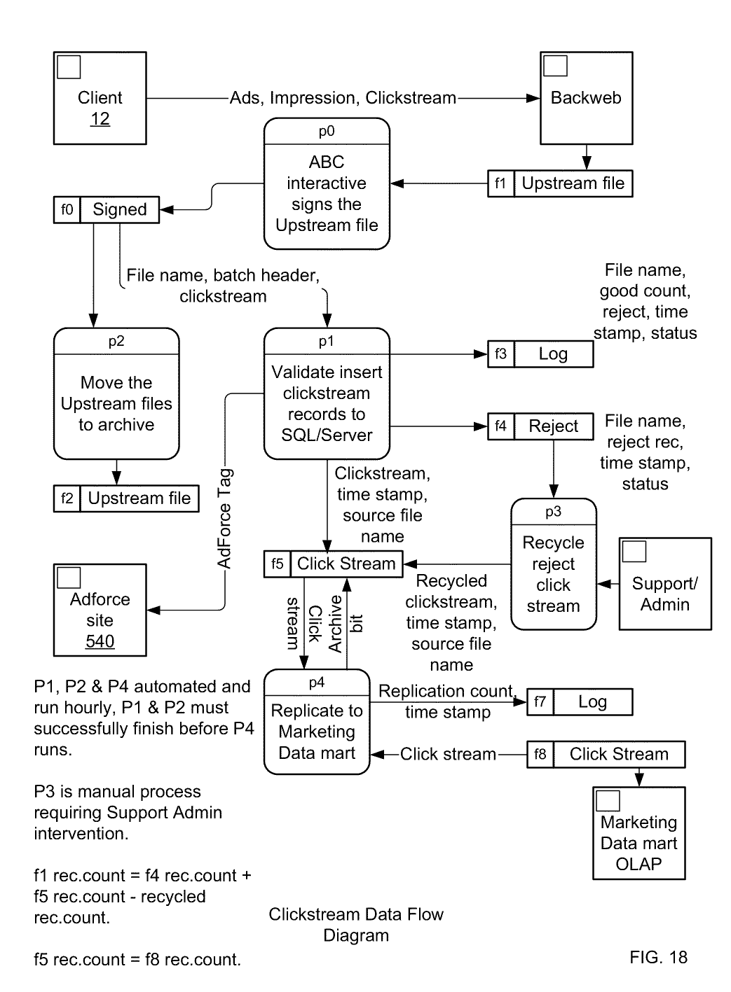

FIG. 18 is block diagram showing one possible click stream data flow approach which the DCVM 10 may use. The DCVM 10 provides for both direct reports as well as working together with a booking service such as those used by advertising management services.

Information about the client 12 and end-user impression activity may be reported back to advertisers by the advertising management service. Impressions (used by click per mil campaigns) are reported through the use of a playback mechanism 540. As each click stream report is parsed and validated it is used to “playback” the same tagged HTML requests, normally executed by the end-users' browsers. This actually results in a click by click playback to the service's ad server, But a count is also keep by the DCVM 10 for validation and direct reports. Click thru references (used by counts per click campaigns) booked through the service, using a redirection server, are reported at the time they are executed at the client 12. Thus, all campaigns booked through the service can have report data available within that system (i.e., separate or in addition to that of the DCVM 10 itself). There is, however, a class of click thru ads, such as those that redirect back to the client or those that direct to non-advertising management service servers, that are aggregated only at the reporting system of the DCVM 10, and thus are available only through direct reports.

As depicted in the flow diagram in FIG. 18, click stream and user impression data may be under audit control, with each client 12 report uniquely digitally signed, archived for a period of time, and parsed and redundantly validate able by an outside audit control group.

In another aspect of this invention, it may be implemented to function as a local portal. At least part of the infrastructure 16 of the client 12 on a PC 14 may be made a persistent object, that is one which is always operating when the PC 14 is in its normal operating mode. The infrastructure 16 may then provide a visible presence on the display screen of the PC 14, a “persistent desktop object.” Persistent desktop objects (PDOs) are not new, but providing them in the manner which the present invention can is.

Since the DCVM 10 can come pre-installed in a new PC 14, or on a hard drive 20 which is later installed, the PDO may be functioning the very moment the system enters its normal operating mode. A user thus may perceive a visible and audible presence provided by the infrastructure 16 as soon as the PC 14 completes its power-up boot sequence. This is an excellent mechanism to introduce and educate inexperienced users on a new PC 14, or to welcome them as customers 40 to the stores 44 and the services of the village 46.

To some limited extent, initial user introductions are provided by many operating systems today. The “Tour” in Microsoft's Windows 95/98/ME/2000/VISTA™ products is a good example. Some operating systems today can also support PDOs. An example of this is can be found in the Active Desktop™ feature in the noted Microsoft operating systems. However, this previously existing art can be distinguished in a number of regards.

Previously existing initial user introduction systems have not been persistent. Instead they merely run briefly as a final step in the power-up boot sequence. They also are not interactive, at least not to any appreciable degree beyond the very limited context of describing the features of the operating system itself. This is quite different than the stores 44 and village 46 of the DCVM 10 are. In particular, this does not vend, especially not in the very broad sense which the DCVM 10 can. Previously existing systems do not provide digital content in the commercial sense of offering and exchanging value for value or simply in the sense of providing access to a range of digital content from multiple sources.

Previously existing PDOs also have not been truly pre-installed. Instead they require complex setup, either as an operation following operating system installation or at some later time. Notably, few if any PCs are provided to end users with PDOs operable. Microsoft's Active Desktop™ provides a good example. Its basic functionality may be turned on during operating system installation, but specific PDOs then have to be chosen and enabled in a set-up operation that is daunting to even many experienced computer users. This is not “manufacturing” level pre-installation; it is post installation “configuration,” and it necessarily must be done by the end user or a party acting under their instruction for the end user to receive an acceptable result.

Content presented by such PDOs also has to be loaded. It is not initially present and, while an initial presentation (typically a welcome in the form of a web page) may be loadable from removable media, any digital content actually usable by the user must be retrieved over a communication link from a remote computer system. Furthermore, it should be noted that the initial web page presentations here are not PDOs at this stage. The user must select and enable specific PDOs related (or not) to the initial web page presentations. The end result of all of this may be very powerful, but often too powerful. It is unduly daunting to computer users, and it is just not pre-installed.

Turning back now to PDOs in the context of the present invention, a PDO may provide particular benefits if the PC 14 has access to a private network 120 or the Internet 122. If such access is always on, the PDO may receive and present material in a streaming manner. Alternately, when such access is not presently on, the PDO may use material stored locally, say, as part of the inventory 18, either as initial assets 22 or as assets received and stored at a time when previously on-line. In sum, this is a variation of the invention wherein a PDO handles a presentation to a user of the PC 14, and the inventors have termed it a “local portal.”

As for how such a local portal would appear, the possible variations are about as limitless as the range of what can be presented on the desktop of any visible display device. FIG. 6 provides a basis for discussion of one example. The village view 210 there includes the video display 214 and, if the PC 14 has a speaker, audio may accompany whatever appears in the video display 214 (audio is presumed in the rest of this discussion). The video display 214 can thus be the presence provided by the infrastructure 16. It can always be present on the desktop in the display screen of the PC 14, even when the rest of the village view 210 is gone. The video display 214 may be persistent as part of the desktop, either enlarged as the video display 214 is shown in FIG. 6 or minimized to an unobtrusive icon, even though the underlying persistent object is still at work.

In yet another aspect of the present invention, embodiments of it may be implemented to function as a micro-target for broadband content. The gist of this is that any PC 14 can be unique enough to be a target for digital content, and that content may be broadband content or it may be handled in a manner such that it is perceived to be.

As has been covered in discussing other aspects of the invention, above, the DCVM 10 provides utility as soon as a PC 14 employing it first becomes operable. The client 12, has its inventory 18 of some local digital content, and the infrastructure 16, handles local digital content and can access additional digital content on remote computer systems, e.g., the master server 48 (FIG. 3). In particular, the client 12 can “display” humanly perceivable instances of the digital content visually or audibly on the PC 14.

The client 12 may also obtain and transmit a user profile to a remote computer system. It may easily be embodied to include a mechanism to monitor the user, with respect to the PC 14 as a whole, or with respect to the DCVM 10 and the inventory 18, or even to query the user for data to include in a profile. These approaches permit deriving very accurate user profiles. Another approach is simply obtaining a profile generated on the PC 14 by other means, say, from another application or from the client OS 76 (FIG. 3).

Furthermore, the invention may uniquely identify each specific PC 14 with a hardware identifier, and even specific users of respective systems with a user identifier. A hardware identifier may be based on a simple serialization of each client 12, or may be generated with an algorithm upon first use of the DCVM 10, or may requested from a remote system like the master server 48. User identifiers necessarily require a way to ascertain uniqueness of individual users, but this is easily accomplished by requesting a password from the user or determining from a client OS 76 whom a user is (typically by its previously having required a user password). In any case, identifying the target is not a difficult task and the salient point here is that the invention can easily deliver content with a granularity as fine as individual systems or individual users, i.e., a micro-targeting capability.

Still further, the invention may handle digital content which it receives form a remote computer system an a “broadband” manner. Receipt and delivery to the user of remote digital content can be essentially contemporaneous if a communications link is employed which has broad bandwidth, such as ISDN, DSL, or cable modem connections to the Internet 122, or a high speed Ethernet connection to a private network 120. As has been described elsewhere herein, streaming delivery of some digital content is also achievable. Alternately, if a communications link is employed which has narrow bandwidth, say a conventional telephone line modem, the invention still contiguous display remote digital content to the user. It can buffer remote digital content into a block for contiguous display as soon as all is received, or it can store what is received, into the inventory 18 if desired, and display can then smoothly be provided at any later time. In this manner the invention can deliver digital content which is “rich media,” as that term is used in the industry today, but without the limitations which often seriously limit prior art “rich media” delivery systems.

Therefore, invention can micro-target delivery of digital content and it can deliver broadband content, and it can combine these capabilities to be a micro-target for broadband content.

As was the case in describing the problems which the present invention can address in the Background Art section, the above discussion has primarily used PCs as an example. But the invention can solve problems beyond the context of just PCs. A PC is just one type of personal computerized device or system and a hard drive is just one type of primary storage unit. Those skilled in the relevant arts will readily recognize that the present invention can be used to initially provide and maintain, offer and vend, deliver or enable, configure and service digital content in a wide range of primary storage units and personal computerized systems (and potentially in small and enterprise networks as well). The examples noted, without limitation, in the Background Art section bear some reconsideration in view of this. Gaming stations, like Sony's Playstation™ and Microsoft's X-Box™ have a hard drive which can be pre-loaded with digitally wrapped game software, clue books, advertising, etc. The user can then view or use this, or may obtain a digital key to unwrap and promptly be able to use such. The same process works well for personal communication service (PCS) devices, television “set-top” boxes like WebTV™, Internet enabled cellular telephones; and personal digital assistants (PDAs), albeit to provide more than just game related digital content. And the same process works with “personal devices” that handle text, audio, image data and its capture, storage, playback, communication, etc.

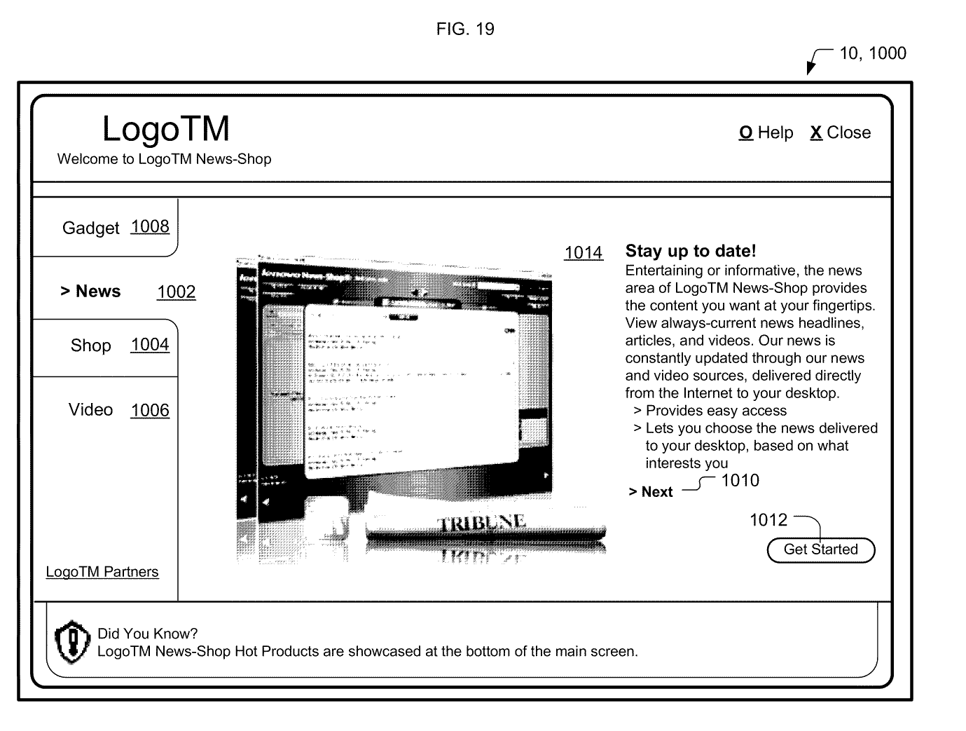

Turning now to an exemplary embodiment that follows the inventors' more recent pillar cover metaphor, the following describes such an embodiment of the DCVM 10 that may serve as a local portal 1000. FIG. 19 is a block diagram showing a user's first initial view of a local portal 1000 in accord with this. In general, this view is straightforward and is what a user sees the first time they see the local portal 1000. The local portal 1000 displays a news tab 1002, a shop tab 1004, a video tab 1006, and a gadget tab 1008. FIG. 19 shows the news tab 1002 in detail, which appears first and then may be navigated away from. In particular, the news tab 1002 includes a next button 1010, a get started button 1012, and introductory information 1014. In keeping with the role of this embodiment of the DCVM 10, behavior tracking and user profiling can begin here.

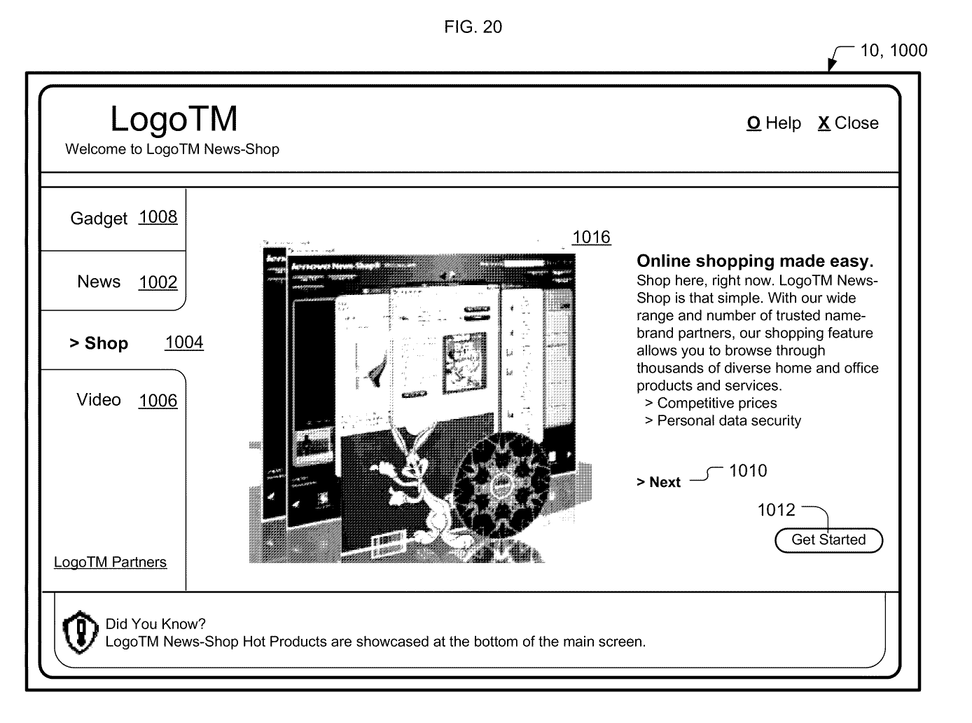

FIG. 20 is a block diagram showing a view associated with the shop tab 1004 in detail, after the user affirmatively selects it or operates the next button 1010 while in the view associated with the news tab 1002. As can be seen, a different set of introductory information 1016 is now provided, along with the next button 1010 and the get started button 1012.

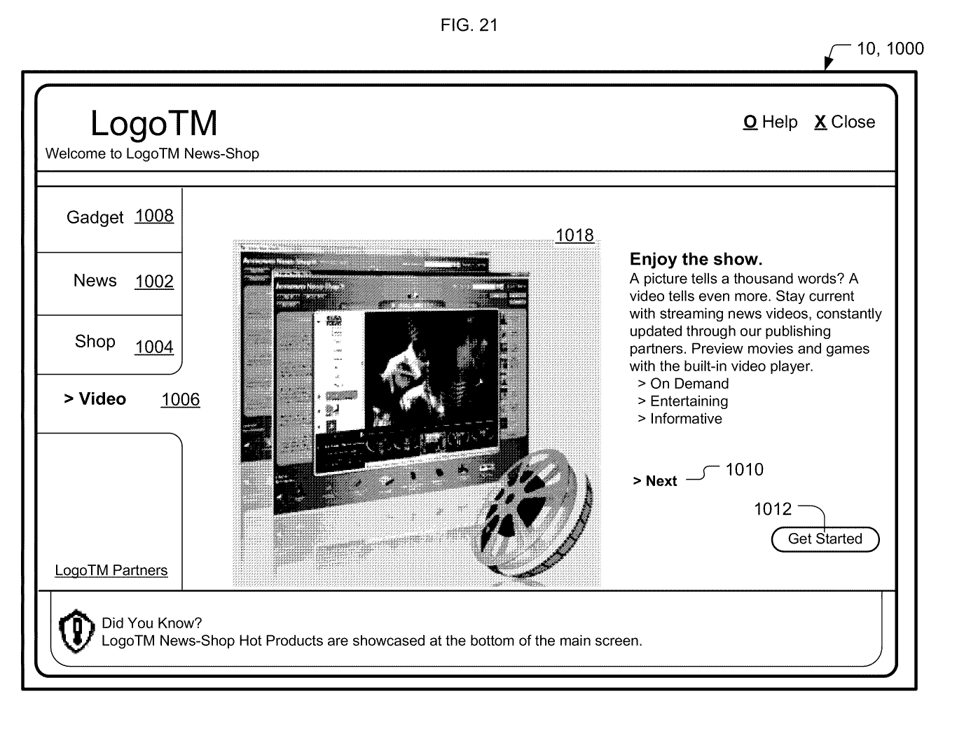

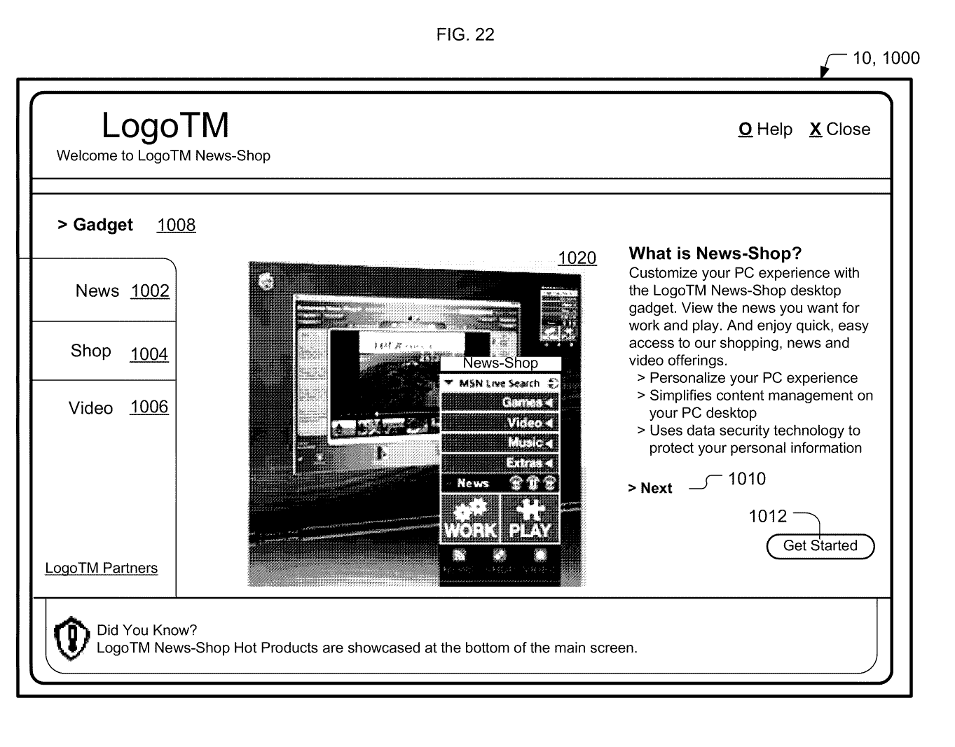

FIG. 21 is a block diagram showing a view associated with the video tab 1006 in detail, after the user affirmatively selects it or operates the next button 1010 while in the view associated with the shop tab 1004. As can be seen now, a different set of introductory information 1018 is now provided, again along with the next button 1010 and the get started button 1012.

FIG. 22 is a block diagram showing a view associated with the gadget tab 1008, after the user affirmatively selects it or operates the next button 1010 while in the view associated with the video tab 1006. A different set of introductory information 1020 is now provided, with the next button 1010 and the get started button 1012.

Summarizing, the local portal 1000 starts in the view associated with the news tab 1002, with “news” being one of the three pillars of this embodiment of the invention. As a matter of design, the user interface of the local portal 1000 here revolves around a number of pillars and this aspect is discussed as its features are introduced in the following. Collectively, FIGS. 19-21 take a new user through a quick and simple introduction. And FIG. 22 introduces the new user to a powerful, but optional, tool that can be used with the local portal 1000. To go any further with this embodiment of the local portal 1000, however, the user must operate the get started button 1012.

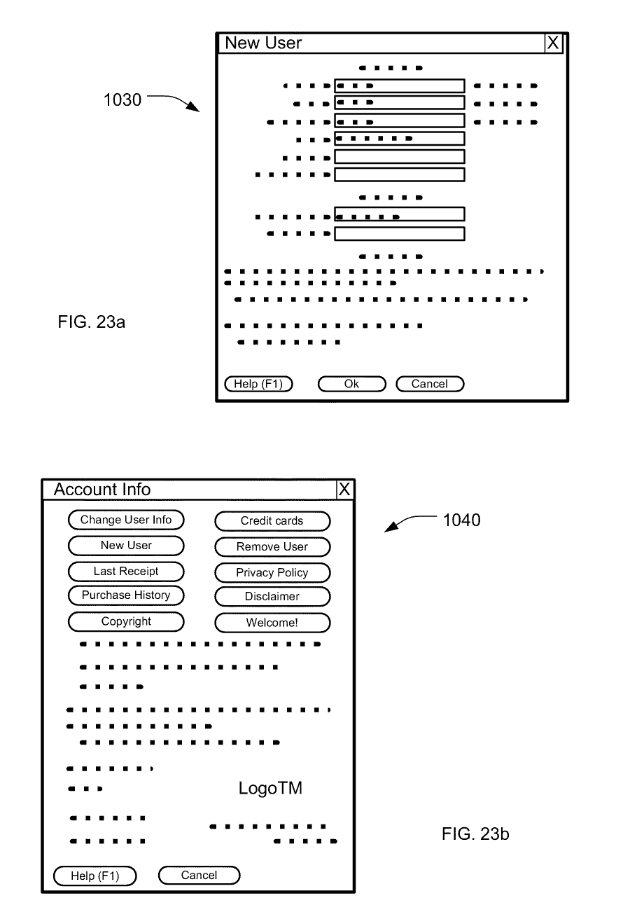

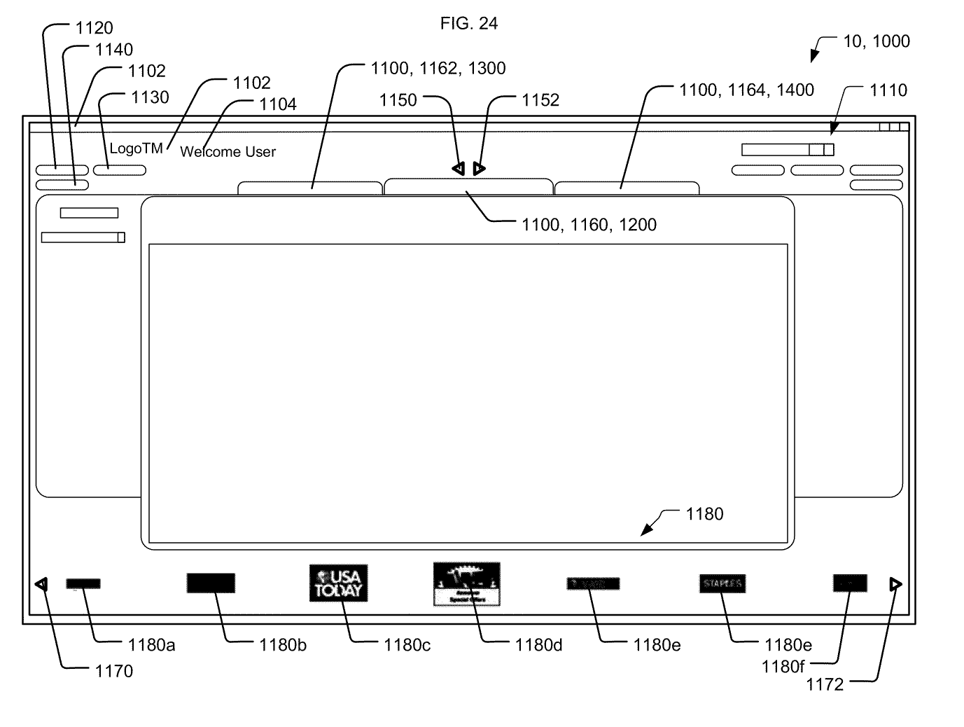

FIGS. 23a-b are block diagrams showing two special dialogs in the local portal 1000, specifically FIG. 23a shows a set-up dialog 1030 and FIG. 23b shows an account info dialog 1040. The set-up dialog 1030 is reached by operating the get started button 1012 in any of FIGS. 19-22. The account info dialog 1040 is reached by operating an account info button 1130 (FIG. 24). In keeping with the ability of modern computers to have multiple user accounts, with one or more for each user, the local portal 1000 similarly permits multiple user accounts, and at least one should be set up before the local portal 1000 is used. The set-up dialog 1030 and the account info dialog 1040 can require more, less, or different information as a matter of design choice, but the present inventors have found that the versions shown here work well. In keeping with the role of this embodiment of the DCVM 10, a large part of the initial user profiling can begin here in these dialogs.

FIG. 24 is a block diagram showing an initial view of a pillar 1100 of the local portal 1000 that is arrived at once the user appropriately exits the set-up dialog 1030 in FIG. 23a. Note, as a matter of design choice when no user preference has been established the local portal 1000 initially starts with a “news” view. Users are typically more receptive to news and will review what is prevented under that label, unlike shopping, which may seem too commercially forward at first impression, and unlike video, which may seem too technically intimidating at first.

Continuing, FIG. 24 includes a number features that are common to many of the views of the local portal 1000. For example, this can include branding information 1102, and FIG. 24 includes two examples (FIGS. 19-22 also include examples). This is where a party providing the local portal 1000 can establish brand recognition with the users. In the usual manner of trade and service marks, this brand reminder serves to reinforce in the mind of the user the source of the local portal 1000 and to assure them of its quality as a source of information. In the example shown in FIG. 24, the entity “Logo™” is actually the manufacturer of the computerized system in which the local portal 1000 has been pre-installed, rather than the source of the software that runs the local portal 1000.

The local portal 1000 can also include user confirmation information 1104, and since in this particular instance the view in FIG. 24 followed after the new user dialog in FIG. 23a, the local portal 1000 has automatically signed in the user based on the new user dialog information. Note however, formally signing in is not a requirement to use many features of the local portal 1000, as discussed further presently.

FIG. 24 includes most of the commonly encountered controls of the local portal 1000. The upper right area of FIG. 24 includes a number of conventional controls 1110, with functions that are so self evident that further discussion should not be needed here. In the upper left is a sign in/out button 1120, the account info button 1130, and a welcome button 1140. The sign in/out button 1120 leads to a sign in dialog (not shown) where a user can be selected, if more than one user has an account in the local portal 1000 at hand, and where a user can sign in. Again, signing in is not a rigid requirement. It is only necessary in this embodiment to access features where access is appropriately restricted (e.g., shopping entailing an actual purchase). If a user is already signed in, the account info button 1130 will take them directly to the account info dialog 1040 (FIG. 23b). Alternately, if no user is formally signed in, the account info button 1130 takes the user to the sign in dialog and after that to the account info dialog. The welcome button 1140 takes the local portal 1000 back to the view shown in FIG. 19.

The upper middle area of FIG. 24 includes a number of controls that are particular to controlling the pillars 1100 in the main middle area of FIG. 24. The pillars 1100 here are a news pillar 1200, a shop pillar 1300, and a video pillar 1400. The currently active pillar is presented centermost and foremost. In FIG. 24 the currently active pillar 1100 is the news pillar 1200, with the shop pillar 1300 (flanking) behind and to the left and with the video pillar 1400 (flanking) behind an to the right.

This embodiment of the local portal 1000 here has three mechanisms to navigate between the pillars 1100. The first mechanism is left/right triangle buttons 1150, 1152 (centered above the news pillar 1200 in the view in FIG. 24). These nominally resemble conventional scroll buttons in many operating systems. If the news pillar 1200 currently has focus, as is the case in FIG. 24, operating the left triangle button 1150 rotates the pillars so that the shop pillar 1300 becomes centermost and foremost, the news pillar 1200 is (flanking) to the right and behind, and the video pillar 1400 is (flanking) to the left and behind. Alternately, again starting with the news pillar 1200 having focus, operating the right triangle button 1152 rotates the pillars so that the video pillar 1400 becomes centermost and foremost, the news pillar 1200 is (flanking) to the left and behind, and the shop pillar 1300 is (flanking) to the right and behind. The second pillar navigation mechanism is news/shop/video tabs 1160, 1162, 1164. By operating a tab (e.g., with a mouse double click) the corresponding pillar 1100 is given the focus. And the third mechanism is to simply double click in a pillar 1100 in an unambiguous manner. In the center pillar (the one foremost and currently having the focus) links are active and clicking on or very close to a link there may be interpreted as selecting that link. In the left and right pillars 1100 (i.e., the ones not currently having the focus) the links are not active and double clicking anywhere in either of these pillars can un-ambiguously be treated as a user request to change the focus to that pillar 1100.

The lower area of FIG. 24 also includes a number of controls that are particular to the local portal 1000. At the lower left and lower right are left/right triangle buttons 1170, 1172 that rotate-ably scroll offerings in a ribbon control 1180 that has selection buttons 1180a-g. In this embodiment of the local portal 1000 the centermost selection button 1180d is reserved for a special offering from the branding party (see e.g., the discussion of the branding information 1102, above) and the offerings associated with the other selection buttons 1180a-c and 1180e-g can be scrolled through in a ribbon-like manner. For example, in FIG. 24 the selection button 1180b is shown associated with an offering from a travel service and the selection button 1180c is shown associated with an offering from a news service. If the right triangle button 1172 is operated, the offering from the news service will be moved to the selection button 1180e and the offering from the travel service will be moved to the selection button 1180c, etc.

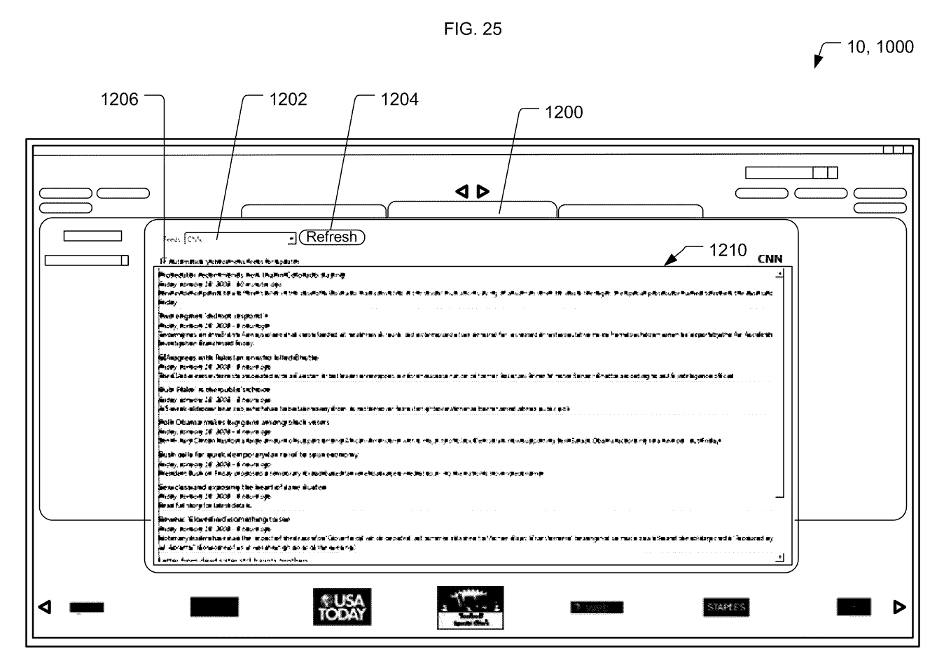

FIG. 25 is a block diagram showing an alternate view of the news pillar 1200 subsequent to the view in FIG. 24. The news pillar 1200 itself also includes some particular controls, including a feed source drop-down list 1202, a refresh button 1204, and an auto operation check-box 1206. In FIG. 25, since the auto operation check-box 1206 is checked and the feed source drop-down list 1202 includes a valid selection, the news pillar 1200 now contains a series of RSS news items 1210.

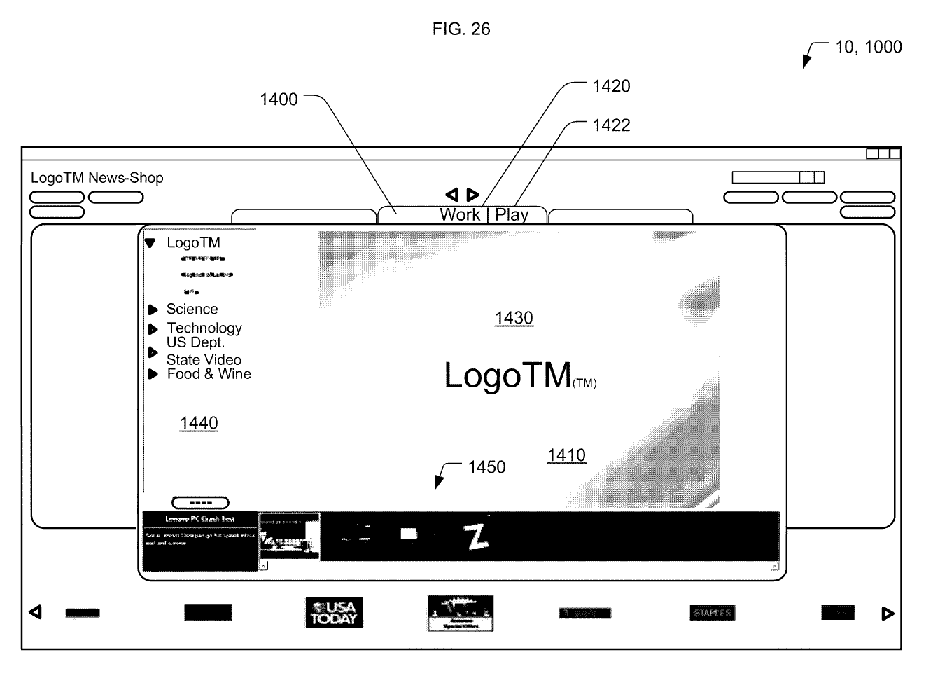

FIG. 26 is a block diagram showing the video pillar 1400 in a typical manner. The video pillar 1400 also includes some particular controls, including work/play buttons 1420, 1422. These operate as a toggle, with the currently selected mode emphasized. Video content can be categorized as work related, play related, or both (e.g., videos instructing in the use of the local portal 1000 or the computerized system running it). In generally conventional manner, content is identified as such initially by where it is stored and secondarily by metadata stored in the content.

Continuing, the central feature in the video pillar 1400 is a video window 1430 where playback of videos can be viewed. To the left of this is a selection control 1440 and across the bottom are thumbnail sub-regions 1450 that are selectable in button-like manner and scrollable if the quantity of possible selections merits this. As shown, each thumbnail sub-region 1450 contains a thumbnail image (or even a thumbnail size video) related to a particular selection. It should be noted that, although this pillar 1100 is termed the “video” pillar, there is no reason that it cannot also be used for audio only presentations. In such cases the video window 1430 can display a visually engaging animation or the entire local portal 1000 can be “minimized” so the user can view other material on the screen of the computerized system running the local portal 1000. Of course, the video and audio content that is experienced using the video pillar 1400 can all be digital content as described else where herein. Next we turn to how the inventive local portal 1000 can further be an extension of the present inventors' DCVM 10, which has already been described in detail elsewhere herein.

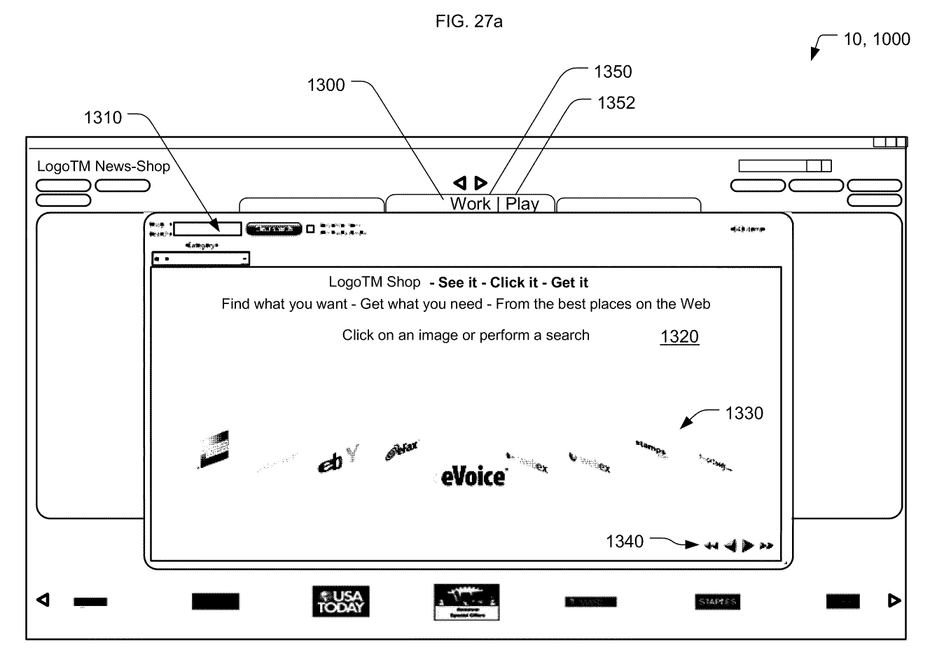

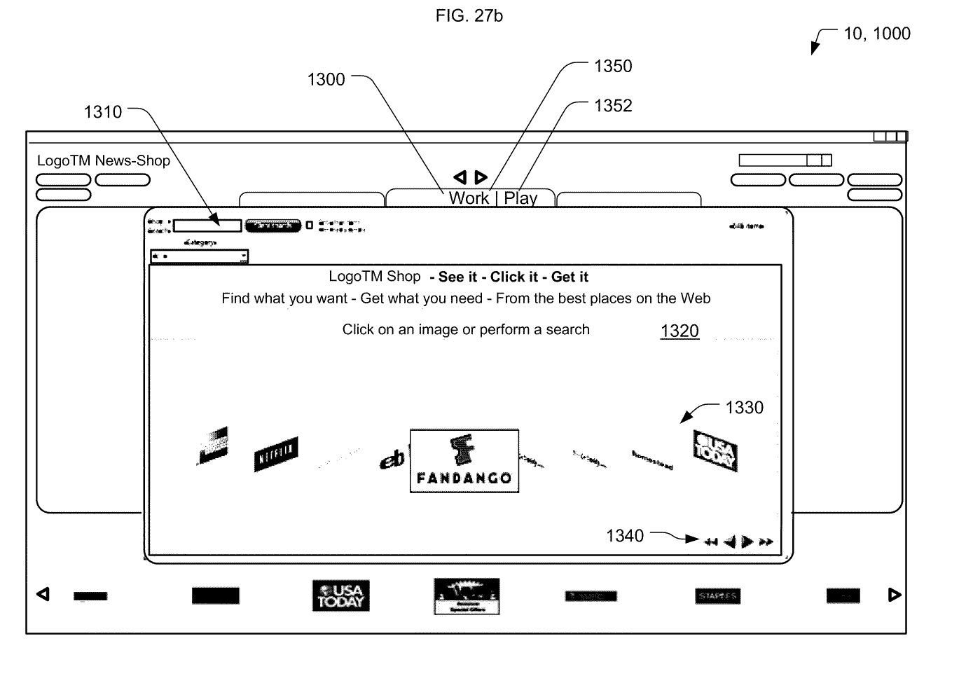

FIGS. 27a-b are block diagram showing the shop pillar 1300 in detail. As is the case for the other pillars 1100, the shop pillar 1300 also includes a number of controls that are particular to it. At the top of the shop pillar 1300 are a set of generally straightforward search controls 1310. These are especially useful in view of the quantity of assets 22 (FIG. 1a) that will typically be present in the inventory 18 of the DCVM 10 that the local portal 1000 is part of. The results of searches in the shop pillar 1300 can be limited with the search controls 1310 to prevent too many results overwhelming the user. For example, “American” can be searched for but categorized as “Financial” to avoid getting results for airline travel. Of course, all of the searching and shopping endeavors of users can be tracked as behaviors and analyzed for profiling purposes, subject to the policies for such set or agreed to by the user and subject to established industry and governmental controls.

Below the search controls 1310 in the shop pillar 1300 is an instructions region 1320, an offerings ribbon 1330, and a set of scroll controls 1340 to control what appears in the offerings ribbon 1330. In keeping with pillar-based design metaphor of the local portal 1000 here, the offerings ribbon 1330 is navigated, displays offerings, and permits selection in a manner similar to the three main pillars 1100. The current central-most offering is emphasized by being displayed foremost and larger, while other offerings are deemphasized by being displayed rear-ward displaced and smaller. The scroll controls 1340 here also work similar to the left/right triangle buttons 1150, 1152 that control selection of a pillar 1100, only the scroll controls 1340 here include go to start and go to end functionality. Note, the normal sort order of the results presented is alphabetical, so “start” and “end” have meaning, but going to the next lower offering from the end offering can still scroll around to the starting offering.

The shop pillar 1300 also has work/play buttons 1350, 1352, and these operate as was described for the work/play buttons 1420, 1422 in the video pillar 1400. FIG. 27a depicts representative offerings in the work mode and FIG. 27b depicts representative offerings in the play mode. It should be noted that some offerings appear to be the same in both modes. This may actually be the case, or it may simply be that a vendor 42 (FIG. 2a) is configured with different offerings in each mode, and that selection of the vendor 42 in a mode will result in different later dialog that is appropriate to the particular offering.

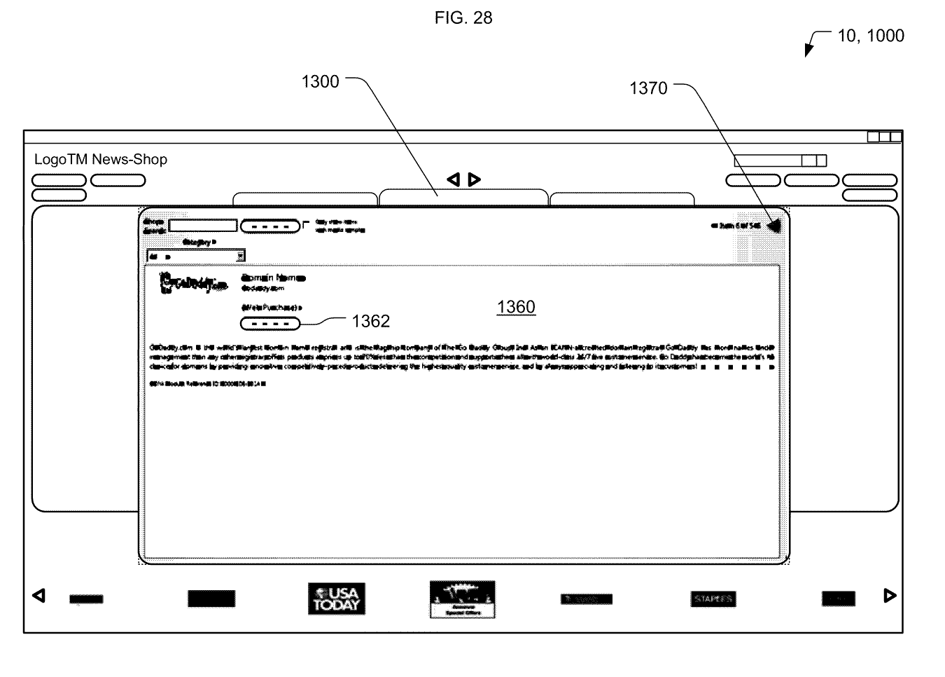

FIG. 28 is a block diagram showing the shop pillar 1300 once a user selects an offering from the offerings ribbon 1330 in FIGS. 27a-b. Selection can be accomplished by double clicking the offering anywhere in the offerings ribbon 1330 or by pressing enter when the offering is centermost in the offerings ribbon 1330. The instructions region 1320 and the offerings ribbon 1330 from FIGS. 27a-b are now replaced with an offering sub-window 1360 with its own set of particular controls, including at least one take me there button 1362. If the description of what is being offered is large the offering sub-window 1360 can include scroll buttons or another suitable description-navigation mechanism. When the offering sub-window 1360 is visible the shop pillar 1300 further includes a back button 1370 (and operating system and browser control conventions can also operate to take the user back to the offerings ribbon 1330 in the shop pillar 1300).

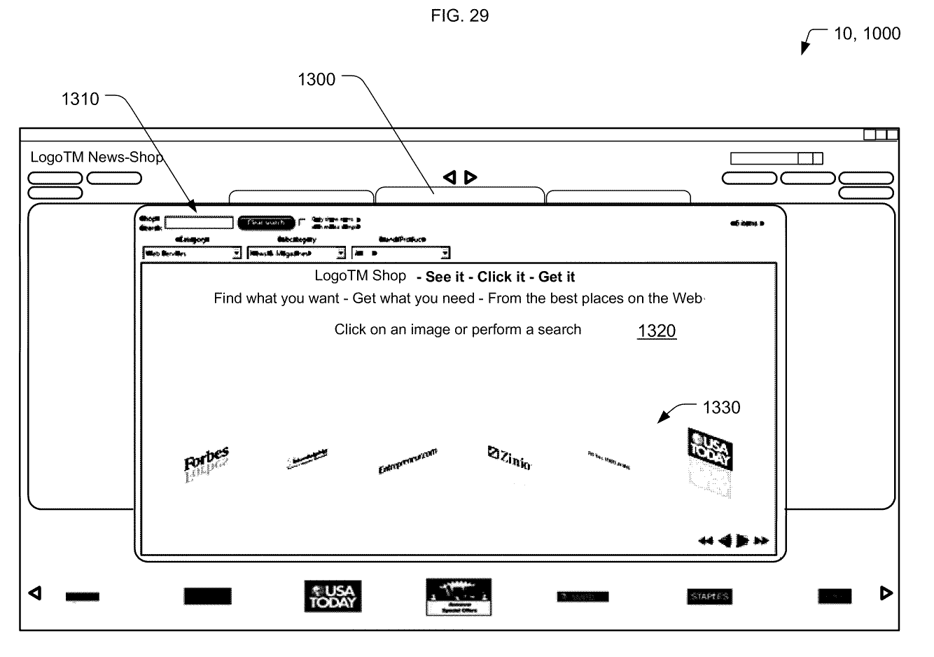

FIG. 29 is a block diagram showing the shop pillar 1300 when a large set of offerings may apply, and particularly how the search controls 1310 may dynamically increase or decrease in number and functionality to adapt to this. In particular, in this embodiment of the inventive DCVM 10 and local portal 1000, this can be based on prior behavior tracking and user profiling. It should also be noted that the offerings FIG. 29 are for digital content that is non-tangible in nature, here being for subscriptions to news feed services.

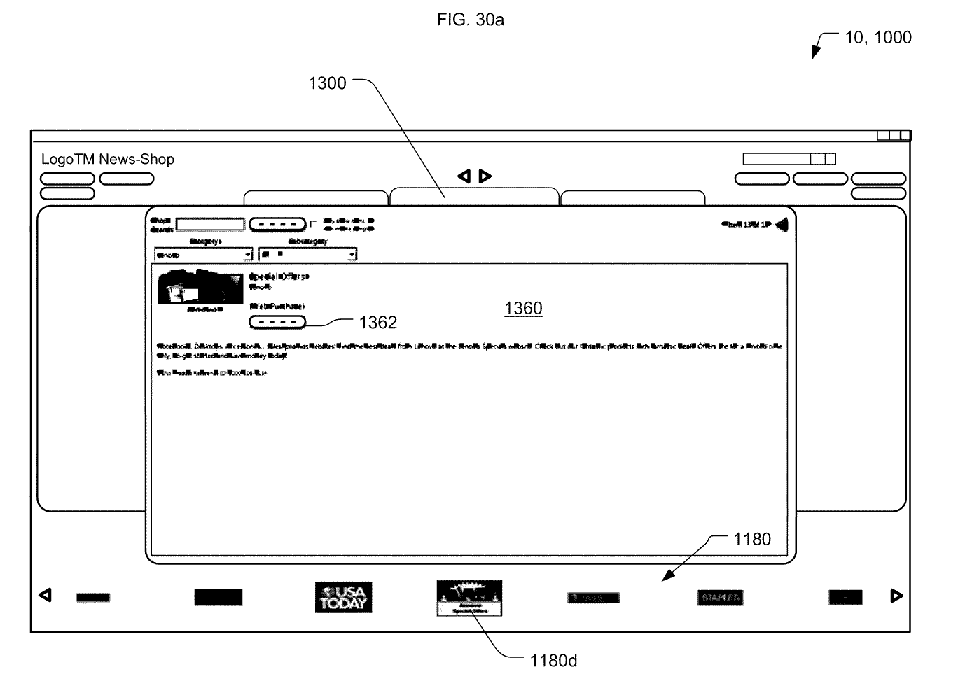

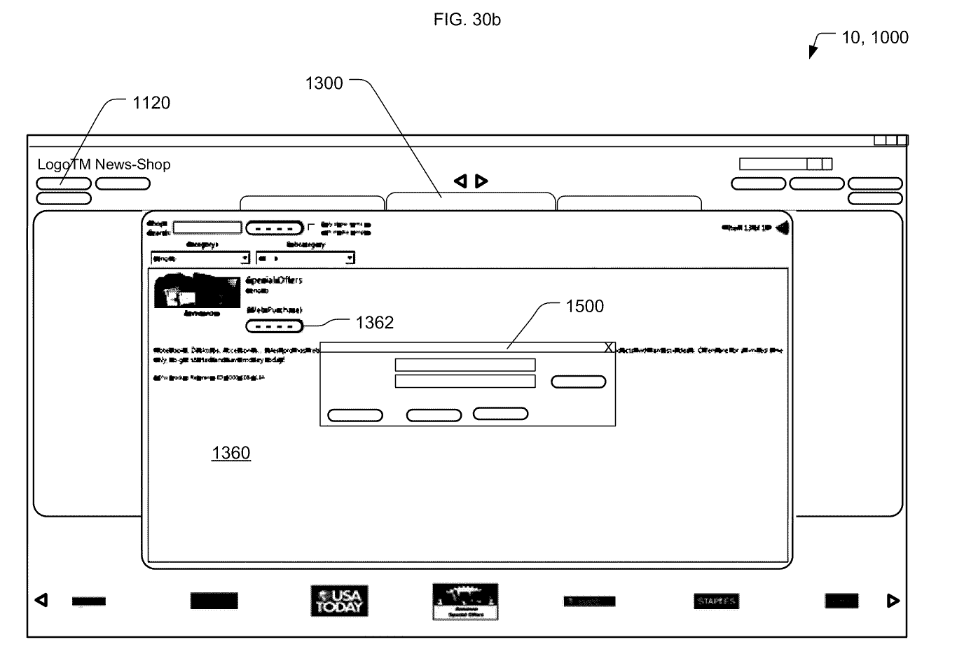

Finally, FIGS. 30a-b are block diagram showing a purchase scenario using the local portal 1000. In FIG. 30a the user has operated the selection button 1180d (the special offer button centered in the ribbon control 1180, which acts as a shortcut directly to an offering and to the shop pillar 1300 entry for it). In FIG. 30b the user has operated the take me there button 1362. However, since the user is not signed into the local portal 1000 yet in this example (note the state of the sign in/out button 1120), a sign in dialog 1500 is presented and then the user can proceed with their purchase, in accord with the manner described generally for the DCVM 10. Prior to the user signing in, their behavior can nonetheless be tracked. The information related to this can be applied to a general profile for the instance of DCVM 10. And once the user does sign in this same information can then be applied specifically to that user's profile.

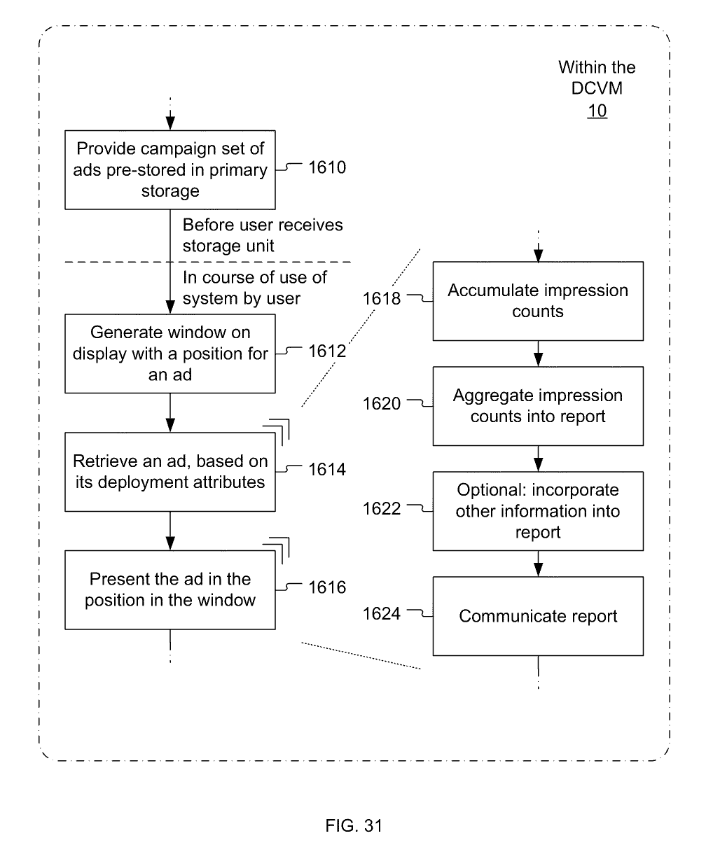

FIG. 31 is a flow chart summarizing the inventive DCVM 10 as a locally driven advertising system. The DCVM 10 generally runs as has been described throughout this discussion, and details of this are therefore not shown again here. The DCVM 10 can be considered as having three major stages, comprising what happens before it reaches an end user, what happens or can happen once it reaches the end user, and what can then happen in an ongoing manner over time as the end user uses the DCVM 10 (i.e., upgrading, restocking, etc. of the infrastructure 16 and inventory 18). The third stage of this should be straightforward, after the preceeding discussion, and therefore is not be considered further. In contrast, the earlier stages have additional considerations with respect to the DCVM 10 as a locally driven advertising system. FIG. 31 shows this generally as two stages separated by a simple dashed line, all within the greater context of the DCVM 10.

In a step 1610 ads are provided in a primary storage unit in a personal computerized system, for example, in the hard drive 20 of a PC 14 (or pre-stored in the high capacity flash memory of a cellular telephone using the Windows Mobile™ operating system). As is the case for the infrastructure 16 and the inventory 18, at least some ads are pre-stored before the computerized system is received by an end user. Additionally, these ads may particularly be in campaign sets and have deployment attributes.

As has been discussed already, ads in the DCVM 10 may be simple advertisements, such as the village ads 154, store ads 172, promotional ads 176, asset ads 194, etc. There is no reason, however, that the DCVM 10 should be limited to providing advertizing for only what is presently in its infrastructure 16, e.g., in the current stores 44, or locally stored in its the inventory 18. For that matter, there is no reason that the DCVM 10 be used to advertize only overt digital content. For instance, a vacation in Hawaii might not overtly seem to be digital content (versus vouchers, reservations, etc. related to such a vacation, which can be expressed as digital content—but again, digital content is defined very broadly herein). Nonetheless, ads for vacations are excelent candidates for the DCVM 10 in its locally driven advertising role.

The DCVM 10 can randomly display such an ad; or it can apply “traditional” criteria, e.g., displaying such an ad in mid Winter to users who live in places like North Dakota; or the DCVM 10 can employ sophistication that other advertising systems are not capable of. For example, displaying an ad here can be “leveraged” off of criteria that are particularly available to the DCVM 10. If an end user is using the DCVM 10 to shop for travel books about Hawaii, the DCVM 10 can detect this and seize the obvious opportunity to advertise travel to and lodging in Hawaii. As a more sophisticated and more subtle example, if a user has word processor and spreadsheet applications open in their computer ten hours a day, six days a week, this would seemingly be a good time to present ads for vacations or, better still, a campaign set of such ads.

Continuing with our hypothetical Hawaiian vacation example, a person currently working 60 hour weeks may not be able to drop everything now to take a vacation. They also may not notice one or two ads for Hawaii, or may even “tune out” the same ad if it is simply repeated. To address this and to generally improve end user perception, the DCVM 10 can present campaign sets of ads. For instance, the DCVM 10 can present a set of theme-related ads, like: ‘overworked people need stress relief’, ‘Hawaii is relaxing,’ ‘Hawaii can be inexpensive,’ ‘Hawaii is safe and is easy to travel to,’ etc.

Wrapping up here with respect to ads and campaign sets of ads in step 1610, in the inventive DCVM 10 these can advantageously be treated as just another part of the inventory 18, that is, as simply more digital content. Core sets of current ads for general subject matter are preferably already present in the inventory 18 when a user first receives it (e.g., in a newly purchased computerized system or in a storage unit added to an existing computerized system) and then new, specialized, and expanded sets can be added to or can replace these as part of maintenance of the inventory 18.

Continuing with FIG. 31, in a step 1612 a window having a position for an ad is displayed to the end user. This is largely straightforward and many different examples have already been presented herein. For example, in FIG. 6 the village view 210 is such a window and the ad cells 212 are such positions; in FIG. 16 the screen 510 is such a window and the sponsor bar position 514 and the promo position 536 can be such positions; and in FIGS. 27a-b the shop pillar 1300 is such a window and the offerings ribbon 1330 has multiple such positions.

Note, step 1612 can run only once with the same window reused by subsequent steps or new windows can be displayed. Ads may be presented in the same window that a user is doing other things in until the user affirmatively responds to an ad, then a new window will be displayed (generally in the same manner that the inventive DCVM 10 uses for its general vending machine role).

In a step 1614 an ad is retrieved. This can be done entirely randomly, and a certain amount of this will typically be done to provide randomized variety, but the DCVM 10 is capable of much more sophistication here as well and it is anticipated that such will often be employed. For example, ads or campaign sets can be provided with deployment attributes and the DCVM 10 can use these to select which campaign set to chose an ad from and/or to select which ad to retrieve. Thus, building on the same example, some instances of Hawaiian vacation deployment attributes might be: if user watches streaming news feeds frequently, display ‘Hawaii is safe for Americans’ ad; if User Location=North Dakota then select from Hawaiian campaign; if Hawaiian campaign has been exhausted then randomly change to either Tahitian or Caribbean campaigns; etc.

There is essentially no limit on deployment attributes other than marketing creativity. As the necessarily limited examples above illustrate, simple criteria such as the season or user location can be the basis for setting deployment attributes, or more complex criteria such as current or repeated user activities can be the basis, or yet more complex criteria such as ad presentation history and user responsiveness to ads can be the basis to select an ad.

And in a step 1616 the selected ad is presented in the window to the user.

FIG. 31 also shows some optional features of the DCVM 10 as a locally driven advertising system. Many aspects here have already been discussed and are covered by in detail by FIGS. 16-18, so only some summarizing remarks and brief examples are now added. Concurrent with steps 1614-1616, steps 1618-1624 can also be employed.

In step 1618 impression counts for ads and campaign sets can be accumulated. A straightforward example of this was presented above, recall the discussion of ‘if Hawaiian campaign has been exhausted then select <other tropic vacation>campaign.’ Obviously, telling if a campaign has been exhausted entails counting ad impressions. But this can take on additional, important, and more powerful meanings in the particular context of the DCVM 10. The conventionally used online marketing phrase “click through rate” is somewhat analogous here. As in online marketing, users of the DCVM 10 can click through on links in or that are associated with ads. This can be on links that fetch online content, and then traditional (albeit, more limited) remote click through counting mechanisms can be employed. Additionally, and as a very powerful advantage of the DCVM 10, users can click through to additional local content, including additional locally stored ads and locally stored follow up information. Since this digital content is stored locally, it presents essentially immediately, regardless of whether the user's computer is even online and regardless of the communications speed if they are. And since this digital content can be directly tied to the ad that the user clicked through on, it is relevant to the ad, current, still connected, etc.—all major issues with online advertising where a link in one page may lead to a wrong other page, to stale information, or simply be broken and no longer lead anywhere.

Impression counts can have very broad meaning and utility here as well. Without limitation to just these examples, they can represent simple counts of user viewings of an ad or of viewings of ads in a campaign set. They also can represent click through instances related to such viewings. And they can represent counts of time associated with such viewings (e.g., 1 second, 5 second, 2 second, 15 second, 10 second viewings of an individual ad or of ads in a particular campaign set implies there is an increasingly promising marketing opportunity).

In step 1620 the impression counts are aggregated into a report. Reporting every impression as it occurs may not be possible or practical, and certainly is not efficient, so the DCVM 10 can aggregate this information and report it when possible, practical, efficient, and as generally deemed desirable.

In step 1622 other information can optionally be incorporated into a report. For example, user demographic information can be added. An early report might thus, for example, include that a user has set up the clock utility in their newly purchased computer based on their being located in the same time zone as Fargo, N. Dak. Or a report might indicate that a user is employing the DCVM 10 to watch online news feeds (say, generally, without intrusively also reporting whether they prefer CNN™ over MSNBC™). Or a report might indicate that while the DCVM 10 is open in one window on a user's PC 14 they are also employing a particular brand of word processor in another window (without intrusively reporting back what is being done in the word processor yet). Then, for instance, it can be determined that ads for software macros for that specific brand of word processor might be well received by this user.

And in a step 1624 the report is communicated (again, see FIGS. 16-18 and the discussion of these with respect to where, how, etc.).

While various embodiments have been described above, it should be understood that they have been presented by way of example only, and not limitation. Thus, the breadth and scope of the invention should not be limited by any of the above described exemplary embodiments, but should be defined only in accordance with the following claims and their equivalents.

### INDUSTRIAL APPLICABILITY

The present DCVM 10 is well suited for customers 40 with personal computers (PCs 14), and personal computerized systems, to shop at the stores 44 in the village 46. The customers 40 can browse for “best of class” software, learn new computer skills, and obtain the latest news or other information on topics of interest. It is anticipated that these digital content assets 22 will initially be primarily software and computer related services, but the underlying concept here easily extends to include music and video content, as consumers of such increasingly gain computer sophistication. For example, the stores 44 may provide top software titles (say the top 200, as determined by best seller lists), with some stores 44 specializing in children's interests, others in adult's interests, others in business interests, etc. Since top-selling (i.e., high desirability) assets 22 may be made available in the stores 44 virtually immediately, they are available at precisely the times that the customers 40 are most likely to buy—right after they purchase a system, or later as impulse or need directs. There is no driving to a store 44 and the stores 44 are open twenty-four hours a day, seven days a week, 365 days a year. Shopping in the stores 44 is friendly and hassle free (e.g., there is no sales pressure); and delivery of assets 22 from the local inventory 18 is virtually instantaneous, is guaranteed, and is free. In sum, the customers 40 may receive superior service, gain confidence in, and have access to what they want (which as described below, can be pre-loaded, and even default configured, i.e., virtually assuring that it will work).

The present DCVM 10 is similarly well suited for the vendors 42. Traditional vendors can easily set up stores 44 in the village 46 and concentrate on their product or service sales missions, leaving system management to the provider of the master server 48 and leaving financial matters to the clearing house 50. Further, in the DCVM 10 the stores 44 can have potentially huge customer 40 traffic yet have very low operating cost. Thus, many additional and diverse potential vendors 42 may chose to operate stores 44 in the village 46.

The vendors 42 can also provide communications with shopkeepers, customer support, and technical support personnel in the stores 44. The DCVM 10 particularly lends itself to various marketing incentives for original equipment manufactures (OEM's) of PCs 14 and other personal computerized systems. The system builders can set up their own outlets and customer service centers (i.e., become vendors 42) in the shipped village 46 which they supply. They can also use the inherent push technology of the Internet 122 to keep these current and to promote special offers, upgrades, rebates, or software service programs. Securing a spot in the village 46 enables system builders to establish and maintain a channel of communications between themselves and their individual customers 40. Thus suppliers can easily enter the software business profitably and create an annuity stream that can continue for years. To “boot strap” the customers 40 into this new manner of commerce, one store 44 can even sell Internet subscription and setup.

The present DCVM 10 is similarly well suited for maintaining the traditional roles of the financial and governmental sectors, which are major concerns today in Internet based commerce. All transactions can be screened for fraud by the clearing houses 50, which may be operated by leading members of the financial industry. To ease commerce via licensing and to minimize disputes, or easily resolve those that do occur, the DCVM 10 may conform to the buying and license management schemes as defined by the Software Publisher's Association, thus assuring compliance with industry standards for credit card and intellectual proprietary protection. Finally, to facilitate governmental regulatory and taxation roles, the master server 48 and the clearing houses 50 are highly audit able.

The key to the inventive DCVM 10 being able to function as described above is that it is stored in the PC 14 or other personal computerized system of the customer 40, thus bringing a plethora of digital content deliverable goods and services from a wide variety of vendors 42 directly to the customer 40. Accordingly, wide and rapid acceptance of the DCVM 10 can be expected.

As can now be appreciated, the present invention particularly permits providing offline advertising in a DCVM 10. The DCVM 10 contains an infrastructure and an inventory of digital content, which includes advertisements (typically entire campaign sets of advertisements). The infrastructure and inventory may both be stored in a primary storage unit (e.g., a hard disk drive), or the inventory may instead be stored on a removable media, such as a CD, DVD, or tape. Customers shop in a plurality of stores operated by vendors and the advertising is then presented to them. And a master server may also be provided to update the infrastructure and inventory, particularly including advertisements into the inventory.

In addition to the above mentioned examples, various other modifications and alterations of the inventive DCVM 10 may be made without departing from the invention. Furthermore, as has also been discussed herein, the inventive DCVM 10 may work in concert with or itself be a component in other inventions, such as the locally driven advertising system as claimed in the present patent application. Accordingly, the above disclosure is not to be considered as limiting and the appended claims are to be interpreted as encompassing the true spirit and the entire scope of the invention.

### APPENDIX A

### Definitions

3rd Party: An individual or company not directly involved in the transaction.

Aisle: A subset of the store which contains digital content assets.

BOB: “Bag'O Bits.”

E-BOB: Encrypted BOB.

U-BOB: Unencrypted (or decrypted) BOB

BWTP: BackWeb's transport protocol [Backweb™ is used herein as an example of an offline access server. Other offline access technologies can, of course, also be used.]

CD: Compact Disk.

CTS: Central Transaction Server

CUS: Central Update Server

Clearing House: A partner in the purchase process who clears the financial instrument, e.g., credit or debit card.

Collateral: Displayable attributes, including but not limited to “box/icons”, ads, data sheets, 3rd party opinions, etc. All of the displayable information associated with an intellectual property or digital content, but not the item itself, plus all advertisements (including those for things other than digital content carried by the store).

DVD: Digital Versatile Disk. A high capacity removal media.

GIF: A file extension defining a graphic file. (Graphics Interchange Format).

Hardgoods fulfillment house: A partner in the purchase process who warehouses, picks, packs and ships physical product.

Hex Accumulator Client profile “clickstream” accumulator.

Inventory: As referred to herein, a collection of digital content. In some cases collateral may be regarded as included.

ILK: Intellectual property long key.

IPP: Intellectual property provider (A software development company).

JPEG: A file extension defining a graphics file. (Joint Photographic Engineering Group).

OEM: An Original Equipment Manufacturer.

Pop-up: A window that appears overlaid on a screen. (often used to display additional required information or choices).

Digital content: Items sold directly (e.g., software products in the inventory on the client 12).

Proxy: A component or service that acts on behalf of one or more other services. Proxies generally add value by acting as repeaters and intermediate cache locations (thus reducing backend load, and reducing latency), and by filtering (thus providing security, or restricting access), or by translating (thus providing security).

HTTP Proxy: A proxy that provides service for network traffic using Hypertext Transport Protocol.

BWTP Proxy: A proxy that provides service for network traffic using an offline access server's transport protocol. [Note, BWTP Proxy is used here for consistence because Backweb™ transport protocol is used as an example and BWTP is the acronym used for that.]

Purchase Points Credits, e.g., funny money or “green” stamps. Rights to purchase certain digital content assets without “real money”. Purchase Points are presumably granted by OEMs or perhaps by returns.

Push Channel: A stream of data that can be received by a client system. Clients can “subscribe” to channels of data. Channels use the metaphor of “pushing” data to clients, rather than using clients to “pull” data.

Rotating Ad: A banner that provides multiple static banners each in turn.

Servers: [See separate Servers Summary, below.]

SKU: Shelf Keeping Unit, an integrated configuration of components.

Store: The second Level in the hierarchy. The store is a subset of the DCVM 10 and contains aisles.

Static Ad: A banner that does not change position or form during the viewing.

### APPENDIX B

### Servers Summary

Servers: In the preferred embodiment there are six servers, as per conventional meaning, generally, and as follows. Some of these may actually be served by the same physical system, or be distributed among several servers and distributed geographically.

Process Server Receives, inventories, tracks intellectual property (IP products, collateral and code); verifies and accepts inventory. Tracking and versioning are done using Agile™ or a similar “WIP”/“Component Control” software. (Centralized. Not Distributed).

Information Services Server: This “Data Warehouse” is a repository for marketing data (e.g. revenue share, number of “views”, number of “links”, number of systems shipped). It also handles logging for customer service, and data for marketing reports, and partner reports. The centralized customer data includes a profile (including digested clickstream), credit history with VS, “purchase points,” configurations (centralized, not distributed)

Transaction Processor Handles purchase functions for customers (credit validation, purchase points validation); Forwards to the clearing house 50 for validation when necessary. Forwards orders to hardgoods manufacturing; Or permission to Update Server. May have subset (read-only or buffered) of the customer database. (This may be distributed.)

Update/content server: Provides (free) information, collateral, and locked content updates; Provides (unlocked/purchased) updated content; Provides keys/missing data for purchased content; The “channel” or channel equivalent server resides here. (May be distributed. May be combined with the online server.)

Online server: The online (web site) village. Similar to established online web shopping sites, with the exception that entry into this site is tightly integrated with the infrastructure on the client 12. Can be created as a “standard” web server. May be the same as the update/content” server, depending on the channel design. (May be distributed.)

Support server: A support center for technical support, sales support, etc.

TABLE 1
File Format Defined:
<ClickStreamFileFormat> :: = <CSHeader > {<CSData>};
<CSHeader> = a java object of class ClickHeader with the following data members:

| protected String customerID = “”; | |
|---|---|
| protected String aliasID = “”; | |
| protected String skuID = “”; | |
| protected String systemID = “”; | |
| protected String startDate = “”; | // form: 19991231 |
| protected String endDate = “”; | // form: 20010101 |
| protected String Hashtable dataTypesAndSizes = new Hashtable( ); //class name and | |

quantity of count entries for each data object in file
{<CSData>} = one or more java objects(s) of one (or more) types currently only one data type is
supported: ClickDataWithLocations. As a result current click report files will include only one
data object.
ClickDataWithLocations objects include the following data members:

| | |
|---|---|
| protected int currentRecord = 0; | // index into arrays, initialized to zero |
| protected int[ ] componentIDs; | |
| protected int[ ] locations; | |
| protected int[ ] clicks; | |

TABLE 2
*****SAMPLE FILE*****

| CustomerID: 123 | Alias: 381914165 | SKU: 001 | SystemID: | StartDate: |
|---|---|---|---|---|
| 19990831 | EndDate: 19991110 | | | |

DataTypesAndSizes: {com.digitalsquare.contentManager.ClickDataWithLocation=4}

| Begin ClickDataWithLocation: | | |
|---|---|---|
| Location: 501 | Component: A258 | ClickCount: 32 |
| Location: 303 | Component: A257 | ClickCount: 10 |
| Location: 1204 | Component: F345 | ClickCount: 4 |
| Location: 1008 | Component: A254 | ClickCount: 2 |

TABLE 3
ClickHeader - Parse the header and provide the following ‘get’ functuions:

public String getCustomerID( )
public String getAliasID( )
public String getSkuID( )
public String getSystemID( )
public String getStartDateID( )
public String getStartEndID( )
public int getNumRecordsID( )

[symbol]

ClickHeaderJava

(attached, and in source repository: com.digitalsquare.contentManager)

ClickDataWithLocation class includes a getRecords( ) instance method which converts the arrays
of data into a Vector of ClickDataWithLocationItem objects, one for each soft URI clicked.

[symbol]

ClickDataWith
LocationJava

(attached, and in source repository: com.digitalsquare.contentManager)

Each ClickDataWithLocationItem includes a single location ID, omponent IS and click count.
public char getType( ) {
public int getComponentIDValue( ) {
public int getComponentID( )
public int getLocation( ) {
public int getCount( ) {
public String toString( ) {

[symbol]

ClickDataWith
LocationItemJava

(attached, and in source repository: com.digitalsquare.contentManager)

What is claimed is:

1. A method for providing offline advertising on a personal computerized system of a user, wherein the personal computerized system has a display unit and a primary storage unit, the method comprising:
(a) providing a campaign set in the primary storage unit, wherein said campaign set includes a plurality of ads each having respective deployment attributes and at least part of said campaign set is stored in said primary storage unit prior to its being received by the user, either as part of the personal computerized system or by addition to the personal computerized system;
(b) generating a viewable window on the display unit, wherein said viewable window includes at least one position;
(c) retrieving a said ad from said campaign set based on its respective said deployment attributes; and
(d) presenting said ad in said position, thereby permitting the user of the personal computerized system to view said ad.

2. The method of claim 1, wherein said primary storage unit is a hard disk drive.

3. The method of claim 1, wherein at least one said position has at least one temporal characteristic, thereby permitting different said ads to be presented based on their having respective said deployment attributes and time.

4. The method of claim 3, wherein said deployment attributes include at least one member of the set consisting of display start date, display end date, duration, subscription period, circulation period, and impression count.

5. The method of claim 1, wherein the primary storage unit further includes a local inventory of digital content and said ad is for an item of said digital content.

6. The method of claim 1, wherein the personal computerized system includes a network link permitting communication with a remote computer system having a master inventory of digital content and said ad is for an item of said digital content.

7. The method of claim 1, wherein the personal computerized system includes a network link permitting communication with a remote computer system, and further wherein said campaign set is an initial campaign set, and the method further comprising:
(e) receiving a second campaign set from said remote computer system.

8. The method of claim 1, wherein said ad has a graphical element and a click thru link, and the personal computerized system further includes an input unit with which said user of the personal computerized system may selectively click a said position in said viewable window on the display unit of the personal computerized system, thereby permitting said user to follow said click thru link.

9. The method of claim 8, wherein said at least some of said click thru links cause said (c) through said (d) to occur using a different said ad from said campaign set.

10. The method of claim 8, further comprising:
(e) accumulating impression counts for respective said ads; and
(f) aggregating said impression counts into a report.

11. The method of claim 10, wherein the personal computerized system includes a network link permitting communication with a remote computer system, and the method further comprising:
(g) communicating said report to said remote computer system.

12. The method of claim 11, wherein said (f) further includes incorporating demographic information about at least one said user of said personal computerized system into said report.

13. The method of claim 11, wherein said campaign set is an initial campaign set, and the method further comprising:
(h) receiving a second campaign set from said remote computer system, wherein said second campaign set has content based at least in part on said report.

14. The method of claim 11, wherein the primary storage unit further includes an inventory of digital content which said user of the personal computerized system may access, and the method further comprising:
(h) receiving different said digital content, based at least in part on said report, via said network link from a remote computer, wherein said remote computer may be, but is not necessarily, said second computer which receives said report; and
(i) changing said inventory with said different said digital content.

15. A computer program, embodied on a computer readable storage medium, for providing offline advertising on a personal computerized system of a user, wherein the personal computerized system has a display unit and a primary storage unit, the computer program comprising:
(a) a code segment that generates a viewable window on the display unit, wherein said viewable window includes at least one position;
(b) a code segment that retrieves a said ad from a campaign set based on respective deployment attributes for said ad, wherein said campaign set has been pre-stored in the primary storage unit prior to its ever being received by the user; and
(c) a code segment that presents said ad in said position, thereby permitting the user of the personal computerized system to view said ad.

16. The computer program of claim 15, wherein said primary storage unit is a hard disk drive and at least part of said campaign set is stored in said hard disk drive prior to its purchase, either as part of the personal computerized system or for addition to the personal computerized system.

17. The computer program of claim 15, wherein said code segment (c) presents said ad in said position based on its having a temporal location, thereby permitting different said ads to be presented based on their having respective said deployment attributes and time.

18. The computer program of claim 17, wherein said deployment attributes include at least one member of the set consisting of display start date, display end date, duration, subscription period, circulation period, and impression count.

19. The computer program of claim 15, wherein the personal computerized system includes a network link permitting communication with a remote computer system, and the computer program further comprising:
(d) a code segment that operates said network link to said access remote computer system and retrieve said ad from a master inventory of digital content stored there on.

20. The computer program of claim 15, wherein the personal computerized system further includes an input unit with which said user of the personal computerized system may selectively click in said viewable window on the display unit and said ad has a graphical element and a click thru link, and the computer program further comprising:
(d) a code segment that monitors said positions to see if a user selectively clicked one and directs the personal computerized system to follow said click thru link.

21. The computer program of claim 20, further comprising:
(e) a code segment that accumulates impression counts for respective said ads; and
(f) a code segment that aggregates said impression counts into a report.

22. The computer program of claim 21, wherein the personal computerized system includes a network link permitting communication with a remote computer system, and the computer program further comprising:
(g) a code segment that communicates said report to said remote computer system.
